(19) United States
(12) Patent Application Publication
(10) Pub. No.: US 2025/0302040 A1
(43) Pub. Date: Oct. 2, 2025

(54) FUNGICIDAL COMBINATIONS OF FLUAZINAM AND USES THEREOF

(71) Applicant: ADAMA MAKHTESHIM LTD., Beer Sheva (IL)

(72) Inventors: Matteo CERNUSCHI, Milan (IT); Marco Antonio TAVARES RODRIGUES, Sao Paulo (BR); Andrew HORSFIELD, Bracken Ridge (AU)

(73) Assignee: ADAMA MAKHTESHIM LTD., Beer Sheva (IL)

(21) Appl. No.: 18/865,146

(22) PCT Filed: May 11, 2023
(86) PCT No.: PCT/IL2023/050490

§ 371 Date: Nov. 12, 2024

Related U.S. Application Data
(60) Provisional application No. 63/340,967, filed on May 12, 2022.

(51) Int. Cl. A01N 43/40; A01N 43/56; A01N 43/653; A01N 43/713; A01N 59/20; A01P 3/00

(52) U.S. Cl. CPC A01N 43/40; A01N 43/56; A01N 43/653; A01N 43/713; A01N 59/20; A01P 3/00

(57) ABSTRACT

The present invention relates to mixture combinations of active compounds comprising an effective amount of fluazinam; an effective amount of at least one fungicide or its salt, for combatting or preventing fungal diseases of crop plants.

### RELATED APPLICATION/S

This application claims benefits of U.S. Provisional Application No. 63/340,967 filed on May 12, 2022; the entire content of which is hereby incorporated by reference herein. Throughout this application, various publications are cited. Disclosures of the documents and publications referred to herein are hereby incorporated in their entireties by references into this application.

### FIELD OF INVENTION

The present invention relates to fungicidal combinations comprising (1) an effective amount of fluazinam and (2) an effective amount of at least one additional fungicide selected from a group consisting of an azole fungicide, a quinone outside inhibitor fungicide, a succinate dehydrogenase inhibitor fungicide, a protectant fungicide, a morpholine fungicide, a benzamide fungicide, a carboxylic acid amide fungicide, a cyanoacetamideoxime fungicide, an Isothiazole fungicide, a melanin biosynthesis inhibitors reductase fungicide, an oxysterol binding protein homologue inhibition fungicide, a phenylamide fungicide, a phosphonate fungicide, a phenylpyrrole fungicide, a quinone inside Inhibitor fungicide, a quinone outside inhibitor fungicide of stigmatellin binding type, and other fungicide selected from a group comprising aminopyrifen, chlorinconazide, dipymetitrone, flufenoxadiazam, ipflufenoquin, picarbutrazox, pyridachlometyl, quinofumelin, and combinations thereof. Methods for controlling or preventing fungal diseases in crop plants are also disclosed.

### BACKGROUND OF INVENTION

Fungicides are compounds of natural or synthetic origin which act to protect plants against damage caused by fungi. Despite the benefits derived from the use of fungicides in agriculture such as protection of crops and improved productivity, it is nowadays desirable to reduce the amounts of fungicides used in the fields owing to the potential health risks associated with an intensive use of agrochemicals. In addition, repeated usage of a single fungicide often leads to the development of resistance to the fungicide.

Another important issue associated with fungus attacks is the loss of nutrients which leads to a decrease in the overall yield of the crop. Compositions comprising one single active ingredient have shown a limited control over diseases. Many known fungicides including fluazinam are effective for specific crop and have a limited activity. In addition, a resistance is developed and there is a need to revert, restore, increase and/or extend the activity.

Despite the benefits derived from the use of fungicides in agriculture such as protection of crops and improved productivity, it is nowadays desirable to reduce the amounts of fungicides used in the fields owing to the potential health risks associated with an intensive use of agrochemicals. Furthermore, repeated usage of a single fungicide often leads to the development of resistance to a specific or a group of fungicides.

The biological properties of known compounds are not entirely satisfactory in the areas of plant disease control, environmental and worker exposure, for example in particular, it has been observed that pathogens become, resistant to pesticides, which are at times administered in higher dosages to achieve the desired control, thereby leading to soil toxicity and other environmental hazards, besides higher costs.

Combinations of fungicides or mixture of one or more fungicides with other crop protection chemical are typically used to broaden spectrum of control, to minimize the doses of chemicals used, to retard resistance development and to reduce the cost of the treatment through additive effect. Although many combinations of one fungicidal agent with one or more crop protection chemicals have been studied, a synergistic effect is rarely attained.

Practical agricultural experience has shown that the repeated and exclusive application of an individual active compound such as fluazinam in the control of fungi leads in many cases to a selection of those fungi which have developed natural or adapted resistance against the active compound in question. Effective control of these fungi with the active compound in question is then no longer possible.

Hence there is a need for a selective mixture of fluazinam with other fungicidal compound that help prevent or overcome resistance. In order to reduce the risk of fungi becoming resistant to certain active compounds, mixtures of different fungicidal chemicals are nowadays conventionally employed for controlling various fungi. By combining judiciously active compounds having different mechanisms of action, it is possible to ensure successful control over a relatively long period of time.

Active agent mixtures are described in the literature. However, the control over the fungi does not always satisfy the needs of agriculture practice. Additionally, the efficacy of mixtures is not entirely satisfactory in cases of fungi control and/or toxicological and/or environmental effects. Random pesticidal compositions and mixtures do not exert a satisfactory controlling effect in most of the cases, and therefore, there is an urgent need for development of new pesticidal mixtures with one more crop protection chemical having some satisfactory controlling effects.

It is an object of the present invention to provide mixtures and compositions of judiciously selected crop protection chemicals which, when applied at a reduced total amount of active compounds, have improved activity against the harmful fungi. It is an object of the present invention to provide a broadened activity spectrum with prolonged control. It is a further object of the present invention to provide mixtures and compositions comprising fluazinam which provide effective resistance management and fungi control, at application rates which are as low as possible.

It is an endeavor of the present invention to find that mixtures comprising fluazinam and at least one further crop protection chemical are synergistically effective, being applied simultaneously, that is jointly or separately, or in succession, allows better control of fungi than is possible with the individual compounds alone, providing synergistic results and solving at least one of the challenges in the prior art by reducing the dosage rate or enhancing the spectrum of activity with prolonged control or facilitating resistance management.

In light of the above, there is endeavor in the present invention for a fungicidal mixture combination of crop protection chemicals comprising fluazinam and one or more fungicides that exhibit synergistically enhanced action, a broader scope of activity, providing a control over the fungal attacks on crops, enabling higher yields while preserving a high amount of nutrients in crops and also reducing cost of treatment.

There is therefore a need for new mixtures and method of treatment that provides a control over the fungal attacks on crops and enables higher yields while preserving a high amount of nutrients in crops.

### SUMMARY OF THE PRESENT INVENTION

We have reasonably found that the object as described above is as a whole or in part achieved by the combination of active compounds defined below.

The present invention relates to a fungicidal mixture combination comprising, as active compounds:
1) an effective amount of a fluazinam; and
2) an effective amount of at least one fungicide selected from the group consisting of:
(a) an azole fungicide selected from a group comprising bromuconazole, cyproconazole, difenoconazole, diniconazole, epoxiconazole, fenbuconazole, fluoxytioconazole, fluquinconazole, flusilazole, flutriafol, hexaconazole, imazalil, ipconazole, ipfentrifluconazole, mefentrifluconazole, metconazole, myclobutanil, penconazole, prochloraz, propiconazole, prothioconazole, pyrisoxazole, tebuconazole, tetraconazole, triadimefon, triadimenol, triflumizole, and a combination thereof;
(b) a quinone outside inhibitor (QoI) fungicide selected from a group comprising azoxystrobin, dimoxystrobin, famoxadone, fenamidone, fluoxastrobin, kresoxim-methyl, metarylpicoxamid, metominostrobin, metyltetraprole, picoxystrobin, pyraclostrobin, pyribencarb, trifloxystrobin, and a combination thereof,
(c) a succinate dehydrogenase inhibitor (SDHI) fungicide selected from a group comprising benzovindiflupyr, bixafen, boscalid, flubeneteram, fluindapyr, fluopyram, flutolanil, fluxapyroxad, inpyrfluxam, isofetamid, isoflucypram, isopyrazam, penthiopyrad, pydiflumetofen, pyrapropoyne, thifluzamide, and a combination thereof,
(d) a protectant fungicide selected from a group comprising copper, captan, folpet, and a combination thereof,
(e) a morpholine fungicide selected from a group comprising acibenzolar-s-methyl, fenpropidin, fenpropimorph, spiroxamine, and a combination thereof,
(f) a benzamide fungicide selected from a group comprising fluopicolide, zoxamide, and a combination thereof,
(g) a carboxylic acid amide (CAA) fungicide selected from a group comprising benthiavalicarb-isopropyl, dimethomorph, iprovalicarb, mandipropamid, valifenalate and a combination thereof;
(h) a cyanoacetamideoxime fungicide selected from a group comprising cymoxanil;
(i) an Isothiazole fungicide selected from a group comprising Dichlobentiazox;
(j) a melanin biosynthesis inhibitor reductase (MI-R) fungicide selected from a group comprising tolprocarb, tricyclazole, and a combination thereof;
(k) an oxysterol binding protein homologue inhibition (OSBPI) fungicide selected from a group comprising fluoxapiprolin, oxathiapiprolin, and a combination thereof,
(l) a phenylamide fungicide selected from a group comprising benalaxyl, metalaxyl, metalaxyl-methyl, oxadixyl, and a combination thereof;
(m) a phosphonate fungicide selected from a group comprising disodium-phosphonate, fosetyl-al, potassium-bicarbonate, potassium-carbonate, potassium phosphite monobasic, potassium phosphonate, and a combination thereof,
(n) a phenylpyrrole fungicide selected from a group comprising fludioxonil;
(o) a quinone inside inhibitor (QiI) fungicide selected from a group comprising amisulbrom, cyazofamid, Fenpicoxamid, florylpicoxamid and a combination thereof;
(p) a quinone outside inhibitor fungicide of stigmatellin binding type (QoSI) selected from a group comprising Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof,
wherein the amount of fluazinam and the amount of the fungicide when applied together is more effective in treating a plant or soil against fungal infection than when each fungicide at the same amount is applied alone.

The present invention also relates to a fungicidal mixture combination comprising, as active compounds:
1) an effective amount of a fluazinam; and
2) an effective amount of at least two fungicides selected from the group consisting of:
(a) an azole fungicide selected from a group comprising bromuconazole, cyproconazole, difenoconazole, diniconazole, epoxiconazole, fenbuconazole, fluoxytioconazole, fluquinconazole, flusilazole, flutriafol, hexaconazole, imazalil, ipconazole, ipfentrifluconazole, mefentrifluconazole, metconazole, myclobutanil, penconazole, prochloraz, propiconazole, prothioconazole, pyrisoxazole, tebuconazole, tetraconazole, triadimefon, triadimenol, triflumizole, and a combination thereof;
(b) a quinone outside inhibitor (QoI) fungicide selected from a group comprising azoxystrobin, dimoxystrobin, famoxadone, fenamidone, fluoxastrobin, kresoxim-methyl, metarylpicoxamid, metominostrobin, metyltetraprole, picoxystrobin, pyraclostrobin, pyribencarb, trifloxystrobin, and a combination thereof,
(c) a succinate dehydrogenase inhibitor (SDHI) fungicide selected from a group comprising benzovindiflupyr, bixafen, boscalid, flubeneteram, fluindapyr, fluopyram, flutolanil, fluxapyroxad, inpyrfluxam, isofetamid, isoflucypram, isopyrazam, penthiopyrad, pydiflumetofen, pyrapropoyne, thifluzamide, and a combination thereof,
(d) a protectant fungicide selected from a group comprising copper, captan, folpet, and a combination thereof;
(e) a morpholine fungicide selected from a group comprising acibenzolar-s-methyl, fenpropidin, fenpropimorph, spiroxamine, and a combination thereof,
(f) a benzamide fungicide selected from a group comprising fluopicolide, zoxamide, and a combination thereof,
(g) a carboxylic acid amide (CAA) fungicide selected from a group comprising benthiavalicarb-isopropyl, dimethomorph, iprovalicarb, mandipropamid, valifenalate and a combination thereof;
(h) a cyanoacetamideoxime fungicide selected from a group comprising cymoxanil;
(i) an Isothiazole fungicide selected from a group comprising Dichlobentiazox;
(j) a melanin biosynthesis inhibitor reductase (MI-R) fungicide selected from a group comprising tolprocarb, tricyclazole, and a combination thereof,
(k) an oxysterol binding protein homologue inhibition (OSBPI) fungicide selected from a group comprising fluoxapiprolin, oxathiapiprolin, and a combination thereof,
(l) a phenylamide fungicide selected from a group comprising benalaxyl, metalaxyl, metalaxyl-methyl, oxadixyl, and a combination thereof,
(m) a phosphonate fungicide selected from a group comprising disodium-phosphonate, fosetyl-al, potassium-bicarbonate, potassium-carbonate, potassium phosphite monobasic, potassium phosphonate, and a combination thereof,
(n) a phenylpyrrole fungicide selected from a group comprising fludioxonil;
(o) a quinone inside inhibitor (QiI) fungicide selected from a group comprising amisulbrom, cyazofamid, Fenpicoxamid, florylpicoxamid and a combination thereof,
(p) a quinone outside inhibitor fungicide of stigmatellin binding type (QoSI) selected from a group comprising Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof,
wherein the amount of fluazinam and the amount of the fungicides when applied together is more effective in treating a plant or soil against fungal infection than when each fungicide at the same amount is applied alone.

The mixture combination of the present invention can be a synergistic mixture.

The present invention also provides a fungicidal composition comprising any one of the combinations or mixtures disclosed herein.

The present invention also provides a method of treating a plant or soil against fungal infection comprising applying an effective amount of any one of the combinations, mixtures or compositions disclosed herein to the plant, propagation material of the plant, or soil so as to thereby treat the plant or soil against fungal infection.

The present invention also provides a method of treating a plant or soil against fungal infection comprising applying to the plant, propagation material of the plant, or soil
1) an effective amount of a fluazinam; and
2) an effective amount of at least one fungicide selected from the group consisting of:
(a) an azole fungicide selected from a group comprising bromuconazole, cyproconazole, difenoconazole, diniconazole, epoxiconazole, fenbuconazole, fluoxytioconazole, fluquinconazole, flusilazole, flutriafol, hexaconazole, imazalil, ipconazole, ipfentrifluconazole, mefentrifluconazole, metconazole, myclobutanil, penconazole, prochloraz, propiconazole, prothioconazole, pyrisoxazole, tebuconazole, tetraconazole, triadimefon, triadimenol, triflumizole, and a combination thereof;
(b) a quinone outside inhibitor (QoI) fungicide selected from a group comprising azoxystrobin, dimoxystrobin, famoxadone, fenamidone, fluoxastrobin, kresoxim-methyl, metarylpicoxamid, metominostrobin, metyltetraprole, picoxystrobin, pyraclostrobin, pyribencarb, trifloxystrobin, and a combination thereof,
(c) a succinate dehydrogenase inhibitor (SDHI) fungicide selected from a group comprising benzovindiflupyr, bixafen, boscalid, flubeneteram, fluindapyr, fluopyram, flutolanil, fluxapyroxad, inpyrfluxam, isofetamid, isoflucypram, isopyrazam, penthiopyrad, pydiflumetofen, pyrapropoyne, thifluzamide, and a combination thereof,
(d) a protectant fungicide selected from a group comprising copper, captan, folpet, and a combination thereof,
(e) a morpholine fungicide selected from a group comprising acibenzolar-s-methyl, fenpropidin, fenpropimorph, spiroxamine, and a combination thereof,
(f) a benzamide fungicide selected from a group comprising fluopicolide, zoxamide, and a combination thereof,
(g) a carboxylic acid amide (CAA) fungicide selected from a group comprising benthiavalicarb-isopropyl, dimethomorph, iprovalicarb, mandipropamid, valifenalate and a combination thereof,
(h) a cyanoacetamideoxime fungicide selected from a group comprising cymoxanil;
(i) an Isothiazole fungicide selected from a group comprising Dichlobentiazox;
(j) a melanin biosynthesis inhibitor reductase (MI-R) fungicide selected from a group comprising tolprocarb, tricyclazole, and a combination thereof,
(k) an oxysterol binding protein homologue inhibition (OSBPI) fungicide selected from a group comprising fluoxapiprolin, oxathiapiprolin, and a combination thereof,
(l) a phenylamide fungicide selected from a group comprising benalaxyl, metalaxyl, metalaxyl-methyl, oxadixyl, and a combination thereof,
(m) a phosphonate fungicide selected from a group comprising disodium-phosphonate, fosetyl-al, potassium-bicarbonate, potassium-carbonate, potassium phosphite monobasic, potassium phosphonate, and a combination thereof,
(n) a phenylpyrrole fungicide selected from a group comprising fludioxonil;
(o) a quinone inside inhibitor (QiI) fungicide selected from a group comprising amisulbrom, cyazofamid, Fenpicoxamid, florylpicoxamid and a combination thereof,
(p) a quinone outside inhibitor fungicide of stigmatellin binding type (QoSI) selected from a group comprising Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof,
so as to thereby treat the plant or soil against fungal infection,
wherein the amount of fluazinam and the amount of the fungicide when applied together is more effective for treating the plant or soil against fungal infection than when each fungicide at the same amount is applied alone.

The present invention also provides a method of treating a plant or soil against fungal infection comprising applying to the plant, propagation material of the plant, or soil
1) an effective amount of a fluazinam; and
2) an effective amount of at least one fungicide selected from the group consisting of:
(a) an azole fungicide selected from a group comprising bromuconazole, cyproconazole, difenoconazole, diniconazole, epoxiconazole, fenbuconazole, fluoxytioconazole, fluquinconazole, flusilazole, flutriafol, hexaconazole, imazalil, ipconazole, ipfentrifluconazole, mefentrifluconazole, metconazole, myclobutanil, penconazole, prochloraz, propiconazole, prothioconazole, pyrisoxazole, tebuconazole, tetraconazole, triadimefon, triadimenol, triflumizole, and a combination thereof;
(b) a quinone outside inhibitor (QoI) fungicide selected from a group comprising azoxystrobin, dimoxystrobin, famoxadone, fenamidone, fluoxastrobin, kresoxim-methyl, metarylpicoxamid, metominostrobin, metyltetraprole, picoxystrobin, pyraclostrobin, pyribencarb, trifloxystrobin, and a combination thereof,
(c) a succinate dehydrogenase inhibitor (SDHI) fungicide selected from a group comprising benzovindiflupyr, bixafen, boscalid, flubeneteram, fluindapyr, fluopyram, flutolanil, fluxapyroxad, inpyrfluxam, isofetamid, isoflucypram, isopyrazam, penthiopyrad, pydiflumetofen, pyrapropoyne, thifluzamide, and a combination thereof,
(d) a protectant fungicide selected from a group comprising copper, captan, folpet, and a combination thereof,
(e) a morpholine fungicide selected from a group comprising acibenzolar-s-methyl, fenpropidin, fenpropimorph, spiroxamine, and a combination thereof,
(f) a benzamide fungicide selected from a group comprising fluopicolide, zoxamide, and a combination thereof;
(g) a carboxylic acid amide (CAA) fungicide selected from a group comprising benthiavalicarb-isopropyl, dimethomorph, iprovalicarb, mandipropamid, valifenalate and a combination thereof,
(h) a cyanoacetamideoxime fungicide selected from a group comprising cymoxanil;
(i) an Isothiazole fungicide selected from a group comprising Dichlobentiazox;
(j) a melanin biosynthesis inhibitor reductase (MI-R) fungicide selected from a group comprising tolprocarb, tricyclazole, and a combination thereof,
(k) an oxysterol binding protein homologue inhibition (OSBPI) fungicide selected from a group comprising fluoxapiprolin, oxathiapiprolin, and a combination thereof,
(l) a phenylamide fungicide selected from a group comprising benalaxyl, metalaxyl, metalaxyl-methyl, oxadixyl, and a combination thereof,
(m) a phosphonate fungicide selected from a group comprising disodium-phosphonate, fosetyl-al, potassium-bicarbonate, potassium-carbonate, potassium phosphite monobasic, potassium phosphonate, and a combination thereof,
(n) a phenylpyrrole fungicide selected from a group comprising fludioxonil;
(o) a quinone inside inhibitor (QiI) fungicide selected from a group comprising amisulbrom, cyazofamid, Fenpicoxamid, florylpicoxamid and a combination thereof,
(p) a quinone outside inhibitor fungicide of stigmatellin binding type (QoSI) selected from a group comprising Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof,
so as to thereby treat the plant or soil against fungal infection, wherein the amount of fluazinam applied is less than the fungicidally effective amount of fluazinam when fluazinam is used alone, and/or
wherein the amount of the fungicide applied is less than the fungicidally effective amount of the fungicide when the fungicide is used alone.

The present invention also provides use of fluazinam, any one of the combinations, mixtures or compositions disclosed herein for combatting phytopathogenic diseases as well as mites on crop plants.

The present invention also provides use of any one of the combinations, mixtures or compositions disclosed herein for treating a plant or soil against fungal infection.

The present invention also provides a method of treating a plant or soil against infection by fungi selected from a group comprising phoma (Leptosphaeria maculans), Ascochytafabae (Didymella pisi), Botrytis sp. (Botrytis), Cercospora beticola (leaf spot of beet), Cercospora zeae-maydis (Gray Leaf Spot), Cochliobolus carbonum (Northern Corn Leaf Spot), Cochliobolus heterostrophus (Southern corn leaf blight), Colletotrichum kahawae (Coffee Berry Disease), Colletotrichum sp. (Anthracnose), Colletotrichum truncatum (Anthracnose), Corynespora cassiicola (Target spot), Fusarium sp. (Fusarium head blight), Hemileia vastatrix (Coffee Leaf Rust), Mycosphaerella fijiensis (Black sigatoka), Phakopsora pachyrhizi (Asian soybean rust), Phytophthora infestans (Late blight), Plasmopara viticola (Downy mildew), Pseudocercospora musae (Yellow sigatoka), Pseudoperonospora cubensis (Downy mildew), Puccinia recondite (Brown rust), Puccinia striiformis (Yellow rust), Pyrenophora teres (Net blotch), Pyricularia oryzae (Rice Blast), Ramularia areola (Ramularia leaf spot), Ramularia beticola (Ramularia leaf spot), Ramularia collo-cygni (Ramularia leaf spot), Rhizoctonia solani/Thanatephorus cucumeris (Sheath Blight), Sclerotinia homeocarpa (Dollar spot), Sclerotinia sclerotiorum (Sclerotinia), Setosphaeria turcica (Northern Corn Leaf Blight), powdery mildew, Uromyces betae (Rust), Venturia inaequalis (Scab), Zymoseptoria tritici (Septoria), Alternaria sp. (Early blight).

The preferred target fungi and fungal diseases for treating a plant or soil against infection are phoma (Leptosphaeria maculans), Alternaria sp. (Early blight) in Potato and Tomato; Ascochyta fabae (Didymella pisi) in Pulses and Peanuts; Botrytis sp. (Botrytis) in Grapes, Strawberry, flowers and ornamentals, tomato, chilli, Avocado, Mango and Pistachio; Cercospora beticola (leaf spot of beet) in Sugar beet; Cercospora zeae-maydis (Gray Leaf Spot) in corn; Cochliobolus carbonum (Northern Corn Leaf Spot) in corn, Cochliobolus heterostrophus (Southern corn leaf blight) in corn, Colletotrichum kahawae (Coffee Berry Disease) in coffee; Colletotrichum sp. (Anthracnose) in Pulses and Peanuts, Colletotrichum truncatum (Anthracnose) in chilli, Corynespora cassiicola (Target spot) in Soybean and cotton; Fusarium sp. (Fusarium head blight) in cereals; Hemileia vastatrix (Coffee Leaf Rust) in coffee; Mycosphaerella fijiensis (Black sigatoka) in Banana; Phakopsora pachyrhizi (Asian soybean rust) in soybean; Phytophthora infestans (Late blight) in Potato and Tomato; Plasmopara viticola (Downy mildew) in Grapes; Pseudocercospora musae (Yellow sigatoka) in Banana; Pseudoperonospora cubensis (Downy mildew) in Cucurbits; Puccinia recondite (Brown rust) in cereals; Puccinia striiformis (Yellow rust) in cereals; Pyrenophora teres (Net blotch) in Barley; Pyricularia oryzae (Rice Blast) in Rice; Ramularia areola (Ramularia leaf spot) in cotton; Ramularia beticola (Ramularia leaf spot) in Sugar beet; Ramularia collo-cygni (Ramularia leaf spot) in Cereals, Rhizoctonia solani/Thanatephorus cucumeris (Sheath Blight) in Rice; Sclerotinia homeocarpa (Dollar spot) in Turf, Lawns, Golf courses; Sclerotinia sclerotiorum (Sclerotinia) in OSR, Soybean, Sunflower and Lettuces; Setosphaeria turcica (Northern Corn Leaf Blight) in corn; Uromyces betae (Rust) in sugar beet; Venturia inaequalis (Scab) in Pome fruit; and Zymoseptoria tritici (Septoria) in Cereals.

The present invention preferably relates to a fungicidal mixture combination comprising, as active compounds:
1) an effective amount of a fluazinam; and
2) an effective amount of at least one fungicide selected from the group consisting of:
(a) an azole fungicide selected from a group comprising difenoconazole, epoxiconazole, ipfentrifluconazole, fluoxytioconazole, mefentrifluconazole, prothioconazole, tebuconazole, and a combination thereof,
(b) a quinone outside inhibitor fungicide selected from a group comprising azoxystrobin, dimoxystrobin, fluoxastrobin, kresoxim-methyl, metarylpicoxamid, metominostrobin, metyltetraprole, picoxystrobin, pyraclostrobin, trifloxystrobin, and a combination thereof,
(c) a succinate dehydrogenase inhibitor fungicide selected from a group comprising benzovindiflupyr, boscalid, flubeneteram, fluindapyr, fluopyram, fluxapyroxad, inpyrfluxam, isoflucypram, pydiflumetofen, and a combination thereof,
(d) a protectant fungicide selected from a group comprising copper, captan, folpet, and a combination thereof,
(e) a morpholine fungicide selected from a group comprising fenpropidin, fenpropimorph, spiroxamine, and a combination thereof,
(f) a benzamide fungicide selected from a group comprising fluopicolide, zoxamide, and a combination thereof,
(g) a carboxylic acid amide fungicide selected from a group comprising mandipropamid, valifenalate and a combination thereof,
(h) a cyanoacetamideoxime fungicide selected from a group comprising cymoxanil;
(i) an Isothiazole fungicide selected from a group comprising Dichlobentiazox;
(j) a melanin biosynthesis inhibitor reductase fungicide selected from a group comprising tricyclazole;
(k) an oxysterol binding protein homologue inhibition fungicide selected from a group comprising fluoxapiprolin, oxathiapiprolin, and a combination thereof,
(l) a phenylamide fungicide selected from a group comprising benalaxyl, metalaxyl-methyl, oxadixyl, and a combination thereof,
(m) a phosphonate fungicide selected from a group comprising disodium-phosphonate, fosetyl-al, potassium phosphonate, and a combination thereof,
(n) a phenylpyrrole fungicide selected from a group comprising fludioxonil;
(o) a quinone inside inhibitor fungicide selected from a group comprising cyazofamid, Fenpicoxamid, florylpicoxamid and a combination thereof,
(p) a quinone outside inhibitor fungicide of stigmatellin binding type selected from a group comprising Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof.

More preferably, the present invention relates to a fungicidal mixture combination comprising, as active compounds:
1) an effective amount of a fluazinam; and
2) an effective amount of one or more fungicides selected from the group consisting of:
(a) an azole fungicide selected from a group comprising difenoconazole, epoxiconazole, ipfentrifluconazole, fluoxytioconazole, mefentrifluconazole, prothioconazole, and a combination thereof;
(b) a quinone outside inhibitor fungicide selected from a group comprising azoxystrobin, metyltetraprole, picoxystrobin, pyraclostrobin, and a combination thereof;
(c) a succinate dehydrogenase inhibitor fungicide selected from a group comprising flubeneteram, fluindapyr, fluopyram, fluxapyroxad, inpyrfluxam, isoflucypram, and a combination thereof;
(d) a protectant fungicide is selected from a group comprising copper, captan, folpet, and a combination thereof;
(e) a morpholine fungicide is fenpropidin;
(f) a benzamide fungicide is fluopicolide;
(g) a carboxylic acid amide fungicide is mandipropamid;
(h) a cyanoacetamideoxime fungicide is cymoxanil;
(i) an Isothiazole fungicide is Dichlobentiazox;
(j) a melanin biosynthesis inhibitor reductase fungicide is tricyclazole;
(k) an oxysterol binding protein homologue inhibition fungicide is fluoxapiprolin;
(l) a phenylamide fungicide is metalaxyl-methyl;
(m) a phosphonate fungicide is potassium phosphonate;
(n) a phenylpyrrole fungicide is fludioxonil;
(o) a quinone inside inhibitor fungicide is florylpicoxamid;
(p) a quinone outside inhibitor fungicide of stigmatellin binding type is Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof.

The present invention also provides a kit comprising any one of the combinations, mixtures or compositions disclosed herein.

The present invention also provides a process for the preparation any one of the combinations, mixtures or compositions disclosed herein from individual component parts.

### DETAILED DESCRIPTION OF THE PRESENT INVENTION

### Brief Description of the Figures

FIG. 1 describes Design of the Microtiter Plate (MTP) assay unit for testing fungicide mixture on pathogen strains.

FIG. 2 describes effects of two-way fungicidal mixture compositions on green leaf retentions in the soybean plants.

FIG. 3 describes effects of three-way fungicidal mixture compositions on green leaf retentions in the soybean plants.

### DEFINITIONS

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly in contact with the other element or intervening elements may be present there between. In contrast, when an element is referred to as being “directly on” another element, there are no intervening elements present.

The terminology used herein is for the purpose of describing particular embodiments only and is not intended to be limiting. As used herein, the singular forms “a,” “an,” and “the” are intended to include the plural forms as well, unless the context clearly indicates otherwise.

It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, the term “mixture” means but is not limited to an assemblage of agrochemicals for application either by simultaneous, contemporaneous and/or succession application. A combination of any time of application of the individual components, e.g. succession and/or in any physical form, e.g. blend, solution, suspension, dispersion, emulsion, alloy, or the like. Mixture also may refer to combining and applying the active components as one composition and/or formulating each of the active component in the mixture or combination as separated compositions and application at the same time or in separated applications at the same time or different times.

As used herein, the term “succession” when used in connection with the application of agrochemicals (of the mixture) means that an individual agrochemical is applied at separate times from another agrochemical, one after the other.

As used herein, the term “contemporaneous” when used in connection with application of agrochemicals (of the mixture) means that an individual agrochemical is applied separately from another agrochemical or premixture at the same time or at times sufficiently close together that a synergistic activity or an activity that is additive or more than additive relative to the activity of either agrochemical alone at the same dose is achieved.

As used herein, the term “combination” means an assemblage of agrochemicals for application either by simultaneous or contemporaneous application.

As used herein, the term “simultaneous” when used in connection with application of agrochemicals means that the agrochemicals are applied in an admixture, for example, a tank mix. For simultaneous application, the combination may be the admixture or separate containers each containing an agrochemical that are combined prior to application.

As used herein the term “prolonged control” means obtaining fungicidal activity over an extended period after the application of one or more fungicide for controlling fungi infestation of the plant or locus over an extended period of time, before and/or after an infestation or before and/or after damage due to fungi are shown.

As used herein, the term “effective” when used in connection with an amount of the combination, mixture or composition refers to an amount of the combination, mixture or composition that achieve a good level of control of the fungus, pathogen, and/or disease when applied to a plant, propagation material of the plant, or soil.

As used herein the term “propagation material” is to be understood to denote all the generative parts of the plant such as seeds and spores, vegetative structures such as bulbs, corms, tubers, rhizomes, roots stems, basal shoots, stolons and buds.

As used herein, the term “fungicidally effective amount” refers to an amount of the active component that is commercially recommended for use to control fungi. The commercially recommended amount for each active component, often specified as application rates of the commercial formulation, may be found on the label accompanying the commercial formulation. The commercially recommended application rates of the commercial formulation may vary depending on factors such as the plant species and the fungus to be controlled.

As used herein, the term “treating a plant or soil against fungal infection” includes, but is not limited to, protecting the plant or soil against fungal attack, preventing fungal infection of the plant or soil, controlling fungal disease infecting the plant or soil, and reducing fungal infection of the plant or soil.

As used herein, the term “more effective for controlling fungal disease” includes, but is not limited to, increasing efficacy of fungal disease control and reducing the amount of time needed to achieve a given level of fungal control.

As used herein, the term “more effective for protecting the plant or soil against fungal attack” includes, but is not limited to, prolonging the duration of protection against fungal attack after application and extending the protection period against fungal attack.

As used herein, the term “agriculturally acceptable inert additives” is defined as any substance that itself is not an active ingredient but is added to the composition such as thickening agent, sticking agents, surfactants, anti-oxidation agent, anti-foaming agents and thickeners.

As used herein, the term “tank mix” means that two or more chemical pesticides or compositions are mixed in the spray tank at the time of spray application.

As used herein, the term “ready mix” means a composition that may be applied to plants directly after dilution. The composition comprises the combination of the active ingredients. The term “mixture” or “combination” refers, but is not limited to, a combination in any physical form, e.g., blend, solution, alloy, or the like.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits. The term “plant” may also include the propagation material thereof, which may include all the generative parts of the plant such as seeds and vegetative plant material such as cuttings and tubers, which can be used for the multiplication of the plant. It may also include spores, corms, bulbs, rhizomes, sprouts basal shoots, stolons, and buds and other parts of plants, including seedlings and young plants, which are to be transplanted after germination or after emergence from soil.

As used herein, the term “locus” includes a habitat, breeding ground, plant, propagation material, soil, area, material or environment in which a pest is growing or may grow.

As used herein, the term “cultivated plants” includes plants which have been modified by breeding, mutagenesis or genetic engineering. Genetically modified plants are plants, which genetic material has been modified by the use of recombinant DNA techniques. Typically, one or more genes have been integrated into the genetic material of such a plant in order to improve certain properties of the plant.

The term “plant health” comprises various sorts of improvements of plants that are not connected to the control of pests. For example, advantageous properties that may be mentioned are improved crop characteristics including: emergence, crop yields, protein content, oil content, starch content, more developed root system (improved root growth), improved stress tolerance (e.g. against drought, heat, salt, UV, water, cold), reduced ethylene (reduced production and/or inhibition of reception), increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), increased shoot growth, enhanced plant vigor, increased plant stand and early and better germination; or any other advantages familiar to a person skilled in the art.

Throughout the application, descriptions of various embodiments use the term “comprising”; however, it will be understood by one of skill in the art, that in some specific instances, an embodiment can alternatively be described using the language “consisting essentially of” or “consisting of”.

As used herein the term “ha” refers to hectare.

As used herein, the term “g” refers to gram, and “L” or “1” refers to litre.

As used herein, the term “more effective” includes, but is not limited to, increasing efficacy of pesticidal disease control, prolonging protection and reducing the amount of time needed to achieve a given level of pesticidal control, prolonging the duration of protection against pest attack after application and extending the protection period against pest attack and/or reducing the amount of time needed to achieve a level of pest control compared to when each pesticide at the same amount is applied alone.

The term “enhancing crop plants” as used herein means improving one or more of plant quality, plant vigor, nutrient uptake, root system, tolerance to stress factors, and/or yield in a plant to which the mixture or composition described herein has been applied as compared to a control plant grown under the same conditions except to which the mixture or composition described herein has not been applied.

The term “enhancing roots system” as may be used herein means the roots system is improved qualitatively or quantitatively in a plant to which the mixture or composition described herein has been applied as compared to the roots systems in a control plant grown under the same conditions except to which the mixture or composition described herein has not been applied.

Enhanced roots systems include but are not limited to improved visual appearance and composition of the roots system (i.e., improved color, density, and uniformity), increased root growth, a more developed root system, stronger and healthier roots, improved plant stand, and increased roots system weight.

The term “improving plant quality” as used herein means that one or more traits are improved qualitatively or quantitatively in a plant to which the mixture or composition described herein has been applied as compared to the same trait in a control plant grown under the same conditions except to which the mixture or composition described herein has not been applied. Such traits include but are not limited to improved visual appearance and composition of the plant (i.e., improved color, density, uniformity, compactness), reduced ethylene (reduced production and/or inhibition of reception), improved visual appearance and composition of harvested material (i.e., seeds, fruits, leaves, vegetables, shoot/stem/cane), improved carbohydrate content (i.e., increased quantities of sugar and/or starch, improved sugar acid ratio, reduction of reducing sugars, increased rate of development of sugar), improved protein content, improved oil content and composition, improved nutritional value, reduction in anti-nutritional compounds, increased nutrient uptake, stronger and healthier roots, improved organoleptic properties (i.e., improved taste), improved consumer health benefits (i.e., increased levels of vitamins and antioxidants), improved post-harvest characteristics (i.e., enhanced shelf-life and/or storage stability, easier processability, easier extraction of compounds), and/or improved seed quality (i.e., for use in following seasons).

As used herein, the term “plants” refers to any and all physical parts of a plant, including but not limited to seeds, seedlings, saplings, roots, tubers, stems, stalks, foliage, and fruits.

As used herein, the term “plant growth regulation” or “regulating plant growth” includes restricting vertical stem growth, promoting root growth, stunting, increasing stem diameter and stem-wall thickness, and the like.

As used herein, the term “surfactant” means an agriculturally acceptable material which imparts emulsifiability, stability, spreading, wetting, dispersibility or other surface-modifying properties. Examples of suitable surfactants include non-ionic, anionic, cationic and ampholytic surfactants.

For purposes of better understanding the present teachings and in no way limiting the scope of the teachings, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, use of the term “about” herein specifically includes ±10% from the indicated values in the range. In addition, the endpoints of all ranges directed to the same component or property herein are inclusive of the endpoints, are independently combinable, and include all intermediate points and ranges.

Unless otherwise specified, references to percentages are by weight (wt.) percentages of the active compounds in the composition of this invention are based on the total weight of active ingredients in the composition, i.e., the active compounds themselves, exclusive of any amounts of solvents, carriers, dispersants, stabilizers or other materials which may be present.

It is further understood that where a parameter range is provided, all integers within that range, and tenths thereof, are also provided by the subject matter. For example, “0.1% to 50%” includes 0.1%, 0.2%, 0.3%, 0.4% etc. up to 50%.

When a ratio herein is to be “X:1 or higher”, it is meant that the ratio is Y:1, where Y is X or greater, and when a ratio is herein to be “X:1 or lower”, it is meant that the ratio is Z:1, where Z is X or less. The same logic follows for ratios that are “1:X or higher” and “1:X or lower”.

### Fungicidal Mixture Combination

It has been surprisingly found that by combining fluazinam with one or more crop fungicidal compounds, mixture combinations are produced, that exhibit a broad spectrum of control and high efficacy against a very wide range of fungi, as well as having long residual effect under different climate conditions. The mixtures and compositions of the present invention are based in part on the finding that application of the mixture combination of the present invention to a locus or area where fungicidal control is desired results in improved control of fungi and prevents further infestation.

In some embodiments, the combination provides a higher fungicidal activity than that envisaged on the basis of the sum of activities of each of fluazinam and the fungicides found therein. Such a combination allows the reduced dosages of the individual fungicide which can damage agriculturally important plants.

In an embodiment, the present invention relates to a fungicidal mixture combination comprising, as active compounds:
1) an effective amount of a fluazinam; and
2) an effective amount of at least one fungicide selected from the group consisting of:
(a) an azole fungicide selected from a group comprising bromuconazole, cyproconazole, difenoconazole, diniconazole, epoxiconazole, fenbuconazole, fluoxytioconazole, fluquinconazole, flusilazole, flutriafol, hexaconazole, imazalil, ipconazole, ipfentrifluconazole, mefentrifluconazole, metconazole, myclobutanil, penconazole, prochloraz, propiconazole, prothioconazole, pyrisoxazole, tebuconazole, tetraconazole, triadimefon, triadimenol, triflumizole, and a combination thereof;
(b) a quinone outside inhibitor (QoI) fungicide selected from a group comprising azoxystrobin, dimoxystrobin, famoxadone, fenamidone, fluoxastrobin, kresoxim-methyl, metarylpicoxamid, metominostrobin, metyltetraprole, picoxystrobin, pyraclostrobin, pyribencarb, trifloxystrobin, and a combination thereof,
(c) a succinate dehydrogenase inhibitor (SDHI) fungicide selected from a group comprising benzovindiflupyr, bixafen, boscalid, flubeneteram, fluindapyr, fluopyram, flutolanil, fluxapyroxad, inpyrfluxam, isofetamid, isoflucypram, isopyrazam, penthiopyrad, pydiflumetofen, pyrapropoyne, thifluzamide, and a combination thereof,
(d) a protectant fungicide selected from a group comprising copper, captan, folpet, and a combination thereof,
(e) a morpholine fungicide selected from a group comprising acibenzolar-s-methyl, fenpropidin, fenpropimorph, spiroxamine, and a combination thereof,
(f) a benzamide fungicide selected from a group comprising fluopicolide, zoxamide, and a combination thereof;
(g) a carboxylic acid amide (CAA) fungicide selected from a group comprising benthiavalicarb-isopropyl, dimethomorph, iprovalicarb, mandipropamid, valifenalate and a combination thereof,
(h) a cyanoacetamideoxime fungicide selected from a group comprising cymoxanil;
(i) an Isothiazole fungicide selected from a group comprising Dichlobentiazox;
(j) a melanin biosynthesis inhibitor reductase (MI-R) fungicide selected from a group comprising tolprocarb, tricyclazole, and a combination thereof,
(k) an oxysterol binding protein homologue inhibition (OSBPI) fungicide selected from a group comprising fluoxapiprolin, oxathiapiprolin, and a combination thereof,
(l) a phenylamide fungicide selected from a group comprising benalaxyl, metalaxyl, metalaxyl-methyl, oxadixyl, and a combination thereof,
(m) a phosphonate fungicide selected from a group comprising disodium-phosphonate, fosetyl-al, potassium-bicarbonate, potassium-carbonate, potassium phosphite monobasic, potassium phosphonate, and a combination thereof,
(n) a phenylpyrrole fungicide selected from a group comprising fludioxonil;
(o) a quinone inside inhibitor (QiI) fungicide selected from a group comprising amisulbrom, cyazofamid, Fenpicoxamid, florylpicoxamid and a combination thereof,
(p) a quinone outside inhibitor fungicide of stigmatellin binding type (QoSI) selected from a group comprising Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof,

It has now been surprisingly found that a composition comprising a combination of i) an effective amount of fluazinam, when mixed in certain ratios with an effective amount of at least one fungicide selected from the group consisting of:
(a) an azole fungicide;
(b) a quinone outside inhibitor (QoI) fungicide;
(c) a succinate dehydrogenase inhibitor (SDHI) fungicide;
(d) a protectant fungicide;
(e) a morpholine fungicide;
(f) a benzamide fungicide;
(g) a carboxylic acid amide (CAA) fungicide;
(h) a cyanoacetamideoxime fungicide;
(i) an Isothiazole fungicide;
(j) a melanin biosynthesis inhibitor reductase (MI-R) fungicide;
(k) an oxysterol binding protein homologue inhibition (OSBPI) fungicide;
(l) a phenylamide fungicide;
(m) a phosphonate fungicide;
(n) a phenylpyrrole fungicide;
(o) a quinone inside inhibitor (QiI) fungicide;
(p) a quinone outside inhibitor fungicide of stigmatellin binding type (QoSI) fungicide; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof,
has a synergistically increased action on the control of fungal diseases in crop plants without causing phytotoxicity to the plants. A particular advantage of the composition according to the present invention is that this synergistic effect among the active components allows for a reduction of the total amount of fluazinam or a fungicide used on the crops while still having a good control of fungal diseases.

It was also surprisingly found that a composition comprising a combination of i) an effective amount of fluazinam, when mixed in certain ratios with an effective amount of at least two fungicides selected from the group consisting of:
(a) an azole fungicide;
(b) a quinone outside inhibitor (QoI) fungicide;
(c) a succinate dehydrogenase inhibitor (SDHI) fungicide;
(d) a protectant fungicide;
(e) a morpholine fungicide;
(f) a benzamide fungicide;
(g) a carboxylic acid amide (CAA) fungicide;
(h) a cyanoacetamideoxime fungicide;
(i) an Isothiazole fungicide;
(j) a melanin biosynthesis inhibitor reductase (MI-R) fungicide;
(k) an oxysterol binding protein homologue inhibition (OSBPI) fungicide;
(l) a phenylamide fungicide;
(m) a phosphonate fungicide;
(n) a phenylpyrrole fungicide;
(o) a quinone inside inhibitor (QiI) fungicide;
(p) a quinone outside inhibitor fungicide of stigmatellin binding type (QoSI) fungicide; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof,
has a synergistically increased action on the control of fungal diseases in crop plants without causing phytotoxicity to the plants. A particular advantage of the composition according to the present invention is that this synergistic effect among fluazinam and two or more active components allows for a reduction of the total amount of fluazinam or two more fungicides used on the crops while still having a good control of fungal diseases.

It has now been found that a combination comprising fluazinam and at least one fungicide selected from the group consisting of:
(a) an azole fungicide;
(b) a quinone outside inhibitor (QoI) fungicide;
(c) a succinate dehydrogenase inhibitor (SDHI) fungicide;
(d) a protectant fungicide;
(e) a morpholine fungicide;
(f) a benzamide fungicide;
(g) a carboxylic acid amide (CAA) fungicide;
(h) a cyanoacetamideoxime fungicide;
(i) an Isothiazole fungicide;
(j) a melanin biosynthesis inhibitor reductase (MI-R) fungicide;
(k) an oxysterol binding protein homologue inhibition (OSBPI) fungicide;
(l) a phenylamide fungicide;
(m) a phosphonate fungicide;
(n) a phenylpyrrole fungicide;
(o) a quinone inside inhibitor (QiI) fungicide;
(p) a quinone outside inhibitor fungicide of stigmatellin binding type (QoSI) fungicide; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof,
has an increased action on protecting plant or soil against fungal attack, preventing fungal infection of plant or soil, controlling fungal disease infecting plant or soil, and reducing fungal infection of plant or soil without causing phytotoxicity to the plant. The increased action can be a synergistically increased action. A particular advantage of the combination according to the present invention is that this synergistic effect among the active components allows for a reduction of the total amount of fluazinam or one or more fungicides used on the plant or soil while still having a good effect of treating the plant or soil against fungal infection. Synergism occurs when the effect of two or more compounds exceeds the effect of the compounds when used alone.

In some embodiments, the combination comprises fluazinam and one or more azole fungicides.

In some embodiments, the combination comprises fluazinam and an azole fungicide.

In some embodiments, the combination comprises fluazinam and one or more QoI fungicides.

In some embodiments, the combination comprises fluazinam and a QoI fungicide.

In some embodiments, the combination comprises fluazinam and one or more SDHI fungicides.

In some embodiments, the combination comprises fluazinam and an SDHI fungicide.

In some embodiments, the combination comprises fluazinam and one or more protectant fungicides.

In some embodiments, the combination comprises fluazinam and a protectant fungicide.

In some embodiments, the combination comprises fluazinam and one or more morpholine fungicides.

In some embodiments, the combination comprises fluazinam and a morpholine fungicide.

In some embodiments, the combination comprises fluazinam and one or more benzamide fungicides.

In some embodiments, the combination comprises fluazinam and a benzamide fungicide.

In some embodiments, the combination comprises fluazinam and one or more CAA fungicides.

In some embodiments, the combination comprises fluazinam and a CAA fungicide.

In some embodiments, the combination comprises fluazinam and one or more cyanoacetamideoxime fungicides.

In some embodiments, the combination comprises fluazinam and a cyanoacetamideoxime fungicide.

In some embodiments, the combination comprises fluazinam and one or more Isothiazole fungicides.

In some embodiments, the combination comprises fluazinam and an Isothiazole fungicide.

In some embodiments, the combination comprises fluazinam and one or more MBI-R fungicides.

In some embodiments, the combination comprises fluazinam and an MBI-R fungicide.

In some embodiments, the combination comprises fluazinam and one or more OSBPI fungicides.

In some embodiments, the combination comprises fluazinam and an OSBPI fungicide.

In some embodiments, the combination comprises fluazinam and one or more phenylamide fungicides.

In some embodiments, the combination comprises fluazinam and a phenylamide fungicide.

In some embodiments, the combination comprises fluazinam and one or more phosphonate fungicides.

In some embodiments, the combination comprises fluazinam and a phosphonate fungicide.

In some embodiments, the combination comprises fluazinam and one or more phenylpyrrole fungicides.

In some embodiments, the combination comprises fluazinam and a phenylpyrrole fungicide.

In some embodiments, the combination comprises fluazinam and one or more QiI fungicides.

In some embodiments, the combination comprises fluazinam and a QiI fungicide.

In some embodiments, the combination comprises fluazinam and one or more QoSI fungicides.

In some embodiments, the combination comprises fluazinam and a QoSI fungicide.

In some embodiments, the combination comprises fluazinam and one or more fungicides selected from a group comprising aminopyrifen, chlorinconazide, dipymetitrone, flufenoxadiazam, ipflufenoquin, picarbutrazox, pyridachlometyl and quinofumelin.

In some embodiments, the combination comprises fluazinam, an azole fungicide and a QoI fungicide.

In some embodiments, the combination comprises fluazinam, an azole fungicide and a SDHI fungicide.

In some embodiments, the combination comprises fluazinam, an azole fungicide and a protectant fungicide.

In some embodiments, the combination comprises fluazinam, an azole fungicide and a morpholine fungicide.

In some embodiments, the combination comprises fluazinam, an azole fungicide and a benzamide fungicide.

In some embodiments, the combination comprises fluazinam, an azole fungicide and a CAA fungicide.

In some embodiments, the combination comprises fluazinam, an azole fungicide and a cyanoacetamideoxime fungicide.

In some embodiments, the combination comprises fluazinam, an azole fungicide and an Isothiazole fungicide.

In some embodiments, the combination comprises fluazinam, an azole fungicide and an MBI-R fungicide.

In some embodiments, the combination comprises fluazinam, an azole fungicide and an OSBPI fungicide.

In some embodiments, the combination comprises fluazinam, an azole fungicide and a phenylamide fungicide.

In some embodiments, the combination comprises fluazinam, an azole fungicide and a phosphonate fungicide.

In some embodiments, the combination comprises fluazinam, an azole fungicide and a phenylpyrrole fungicide.

In some embodiments, the combination comprises fluazinam, an azole fungicide and a QiI fungicide.

In some embodiments, the combination comprises fluazinam, an azole fungicide and a QoSI fungicide.

In some embodiments, the combination comprises fluazinam, an azole fungicide and a fungicide selected from a group comprising aminopyrifen, chlorinconazide, dipymetitrone, flufenoxadiazam, ipflufenoquin, picarbutrazox, pyridachlometyl, quinofumelin.

In some further embodiments, an azole fungicide is selected from a group comprising bromuconazole, cyproconazole, difenoconazole, diniconazole, epoxiconazole, fenbuconazole, fluoxytioconazole, fluquinconazole, flusilazole, flutriafol, hexaconazole, imazalil, ipconazole, ipfentrifluconazole, mefentrifluconazole, metconazole, myclobutanil, penconazole, prochloraz, propiconazole, prothioconazole, pyrisoxazole, tebuconazole, tetraconazole, triadimefon, triadimenol, triflumizole, and a combination thereof.

In some embodiments, an azole fungicide is bromuconazole.

In some embodiments, an azole fungicide is cyproconazole.

In some embodiments, an azole fungicide is difenoconazole.

In some embodiments, an azole fungicide is diniconazole.

In some embodiments, an azole fungicide is epoxiconazole.

In some embodiments, an azole fungicide is fenbuconazole.

In some embodiments, an azole fungicide is fluoxytioconazole.

In some embodiments, an azole fungicide is fluquinconazole.

In some embodiments, an azole fungicide is flusilazole.

In some embodiments, an azole fungicide is flutriafol.

In some embodiments, an azole fungicide is hexaconazole.

In some embodiments, an azole fungicide is imazalil.

In some embodiments, an azole fungicide is ipconazole.

In some embodiments, an azole fungicide is ipfentrifluconazole.

In some embodiments, an azole fungicide is mefentrifluconazole.

In some embodiments, an azole fungicide is metconazole.

In some embodiments, an azole fungicide is myclobutanil.

In some embodiments, an azole fungicide is penconazole.

In some embodiments, an azole fungicide is prochloraz.

In some embodiments, an azole fungicide is propiconazole.

In some embodiments, an azole fungicide is prothioconazole.

In some embodiments, an azole fungicide is pyrisoxazole.

In some embodiments, an azole fungicide is tebuconazole.

In some embodiments, an azole fungicide is tetraconazole.

In some embodiments, an azole fungicide is triadimefon.

In some embodiments, an azole fungicide is triadimenol.

In some embodiments, an azole fungicide is triflumizole.

In some embodiments, a quinone outside inhibitor (QoI) fungicide is selected from a group comprising azoxystrobin, dimoxystrobin, famoxadone, fenamidone, fluoxastrobin, kresoxim-methyl, metarylpicoxamid, metominostrobin, metyltetraprole, picoxystrobin, pyraclostrobin, pyribencarb, trifloxystrobin, and a combination thereof.

In some embodiments, a QoI fungicide is azoxystrobin.

In some embodiments, a QoI fungicide is dimoxystrobin.

In some embodiments, a QoI fungicide is famoxadone.

In some embodiments, a QoI fungicide is fenamidone.

In some embodiments, a QoI fungicide is fluoxastrobin.

In some embodiments, a QoI fungicide is kresoxim-methyl.

In some embodiments, a QoI fungicide is metarylpicoxamid.

In some embodiments, a QoI fungicide is metominostrobin.

In some embodiments, a QoI fungicide is metyltetraprole.

In some embodiments, a QoI fungicide is picoxystrobin.

In some embodiments, a QoI fungicide is pyraclostrobin.

In some embodiments, a QoI fungicide is pyribencarb.

In some embodiments, a QoI fungicide is trifloxystrobin.

In some embodiments, a succinate dehydrogenase inhibitor (SDHI) fungicide is selected from a group comprising benzovindiflupyr, bixafen, boscalid, flubeneteram, fluindapyr, fluopyram, flutolanil, fluxapyroxad, inpyrfluxam, isofetamid, isoflucypram, isopyrazam, penthiopyrad, pydiflumetofen, pyrapropoyne, thifluzamide, and a combination thereof.

In some embodiments, a SDHI fungicide is benzovindiflupyr.

In some embodiments, a SDHI fungicide is bixafen.

In some embodiments, a SDHI fungicide is boscalid.

In some embodiments, a SDHI fungicide is flubeneteram.

In some embodiments, a SDHI fungicide is fluindapyr.

In some embodiments, a SDHI fungicide is fluopyram.

In some embodiments, a SDHI fungicide is flutolanil.

In some embodiments, a SDHI fungicide is fluxapyroxad.

In some embodiments, a SDHI fungicide is inpyrfluxam.

In some embodiments, a SDHI fungicide is isofetamid.

In some embodiments, a SDHI fungicide is isoflucypram.

In some embodiments, a SDHI fungicide is isopyrazam.

In some embodiments, a SDHI fungicide is penthiopyrad.

In some embodiments, a SDHI fungicide is pydiflumetofen.

In some embodiments, a SDHI fungicide is pyrapropoyne.

In some embodiments, a SDHI fungicide is thifluzamide.

In some embodiments, a protectant fungicide is selected from a group comprising copper, captan, folpet, and a combination thereof.

In some embodiments, a protectant fungicide is copper.

In some embodiments, a protectant fungicide is captan.

In some embodiments, a protectant fungicide is folpet.

In some embodiments, a morpholine fungicide is selected from a group comprising acibenzolar-s-methyl, fenpropidin, fenpropimorph, spiroxamine, and a combination thereof.

In some embodiments, a morpholine fungicide is acibenzolar-s-methyl.

In some embodiments, a morpholine fungicide is fenpropidin.

In some embodiments, a morpholine fungicide is fenpropimorph.

In some embodiments, a morpholine fungicide is spiroxamine.

In some embodiments, a benzamide fungicide is selected from a group comprising fluopicolide, zoxamide, and a combination thereof.

In some embodiments, a benzamide fungicide is fluopicolide.

In some embodiments, a benzamide fungicide is zoxamide.

In some embodiments, a carboxylic acid amide (CAA) fungicide is selected from a group comprising benthiavalicarb-isopropyl, dimethomorph, iprovalicarb, mandipropamid, valifenalate and a combination thereof.

In some embodiments, a CAA fungicide is benthiavalicarb-isopropyl.

In some embodiments, a CAA fungicide is dimethomorph.

In some embodiments, a CAA fungicide is iprovalicarb.

In some embodiments, a CAA fungicide is mandipropamid.

In some embodiments, a CAA fungicide is valifenalate.

In some embodiments, a cyanoacetamideoxime fungicide is selected from a group comprising cymoxanil.

In some embodiments, a cyanoacetamideoxime fungicide is cymoxanil.

In some embodiments, an Isothiazole fungicide is selected from a group comprising Dichlobentiazox.

In some embodiments, an Isothiazole fungicide is Dichlobentiazox.

In some embodiments, a melanin biosynthesis inhibitor reductase (MBI-R) fungicide is selected from a group comprising tolprocarb, tricyclazole, and a combination thereof.

In some embodiments, a MBI-R fungicide is tolprocarb.

In some embodiments, a MBI-R fungicide is tricyclazole.

In some embodiments, an oxysterol binding protein homologue inhibition (OSBPI) fungicide is selected from a group comprising fluoxapiprolin, oxathiapiprolin, and a combination thereof.

In some embodiments, an OSBPI fungicide is fluoxapiprolin.

In some embodiments, an OSBPI fungicide is oxathiapiprolin.

In some embodiments, a phenylamide fungicide is selected from a group comprising benalaxyl, metalaxyl, metalaxyl-methyl, oxadixyl, and a combination thereof.

In some embodiments, a phenylamide fungicide is benalaxyl.

In some embodiments, a phenylamide fungicide is metalaxyl.

In some embodiments, a phenylamide fungicide is metalaxyl-methyl.

In some embodiments, a phenylamide fungicide is oxadixyl.

In some embodiments, a phosphonate fungicide is selected from a group comprising disodium-phosphonate, fosetyl-al, potassium phosphite monobasic, potassium phosphonate, and a combination thereof.

In some embodiments, a phosphonate fungicide is disodium-phosphonate.

In some embodiments, a phosphonate fungicide is fosetyl-al.

In some embodiments, a phosphonate fungicide is potassium phosphite monobasic.

In some embodiments, a phosphonate fungicide is potassium phosphonate.

In some embodiments, a phenylpyrrole fungicide is selected from a group comprising fludioxonil.

In some embodiments, a phenylpyrrole fungicide is fludioxonil.

In some embodiments, a quinone inside inhibitor (QiI) fungicide is selected from a group comprising amisulbrom, cyazofamid, Fenpicoxamid, florylpicoxamid and a combination thereof.

In some embodiments, a QiI fungicide is amisulbrom.

In some embodiments, a QiI fungicide is cyazofamid.

In some embodiments, a QiI fungicide is fenpicoxamid.

In some embodiments, a QiI fungicide is florylpicoxamid.

In some embodiments, a quinone outside inhibitor fungicide of stigmatellin binding type (QoSI) is selected from a group comprising Ametoctradin.

In some embodiments, a QoSI fungicide is Ametoctradin.

In some embodiments, other fungicide is selected from a group comprising aminopyrifen, chlorinconazide, dipymetitrone, flufenoxadiazam, ipflufenoquin, picarbutrazox, pyridachlometyl, quinofumelin, and combinations thereof.

In some embodiments, other fungicide is aminopyrifen.

In some embodiments, other fungicide is chlorinconazide.

In some embodiments, other fungicide is dipymetitrone.

In some embodiments, other fungicide is flufenoxadiazam.

In some embodiments, other fungicide is ipflufenoquin.

In some embodiments, other fungicide is picarbutrazox.

In some embodiments, other fungicide is pyridachlometyl.

In some embodiments, other fungicide is quinofumelin.

In some specific embodiments, the combination of the present invention comprises fluazinam and difenoconazole.

In some specific embodiments, the combination of the present invention comprises fluazinam and fluoxytioconazole.

In some specific embodiments, the combination of the present invention comprises fluazinam and ipfentrifluconazole.

In some specific embodiments, the combination of the present invention comprises fluazinam and mefentrifluconazole.

In some specific embodiments, the combination of the present invention comprises fluazinam and prothioconazole.

In some specific embodiments, the combination of the present invention comprises fluazinam and tebuconazole.

In some specific embodiments, the combination of the present invention comprises fluazinam and azoxystrobin.

In some specific embodiments, the combination of the present invention comprises fluazinam and dimoxystrobin.

In some specific embodiments, the combination of the present invention comprises fluazinam and fluoxastrobin.

In some specific embodiments, the combination of the present invention comprises fluazinam and kresoxim-m.

In some specific embodiments, the combination of the present invention comprises fluazinam and metarylpicoxamid.

In some specific embodiments, the combination of the present invention comprises fluazinam and metominostrobin.

In some specific embodiments, the combination of the present invention comprises fluazinam and metyltetraprole.

In some specific embodiments, the combination of the present invention comprises fluazinam and picoxystrobin.

In some specific embodiments, the combination of the present invention comprises fluazinam and pyraclostrobin.

In some specific embodiments, the combination of the present invention comprises fluazinam and trifloxystrobin.

In some specific embodiments, the combination of the present invention comprises fluazinam and mandestrobin.

In some specific embodiments, the combination of the present invention comprises fluazinam and benzovindiflupyr.

In some specific embodiments, the combination of the present invention comprises fluazinam and boscalid.

In some specific embodiments, the combination of the present invention comprises fluazinam and flubeneteram.

In some specific embodiments, the combination of the present invention comprises fluazinam and fluindapyr.

In some specific embodiments, the combination of the present invention comprises fluazinam and fluopyram.

In some specific embodiments, the combination of the present invention comprises fluazinam and fluxapyroxad.

In some specific embodiments, the combination of the present invention comprises fluazinam and Inpyrfluxam.

In some specific embodiments, the combination of the present invention comprises fluazinam and Isoflucypram.

In some specific embodiments, the combination of the present invention comprises fluazinam and pydiflumetofen.

In some specific embodiments, the combination of the present invention comprises fluazinam and copper.

In some specific embodiments, the combination of the present invention comprises fluazinam and captan.

In some specific embodiments, the combination of the present invention comprises fluazinam and folpet.

In some specific embodiments, the combination of the present invention comprises fluazinam and fenpropidin.

In some specific embodiments, the combination of the present invention comprises fluazinam and fenpropimorph.

In some specific embodiments, the combination of the present invention comprises fluazinam and spiroxamine.

In some specific embodiments, the combination of the present invention comprises fluazinam and fluopicolide.

In some specific embodiments, the combination of the present invention comprises fluazinam and zoxamide.

In some specific embodiments, the combination of the present invention comprises fluazinam and mandipropamid.

In some specific embodiments, the combination of the present invention comprises fluazinam and valifenalate.

In some specific embodiments, the combination of the present invention comprises fluazinam and cymoxanil.

In some specific embodiments, the combination of the present invention comprises fluazinam and dichlobentiazox.

In some specific embodiments, the combination of the present invention comprises fluazinam and tricyclazole.

In some specific embodiments, the combination of the present invention comprises fluazinam and fluoxapiprolin.

In some specific embodiments, the combination of the present invention comprises fluazinam and oxathiapiprolin.

In some specific embodiments, the combination of the present invention comprises fluazinam and benalaxyl.

In some specific embodiments, the combination of the present invention comprises fluazinam and metalaxyl-m.

In some specific embodiments, the combination of the present invention comprises fluazinam and oxadixyl.

In some specific embodiments, the combination of the present invention comprises fluazinam and disodium-phosphonate.

In some specific embodiments, the combination of the present invention comprises fluazinam and fosetyl-Al.

In some specific embodiments, the combination of the present invention comprises fluazinam and potassium-phosphonate.

In some specific embodiments, the combination of the present invention comprises fluazinam and fludioxonil.

In some specific embodiments, the combination of the present invention comprises fluazinam and cyazofamid.

In some specific embodiments, the combination of the present invention comprises fluazinam and fenpicoxamid.

In some specific embodiments, the combination of the present invention comprises fluazinam and florylpicoxamid.

In some specific embodiments, the combination of the present invention comprises fluazinam and ametoctradin.

In some specific embodiments, the combination of the present invention comprises fluazinam and aminopyrifen.

In some specific embodiments, the combination of the present invention comprises fluazinam and chlorinconazide.

In some specific embodiments, the combination of the present invention comprises fluazinam and dipymetitrone.

In some specific embodiments, the combination of the present invention comprises fluazinam and flufenoxadiazam.

In some specific embodiments, the combination of the present invention comprises fluazinam and ipflufenoquin.

In some specific embodiments, the combination of the present invention comprises fluazinam and picarbutrazox.

In some specific embodiments, the combination of the present invention comprises fluazinam and pyridachlometyl.

In some specific embodiments, the combination of the present invention comprises fluazinam and quinofumelin.

In some embodiments, the combination of the present invention comprises fluazinam and at least two fungicides selected from the list of actives mentioned hereinbefore.

In some specific embodiments, the combination of the present invention comprises fluazinam, prothioconazole and picoxystrobin.

In some specific embodiments, the combination of the present invention comprises fluazinam, prothioconazole and fluxapyroxad.

In some specific embodiments, the combination of the present invention comprises fluazinam, prothioconazole and fenpropidin.

In some specific embodiments, the combination of the present invention comprises fluazinam, tebuconazole and picoxystrobin.

In some specific embodiments, the combination of the present invention comprises fluazinam, tebuconazole and fluxapyroxad.

In some specific embodiments, the combination of the present invention comprises fluazinam, tebuconazole and fenpropidin.

In some specific embodiments, the combination of the present invention comprises fluazinam, picoxystrobin and fluxapyroxad.

In some specific embodiments, the combination of the present invention comprises fluazinam, picoxystrobin and fenpropidin.

In some specific embodiments, the combination of the present invention comprises fluazinam, fluxapyroxad and fenpropidin.

It was also found that these combinations help prevent fungal attack and thus enable the use of a reduced amount of fluazinam or the respective fungicides at a later stage of the plant development. The present combination is capable of limiting or destroying the microorganisms which occur on plants or parts of plants of a variety of crops of useful plants, and even on parts of plants which are formed at a later point in time and remain unharmed by such microorganisms.

In order to solve one of the problems encountered in the state of the art, the present invention developed a method for reducing the phytotoxicity of fungicide on crops, in particular, in Potato, Tomato, Pulses, Peanuts, Grapes, Strawberry, flowers and ornamentals, chilli, Avocado, Mango and Pistachio, Sugar beet, corn, coffee, Soybean, cotton, cereals, Banana, Barley, Rice, Turf, Lawns, Golf courses, Pome fruit, Sunflower and Lettuces. It has now been found that fluazinam when mixed with at least one of the active ingredients as mentioned hereinbefore, shows clearly reduced phytotoxicity.

The combinations according to the invention may also comprise more than one of the active components (a) to (q), if broadening of the spectrum of disease control is desired. The present invention also provides a synergistic combination comprising (1) an amount of fluazinam, and (2) an amount of at least one additional fungicide selected from the group consisting of:
(a) an azole fungicide selected from a group comprising bromuconazole, cyproconazole, difenoconazole, diniconazole, epoxiconazole, fenbuconazole, fluoxytioconazole, fluquinconazole, flusilazole, flutriafol, hexaconazole, imazalil, ipconazole, ipfentrifluconazole, mefentrifluconazole, metconazole, myclobutanil, penconazole, prochloraz, propiconazole, prothioconazole, pyrisoxazole, tebuconazole, tetraconazole, triadimefon, triadimenol, triflumizole, and a combination thereof;
(b) a quinone outside inhibitor (QoI) fungicide selected from a group comprising azoxystrobin, dimoxystrobin, famoxadone, fenamidone, fluoxastrobin, kresoxim-methyl, metarylpicoxamid, metominostrobin, metyltetraprole, picoxystrobin, pyraclostrobin, pyribencarb, trifloxystrobin, and a combination thereof,
(c) a succinate dehydrogenase inhibitor (SDHI) fungicide selected from a group comprising benzovindiflupyr, bixafen, boscalid, flubeneteram, fluindapyr, fluopyram, flutolanil, fluxapyroxad, inpyrfluxam, isofetamid, isoflucypram, isopyrazam, penthiopyrad, pydiflumetofen, pyrapropoyne, thifluzamide, and a combination thereof,
(d) a protectant fungicide selected from a group comprising copper, captan, folpet, and a combination thereof,
(e) a morpholine fungicide selected from a group comprising acibenzolar-s-methyl, fenpropidin, fenpropimorph, spiroxamine, and a combination thereof,
(f) a benzamide fungicide selected from a group comprising fluopicolide, zoxamide, and a combination thereof,
(g) a carboxylic acid amide (CAA) fungicide selected from a group comprising benthiavalicarb-isopropyl, dimethomorph, iprovalicarb, mandipropamid, valifenalate and a combination thereof,
(h) a cyanoacetamideoxime fungicide selected from a group comprising cymoxanil;
(i) an Isothiazole fungicide selected from a group comprising Dichlobentiazox;
(j) a melanin biosynthesis inhibitor reductase (MI-R) fungicide selected from a group comprising tolprocarb, tricyclazole, and a combination thereof,
(k) an oxysterol binding protein homologue inhibition (OSBPI) fungicide selected from a group comprising fluoxapiprolin, oxathiapiprolin, and a combination thereof,
(l) a phenylamide fungicide selected from a group comprising benalaxyl, metalaxyl, metalaxyl-methyl, oxadixyl, and a combination thereof,
(m) a phosphonate fungicide selected from a group comprising disodium-phosphonate, fosetyl-al, potassium-bicarbonate, potassium-carbonate, potassium phosphite monobasic, potassium phosphonate, and a combination thereof,
(n) a phenylpyrrole fungicide selected from a group comprising fludioxonil;
(o) a quinone inside inhibitor (QiI) fungicide selected from a group comprising amisulbrom, cyazofamid, Fenpicoxamid, florylpicoxamid and a combination thereof,
(p) a quinone outside inhibitor fungicide of stigmatellin binding type (QoSI) selected from a group comprising Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof,
wherein the combination is more effective for treating a plant or soil against fungal disease than when fluazinam and the fungicide(s) at the same amount is applied alone.

The present invention also provides a synergistic combination comprising (1) an amount of fluazinam, and (2) an amount of at least one additional fungicide selected from the group consisting of:
(a) an azole fungicide selected from a group comprising bromuconazole, cyproconazole, difenoconazole, diniconazole, epoxiconazole, fenbuconazole, fluoxytioconazole, fluquinconazole, flusilazole, flutriafol, hexaconazole, imazalil, ipconazole, ipfentrifluconazole, mefentrifluconazole, metconazole, myclobutanil, penconazole, prochloraz, propiconazole, prothioconazole, pyrisoxazole, tebuconazole, tetraconazole, triadimefon, triadimenol, triflumizole, and a combination thereof;
(b) a quinone outside inhibitor (QoI) fungicide selected from a group comprising azoxystrobin, dimoxystrobin, famoxadone, fenamidone, fluoxastrobin, kresoxim-methyl, metarylpicoxamid, metominostrobin, metyltetraprole, picoxystrobin, pyraclostrobin, pyribencarb, trifloxystrobin, and a combination thereof,
(c) a succinate dehydrogenase inhibitor (SDHI) fungicide selected from a group comprising benzovindiflupyr, bixafen, boscalid, flubeneteram, fluindapyr, fluopyram, flutolanil, fluxapyroxad, inpyrfluxam, isofetamid, isoflucypram, isopyrazam, penthiopyrad, pydiflumetofen, pyrapropoyne, thifluzamide, and a combination thereof,
(d) a protectant fungicide selected from a group comprising copper, captan, folpet, and a combination thereof,
(e) a morpholine fungicide selected from a group comprising acibenzolar-s-methyl, fenpropidin, fenpropimorph, spiroxamine, and a combination thereof,
(f) a benzamide fungicide selected from a group comprising fluopicolide, zoxamide, and a combination thereof,
(g) a carboxylic acid amide (CAA) fungicide selected from a group comprising benthiavalicarb-isopropyl, dimethomorph, iprovalicarb, mandipropamid, valifenalate and a combination thereof,
(h) a cyanoacetamideoxime fungicide selected from a group comprising cymoxanil;
(i) an Isothiazole fungicide selected from a group comprising Dichlobentiazox;
(j) a melanin biosynthesis inhibitor reductase (MI-R) fungicide selected from a group comprising tolprocarb, tricyclazole, and a combination thereof;
(k) an oxysterol binding protein homologue inhibition (OSBPI) fungicide selected from a group comprising fluoxapiprolin, oxathiapiprolin, and a combination thereof,
(l) a phenylamide fungicide selected from a group comprising benalaxyl, metalaxyl, metalaxyl-methyl, oxadixyl, and a combination thereof,
(m) a phosphonate fungicide selected from a group comprising disodium-phosphonate, fosetyl-al, potassium-bicarbonate, potassium-carbonate, potassium phosphite monobasic, potassium phosphonate, and a combination thereof,
(n) a phenylpyrrole fungicide selected from a group comprising fludioxonil;
(o) a quinone inside inhibitor (QiI) fungicide selected from a group comprising amisulbrom, cyazofamid, Fenpicoxamid, florylpicoxamid and a combination thereof;
(p) a quinone outside inhibitor fungicide of stigmatellin binding type (QoSI) selected from a group comprising Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof;
wherein the amount of fluazinam in the mixture is less than the fungicidally effective amount of fluazinam when fluazinam is used alone, and/or
wherein the amount of the fungicide(s) in the mixture is less than the fungicidally effective amount of the fungicide when the fungicide is used alone.

The present invention also provides a fungicidal composition comprising any one of the combinations or mixtures disclosed herein.

In some embodiments, the combination, mixture or composition comprises an azole fungicide. In some embodiments, the amount of the azole fungicide in the mixture is less than the fungicidally effective amount of the azole fungicide when the azole fungicide is used alone.

In some embodiments, the combination, mixture or composition comprises a quinone outside inhibitor (QoI) fungicide. In some embodiments, the amount of the quinone outside inhibitor (QoI) fungicide in the mixture is less than the fungicidally effective amount of the quinone outside inhibitor (QoI) fungicide when the QoI fungicide is used alone.

In some embodiments, the combination, mixture or composition comprises a succinate dehydrogenase inhibitor (SDHI) fungicide. In some embodiments, the amount of the SDHI fungicide in the mixture is less than the fungicidally effective amount of the SDHI fungicide when the SDHI fungicide is used alone.

In some embodiments, the combination, mixture or composition comprises a protectant fungicide. In some embodiments, the amount of the protectant fungicide in the mixture is less than the fungicidally effective amount of the protectant fungicide when the protectant fungicide is used alone.

In some embodiments, the combination, mixture or composition comprises a morpholine fungicide. In some embodiments, the amount of the morpholine fungicide in the mixture is less than the fungicidally effective amount of the morpholine fungicide when the morpholine fungicide is used alone.

In some embodiments, the combination, mixture or composition comprises a benzamide fungicide. In some embodiments, the amount of the benzamide fungicide in the mixture is less than the fungicidally effective amount of the benzamide fungicide when the benzamide fungicide is used alone.

In some embodiments, the combination, mixture or composition comprises a carboxylic acid amide (CAA) fungicide. In some embodiments, the amount of the CAA fungicide in the mixture is less than the fungicidally effective amount of the CAA fungicide when the CAA fungicide is used alone.

In some embodiments, the combination, mixture or composition comprises a cyanoacetamideoxime fungicide. In some embodiments, the amount of the cyanoacetamideoxime fungicide in the mixture is less than the fungicidally effective amount of the cyanoacetamideoxime fungicide when the cyanoacetamideoxime fungicide is used alone.

In some embodiments, the combination, mixture or composition comprises an isothiazole fungicide. In some embodiments, the amount of the isothiazole fungicide in the mixture is less than the fungicidally effective amount of the isothiazole fungicide when the isothiazole fungicide is used alone.

In some embodiments, the combination, mixture or composition comprises a melanin biosynthesis inhibitor reductase (MI-R) fungicide. In some embodiments, the amount of the MBI-R fungicide in the mixture is less than the fungicidally effective amount of the MBI-R fungicide when the MBI-R fungicide is used alone.

In some embodiments, the combination, mixture or composition comprises an oxysterol binding protein homologue inhibition (OSBPI) fungicide. In some embodiments, the amount of the OSBPI fungicide in the mixture is less than the fungicidally effective amount of the OSBPI fungicide when the OSBPI fungicide is used alone.

In some embodiments, the combination, mixture or composition comprises a phenylamide fungicide. In some embodiments, the amount of the phenylamide fungicide in the mixture is less than the fungicidally effective amount of the phenylamide fungicide when the phenylamide fungicide is used alone.

In some embodiments, the combination, mixture or composition comprises a phosphonate fungicide. In some embodiments, the amount of the phosphonate fungicide in the mixture is less than the fungicidally effective amount of the phosphonate fungicide when the phosphonate fungicide is used alone.

In some embodiments, the combination, mixture or composition comprises a phenylpyrrole fungicide. In some embodiments, the amount of the phenylpyrrole fungicide in the mixture is less than the fungicidally effective amount of the phenylpyrrole fungicide when the phenylpyrrole fungicide is used alone.

In some embodiments, the combination, mixture or composition comprises a quinone inside inhibitor (QiI) fungicide. In some embodiments, the amount of the QiI fungicide in the mixture is less than the fungicidally effective amount of the QiI fungicide when the QiI fungicide is used alone.

In some embodiments, the combination, mixture or composition comprises a quinone outside inhibitor fungicide of stigmatellin binding type (QoSI) fungicide. In some embodiments, the amount of the QoSI fungicide in the mixture is less than the fungicidally effective amount of the QoSI fungicide when the QoSI fungicide is used alone.

In some embodiments, the combination, mixture or composition comprises aminopyrifen. In some embodiments, the amount of aminopyrifen in the mixture is less than the fungicidally effective amount of aminopyrifen when aminopyrifen is used alone.

In some embodiments, the combination, mixture or composition comprises chlorinconazide. In some embodiments, the amount of chlorinconazide in the mixture is less than the fungicidally effective amount of chlorinconazide when chlorinconazide is used alone.

In some embodiments, the combination, mixture or composition comprises dipymetitrone. In some embodiments, the amount of dipymetitrone in the mixture is less than the fungicidally effective amount of dipymetitrone when dipymetitrone is used alone.

In some embodiments, the combination, mixture or composition comprises flufenoxadiazam. In some embodiments, the amount of flufenoxadiazam in the mixture is less than the fungicidally effective amount of flufenoxadiazam when flufenoxadiazam is used alone.

In some embodiments, the combination, mixture or composition comprises ipflufenoquin. In some embodiments, the amount of ipflufenoquin in the mixture is less than the fungicidally effective amount of ipflufenoquin when ipflufenoquin is used alone.

In some embodiments, the combination, mixture or composition comprises picarbutrazox. In some embodiments, the amount of picarbutrazox in the mixture is less than the fungicidally effective amount of picarbutrazox when picarbutrazox is used alone.

In some embodiments, the combination, mixture or composition comprises pyridachlometyl. In some embodiments, the amount of pyridachlometyl in the mixture is less than the fungicidally effective amount of pyridachlometyl when pyridachlometyl is used alone.

In some embodiments, the combination, mixture or composition comprises quinofumelin. In some embodiments, the amount of quinofumelin in the mixture is less than the fungicidally effective amount of quinofumelin when quinofumelin is used alone.

In some embodiments, the combination, mixture or composition is more effective for protecting the plant or soil against fungal attack infection than when fluazinam or the fungicide at the same amount is applied alone. In some embodiments, the combination, mixture or composition is more effective for preventing fungal infection of the plant or soil infection than when fluazinam or each fungicide at the same amount is applied alone. In some embodiments, the combination, mixture or composition is more effective for controlling fungal disease infecting the plant or soil infection than when fluazinam or each fungicide at the same amount is applied alone. In some embodiments, the combination, mixture or composition is more effective for reducing fungal infection of the plant or soil infection than when fluazinam or each fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when fluazinam at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the azole fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the QoI fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the SDHI fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the protectant fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the morpholine fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the benzamide fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the CAA fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the cyanoacetamideoxime fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the Isothiazole fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the MBI-R fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the OSBPI fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the phenylamide fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the phosphonate fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the phenylpyrrole fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the QiI fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the QoSI fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when aminopyrifen at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when chlorinconazide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when dipymetitrone at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when flufenoxadiazam at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when ipflufenoquin at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when picarbutrazox at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when pyridachlometyl at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when quinofumelin at the same amount is applied alone.

The present invention also provides a mixture for controlling crop disease, the mixture comprising
1) an effective amount of fluazinam; and
2) an effective amount of at least one fungicide selected from the group consisting of:
(a) an azole fungicide selected from a group comprising bromuconazole, cyproconazole, difenoconazole, diniconazole, epoxiconazole, fenbuconazole, fluoxytioconazole, fluquinconazole, flusilazole, flutriafol, hexaconazole, imazalil, ipconazole, ipfentrifluconazole, mefentrifluconazole, metconazole, myclobutanil, penconazole, prochloraz, propiconazole, prothioconazole, pyrisoxazole, tebuconazole, tetraconazole, triadimefon, triadimenol, triflumizole, and a combination thereof;
(b) a quinone outside inhibitor (QoI) fungicide selected from a group comprising azoxystrobin, dimoxystrobin, famoxadone, fenamidone, fluoxastrobin, kresoxim-methyl, metarylpicoxamid, metominostrobin, metyltetraprole, picoxystrobin, pyraclostrobin, pyribencarb, trifloxystrobin, and a combination thereof;
(c) a succinate dehydrogenase inhibitor (SDHI) fungicide selected from a group comprising benzovindiflupyr, bixafen, boscalid, flubeneteram, fluindapyr, fluopyram, flutolanil, fluxapyroxad, inpyrfluxam, isofetamid, isoflucypram, isopyrazam, penthiopyrad, pydiflumetofen, pyrapropoyne, thifluzamide, and a combination thereof,
(d) a protectant fungicide selected from a group comprising copper, captan, folpet, and a combination thereof,
(e) a morpholine fungicide selected from a group comprising acibenzolar-s-methyl, fenpropidin, fenpropimorph, spiroxamine, and a combination thereof,
(f) a benzamide fungicide selected from a group comprising fluopicolide, zoxamide, and a combination thereof,
(g) a carboxylic acid amide (CAA) fungicide selected from a group comprising benthiavalicarb-isopropyl, dimethomorph, iprovalicarb, mandipropamid, valifenalate and a combination thereof,
(h) a cyanoacetamideoxime fungicide selected from a group comprising cymoxanil;
(i) an Isothiazole fungicide selected from a group comprising Dichlobentiazox;
(j) a melanin biosynthesis inhibitor reductase (MBI-R) fungicide selected from a group comprising tolprocarb, tricyclazole, and a combination thereof,
(k) an oxysterol binding protein homologue inhibition (OSBPI) fungicide selected from a group comprising fluoxapiprolin, oxathiapiprolin, and a combination thereof,
(l) a phenylamide fungicide selected from a group comprising benalaxyl, metalaxyl, metalaxyl-methyl, oxadixyl, and a combination thereof,
(m) a phosphonate fungicide selected from a group comprising disodium-phosphonate, fosetyl-al, potassium-bicarbonate, potassium-carbonate, potassium phosphite monobasic, potassium phosphonate, and a combination thereof,
(n) a phenylpyrrole fungicide selected from a group comprising fludioxonil;
(o) a quinone inside inhibitor (QiI) fungicide selected from a group comprising amisulbrom, cyazofamid, Fenpicoxamid, florylpicoxamid and a combination thereof,
(p) a quinone outside inhibitor fungicide of stigmatellin binding type (QoSI) selected from a group comprising Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof,
wherein the crop diseases are selected from a group comprising are Early blight, Didymella pisi, Botrytis, leaf spot of beet, Gray Leaf Spot, Northern Corn Leaf Spot, Southern corn leaf blight, Coffee Berry Disease, Anthracnose, Target spot, Fusarium head blight, Coffee Leaf Rust, Black sigatoka in Banana, Asian soybean rust, Late blight, Downy mildew, Yellow sigatoka in Banana, Downy mildew, Brown rust, Yellow rust, Net blotch, Rice Blast, Ramularia leaf spot, Sheath Blight; Dollar spot, Sclerotinia, Northern Corn Leaf Blight, Scab, Septoria.

Most preferred target fungal diseases are Early blight in Potato and Tomato; Didymella pisi in Pulses and Peanuts; Botrytis in Grapes, Strawberry, flowers and ornamentals, tomato, chilli, Avocado, Mango and Pistachio; leaf spot of beet in Sugar beet; Gray Leaf Spot in corn; Northern Corn Leaf Spot in corn, Southern corn leaf blight in corn, Coffee Berry Disease in coffee; Anthracnose in Pulses and Peanuts, Anthracnose in chilli, Target spot in Soybean and cotton; Fusarium head blight in cereals; Coffee Leaf Rust in coffee; Black sigatoka in Banana; Asian soybean rust in soybean; Late blight in Potato and Tomato; Downy mildew in Grapes; Yellow sigatoka in Banana; Downy mildew in Cucurbits; Brown rust in cereals; Yellow rust in cereals; Net blotch in Barley; Rice Blast in Rice; Ramularia leaf spot in cotton; Ramularia leaf spot in Sugar beet; Ramularia leaf spot in Cereals, Sheath Blight in Rice; Dollar spot in Turf, Lawns, Golf courses; Sclerotinia in OSR, Soybean, Sunflower and Lettuces; Northern Corn Leaf Blight in corn; Rust in sugar beet; Scab in Pome fruit; and Septoria in Cereals.

The present invention also provides a mixture for controlling fungus, the mixture comprising
1) an effective amount of a fluazinam; and
2) an effective amount of at least one fungicide selected from the group consisting of:
(a) an azole fungicide selected from a group comprising bromuconazole, cyproconazole, difenoconazole, diniconazole, epoxiconazole, fenbuconazole, fluoxytioconazole, fluquinconazole, flusilazole, flutriafol, hexaconazole, imazalil, ipconazole, ipfentrifluconazole, mefentrifluconazole, metconazole, myclobutanil, penconazole, prochloraz, propiconazole, prothioconazole, pyrisoxazole, tebuconazole, tetraconazole, triadimefon, triadimenol, triflumizole, and a combination thereof;
(b) a quinone outside inhibitor (QoI) fungicide selected from a group comprising azoxystrobin, dimoxystrobin, famoxadone, fenamidone, fluoxastrobin, kresoxim-methyl, metarylpicoxamid, metominostrobin, metyltetraprole, picoxystrobin, pyraclostrobin, pyribencarb, trifloxystrobin, and a combination thereof,
(c) a succinate dehydrogenase inhibitor (SDHI) fungicide selected from a group comprising benzovindiflupyr, bixafen, boscalid, flubeneteram, fluindapyr, fluopyram, flutolanil, fluxapyroxad, inpyrfluxam, isofetamid, isoflucypram, isopyrazam, penthiopyrad, pydiflumetofen, pyrapropoyne, thifluzamide, and a combination thereof,
(d) a protectant fungicide selected from a group comprising copper, captan, folpet, and a combination thereof,
(e) a morpholine fungicide selected from a group comprising acibenzolar-s-methyl, fenpropidin, fenpropimorph, spiroxamine, and a combination thereof,
(f) a benzamide fungicide selected from a group comprising fluopicolide, zoxamide, and a combination thereof,
(g) a carboxylic acid amide (CAA) fungicide selected from a group comprising benthiavalicarb-isopropyl, dimethomorph, iprovalicarb, mandipropamid, valifenalate and a combination thereof,
(h) a cyanoacetamideoxime fungicide selected from a group comprising cymoxanil;
(i) an Isothiazole fungicide selected from a group comprising Dichlobentiazox;
(j) a melanin biosynthesis inhibitor reductase (MBI-R) fungicide selected from a group comprising tolprocarb, tricyclazole, and a combination thereof,
(k) an oxysterol binding protein homologue inhibition (OSBPI) fungicide selected from a group comprising fluoxapiprolin, oxathiapiprolin, and a combination thereof,
(l) a phenylamide fungicide selected from a group comprising benalaxyl, metalaxyl, metalaxyl-methyl, oxadixyl, and a combination thereof,
(m) a phosphonate fungicide selected from a group comprising disodium-phosphonate, fosetyl-al, potassium-bicarbonate, potassium-carbonate, potassium phosphite monobasic, potassium phosphonate, and a combination thereof,
(n) a phenylpyrrole fungicide selected from a group comprising fludioxonil;
(o) a quinone inside inhibitor (QiI) fungicide selected from a group comprising amisulbrom, cyazofamid, Fenpicoxamid, florylpicoxamid and a combination thereof,
(p) a quinone outside inhibitor fungicide of stigmatellin binding type (QoSI) selected from a group comprising Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof,
wherein the fungi are selected from a group comprising phoma (Leptosphaeria maculans), Alternaria sp. (Early blight) in Potato and Tomato; Ascochytafabae (Didymella pisi) in Pulses and Peanuts; Botrytis sp. (Botrytis) in Grapes, Strawberry, flowers and ornamentals, tomato, chilli, Avocado, Mango and Pistachio; Cercospora beticola (leaf spot of beet) in Sugar beet; Cercospora zeae-maydis (Gray Leaf Spot) in corn; Cochlobolus carbonum (Northern Corn Leaf Spot) in corn, Cochliobolus heterostrophus (Southern corn leaf blight) in corn, Colletotrichum kahawae (Coffee Berry Disease) in coffee; Colletotrichum sp. (Anthracnose) in Pulses and Peanuts, Colletotrichum truncatum (Anthracnose) in chilli, Corynespora cassiicola (Target spot) in Soybean and cotton; Fusarium sp. (Fusarium head blight) in cereals; Hemileia vastatrix (Coffee Leaf Rust) in coffee; Mycosphaerella fijiensis (Black sigatoka) in Banana; Phakopsora pachyrhizi (Asian soybean rust) in soybean; Phytophthora infestans (Late blight) in Potato and Tomato; Plasmopara viticola (Downy mildew) in Grapes; Pseudocercospora musae (Yellow sigatoka) in Banana; Pseudoperonospora cubensis (Downy mildew) in Cucurbits; Puccinia recondite (Brown rust) in cereals; Puccinia striiformis (Yellow rust) in cereals; Pyrenophora teres (Net blotch) in Barley; Pyricularia oryzae (Rice Blast) in Rice; Ramularia areola (Ramularia leaf spot) in cotton; Ramularia beticola (Ramularia leaf spot) in Sugar beet; Ramularia collo-cygni (Ramularia leaf spot) in Cereals, Rhizoctonia solani/Thanatephorus cucumeris (Sheath Blight) in Rice; Sclerotinia homeocarpa (Dollar spot) in Turf, Lawns, Golf courses; Sclerotinia sclerotiorum (Sclerotinia) in OSR, Soybean, Sunflower and Lettuces; Setosphaeria turcica (Northern Corn Leaf Blight) in corn; Uromyces betae (Rust) in sugar beet; Venturia inaequalis (Scab) in Pome fruit; and Zymoseptoria tritici (Septoria) in Cereals.

In some embodiments, most preferred target fungal diseases include, but not limited to phoma (Leptosphaeria maculans), Phytophthora infestans (Late blight) in Potato and Tomato, Plasmopara viticola (Downy mildew) in Grapes, Pseudoperonospora cubensis (Downy mildew) in Cucurbits, Alternaria sp. (Early blight) in Potato and Tomato, Cercospora zeae-maydis (Gray Leaf Spot) in corn, Cochliobolus carbonum (Northern Corn Leaf Spot) in corn, Cochliobolus heterostrophus (Southern corn leaf blight) in corn, Colletotrichum kahawae (Coffee Berry Disease) in coffee, Colletotrichum truncatum (Anthracnose) in chilli, Corynespora cassiicola (Target spot) in Soybean and cotton, Phakopsora pachyrhizi (Asian soybean rust) in soybean, Puccinia recondite (Brown rust) in cereals, Puccinia striiformis (Yellow rust) in cereals, Pyrenophora teres (Net blotch) in Barley, Pyricularia oryzae (Rice Blast) in Rice, Ramularia areola (Ramularia leaf spot) in cotton, Ramularia collo-cygni (Ramularia leaf spot) in Cereals, Sclerotinia homeocarpa (Dollar spot) in Turf, Lawns, Golf courses, Uromyces betae (Rust) in sugar beet.

In some more specific embodiments, target fungal diseases include Asian Soybean Rust (Phakopsora pachyrizzi), phoma (Leptosphaeria maculans), Phakopsora pachyrhizi (Asian soybean rust), Phytophthora infestans (Late blight), Pyrenophora teres (Net blotch), Rhizoctonia solani, Venturia inaequalis (Scab) and Zymoseptoria tritici (Septoria).

In some most specific embodiments, the combination, mixture or composition comprises fluazinam and difenoconazole for controlling fungi selected from a group comprising Alternaria sp. (Early blight) in Potato and Tomato, Cercospora beticola (leaf spot of beet) in Sugar beet, Cercospora zeae-maydis (Gray Leaf Spot) in corn, powdery mildew, Venturia inaequalis (Scab) in Pome fruit.

In some most specific embodiments, the combination, mixture or composition comprises fluazinam and Epoxiconazole for controlling fungi selected from a group comprising Zymoseptoria tritici, Septoria tritici, Venturia inaequalis, Phytophthora infestans, Rhizoctonia solani, net blotch (Pyrenophora teres f. teres), phoma (Leptosphaeria maculans) and Asian Soybean Rust (Phakopsora pachyrizzi).

In some most specific embodiments, the combination, mixture or composition comprises fluazinam and Ipfentrifluconazole for controlling fungi selected from a group comprising Zymoseptoria tritici, Septoria tritici, Venturia inaequalis, Phytophthora infestans, Rhizoctonia solani, net blotch (Pyrenophora teres f. teres), phoma (Leptosphaeria maculans) and Asian Soybean Rust (Phakopsora pachyrizzi).

In some most specific embodiments, the combination, mixture or composition comprises fluazinam and Prothioconazole for controlling fungi selected from a group comprising Zymoseptoria tritici, Septoria tritici, Venturia inaequalis, Phytophthora infestans, Rhizoctonia solani, net blotch (Pyrenophora teres f. teres), phoma (Leptosphaeria maculans) and Asian Soybean Rust (Phakopsora pachyrizzi).

In some most specific embodiments, the combination, mixture or composition comprises fluazinam and fluoxytioconazole for controlling fungi selected from a group comprising Alternaria sp. (Early blight) in Potato and Tomato, Cercospora beticola (leaf spot of beet) in Sugar beet, Cercospora zeae-maydis (Gray Leaf Spot) in corn, powdery mildew, Venturia inaequalis (Scab) in Pome fruit.

In some most specific embodiments, the combination, mixture or composition comprises fluazinam and ipfentrifluconazole for controlling fungi selected from a group comprising Alternaria sp. (Early blight) in Potato and Tomato, Cercospora beticola (leaf spot of beet) in Sugar beet, Cercospora zeae-maydis (Gray Leaf Spot) in corn, powdery mildew, Venturia inaequalis (Scab) in Pome fruit.

In some most specific embodiments, the combination, mixture or composition comprises fluazinam and mefentrifluconazole for controlling fungi selected from a group comprising Alternaria sp. (Early blight) in Potato and Tomato, Cercospora beticola (leaf spot of beet) in Sugar beet, Cercospora zeae-maydis (Gray Leaf Spot) in corn, powdery mildew, Venturia inaequalis (Scab) in Pome fruit.

In some most specific embodiments, the combination, mixture or composition comprises fluazinam and prothioconazole for controlling fungi selected from a group comprising Alternaria sp. (Early blight) in Potato and Tomato, Cercospora beticola (leaf spot of beet) in Sugar beet, Cercospora zeae-maydis (Gray Leaf Spot) in corn, powdery mildew, Setosphaeria turcica (Northern Corn Leaf Blight) in corn.

In some most specific embodiments, the combination, mixture or composition comprises fluazinam and Flubeneteram for controlling fungi selected from a group comprising Zymoseptoria tritici, Septoria tritici, Venturia inaequalis, Phytophthora infestans, Rhizoctonia solani, net blotch (Pyrenophora teres f. teres), phoma (Leptosphaeria maculans) and Asian Soybean Rust (Phakopsora pachyrizzi).

In some most specific embodiments, the combination, mixture or composition comprises fluazinam and azoxystrobin for controlling fungi selected from a group comprising Alternaria sp. (Early blight) in Potato and Tomato, Cercospora zeae-maydis (Gray Leaf Spot) in corn, Cochliobolus carbonum (Northern Corn Leaf Spot) in corn, Cochliobolus heterostrophus (Southern corn leaf blight) in corn, Colletotrichum kahawae (Coffee Berry Disease) in coffee, Colletotrichum truncatum (Anthracnose) in chilli, Corynespora cassiicola (Target spot) in Soybean and cotton, Phakopsora pachyrhizi (Asian soybean rust) in soybean, Puccinia recondite (Brown rust) in cereals, Puccinia striiformis (Yellow rust) in cereals, Pyrenophora teres (Net blotch) in Barley, Pyricularia oryzae (Rice Blast) in Rice, Ramularia areola (Ramularia leaf spot) in cotton, Ramularia collo-cygni (Ramularia leaf spot) in Cereals, Sclerotinia homeocarpa (Dollar spot) in Turf, Lawns, Golf courses, Uromyces betae (Rust) in sugar beet, Zymoseptoria tritici (Septoria) in Cereals.

In some most specific embodiments, the combination, mixture or composition comprises fluazinam and Pyridachlometyl for controlling fungi selected from a group comprising Zymoseptoria tritici, Septoria tritici, Venturia inaequalis, Phytophthora infestans, Rhizoctonia solani, net blotch (Pyrenophora teres f. teres), phoma (Leptosphaeria maculans) and Asian Soybean Rust (Phakopsora pachyrizzi).

In some most specific embodiments, the combination, mixture or composition comprises fluazinam and Picarbutrazox for controlling fungi selected from a group comprising Zymoseptoria tritici, Septoria tritici, Venturia inaequalis, Phytophthora infestans, Rhizoctonia solani, net blotch (Pyrenophora teres f. teres), phoma (Leptosphaeria maculans) and Asian Soybean Rust (Phakopsora pachyrizzi).

In some most specific embodiments, the combination, mixture or composition comprises fluazinam and Florylpicoxamid for controlling fungi selected from a group comprising Zymoseptoria tritici, Septoria tritici, Venturia inaequalis, Phytophthora infestans, Rhizoctonia solani, net blotch (Pyrenophora teres f. teres), phoma (Leptosphaeria maculans) and Asian Soybean Rust (Phakopsora pachyrizzi).

In some most specific embodiments, the combination, mixture or composition comprises fluazinam and Fluxapyroxad for controlling fungi selected from a group comprising Zymoseptoria tritici, Septoria tritici, Venturia inaequalis, Phytophthora infestans, Rhizoctonia solani, net blotch (Pyrenophora teres f. teres), phoma (Leptosphaeria maculans) and Asian Soybean Rust (Phakopsora pachyrizzi).

In some most specific embodiments, the combination, mixture or composition comprises fluazinam and metyltetraprole for controlling fungi selected from a group comprising Cercospora zeae-maydis (Gray Leaf Spot) in corn, Cochliobolus carbonum (Northern Corn Leaf Spot) in corn, Cochliobolus heterostrophus (Southern corn leaf blight) in corn, Colletotrichum kahawae (Coffee Berry Disease) in coffee, Colletotrichum truncatum (Anthracnose) in chilli, Corynespora cassiicola (Target spot) in Soybean and cotton, Hemileia vastatrix (Coffee Leaf Rust) in coffee, Phakopsora pachyrhizi (Asian soybean rust) in soybean, Puccinia recondite (Brown rust) in cereals, Puccinia striiformis (Yellow rust) in cereals, Pyrenophora teres (Net blotch) in Barley, Pyricularia oryzae (Rice Blast) in Rice, Ramularia areola (Ramularia leaf spot) in cotton, Ramularia collo-cygni (Ramularia leaf spot) in Cereals, Sclerotinia homeocarpa (Dollar spot) in Turf, Lawns, Golf courses, Zymoseptoria tritici (Septoria) in Cereals.

In some most specific embodiments, the combination, mixture or composition comprises fluazinam and picoxystrobin for controlling fungi selected from a group comprising Alternaria sp. (Early blight) in Potato and Tomato, Cercospora zeae-maydis (Gray Leaf Spot) in corn, Cochliobolus carbonum (Northern Corn Leaf Spot) in corn, Cochliobolus heterostrophus (Southern corn leaf blight) in corn, Colletotrichum kahawae (Coffee Berry Disease) in coffee, Colletotrichum truncatum (Anthracnose) in chilli, Corynespora cassiicola (Target spot) in Soybean and cotton, Phakopsora pachyrhizi (Asian soybean rust) in soybean, Puccinia recondite (Brown rust) in cereals, Puccinia striiformis (Yellow rust) in cereals, Pyrenophora teres (Net blotch) in Barley, Pyricularia oryzae (Rice Blast) in Rice, Ramularia areola (Ramularia leaf spot) in cotton, Ramularia collo-cygni (Ramularia leaf spot) in Cereals, Sclerotinia homeocarpa (Dollar spot) in Turf, Lawns, Golf courses, Uromyces betae (Rust) in sugar beet, Zymoseptoria tritici (Septoria) in Cereals.

In some most specific embodiments, the combination, mixture or composition comprises fluazinam and picoxystrobin for controlling fungi selected from a group comprising phoma (Leptosphaeria maculans), Zymoseptoria tritici, Septoria tritici, Venturia inaequalis, Phytophthora infestans, Rhizoctonia solani, net blotch (Pyrenophora teres f. teres) and Asian Soybean Rust (Phakopsora pachyrizzi).

In some most specific embodiments, the combination, mixture or composition comprises fluazinam and pyraclostrobin for controlling fungi selected from a group comprising Alternaria sp. (Early blight) in Potato and Tomato, Cercospora zeae-maydis (Gray Leaf Spot) in corn, Cochliobolus carbonum (Northern Corn Leaf Spot) in corn, Cochliobolus heterostrophus (Southern corn leaf blight) in corn, Colletotrichum kahawae (Coffee Berry Disease) in coffee, Colletotrichum truncatum (Anthracnose) in chilli, Corynespora cassiicola (Target spot) in Soybean and cotton, Phakopsora pachyrhizi (Asian soybean rust) in soybean, Puccinia recondite (Brown rust) in cereals, Puccinia striiformis (Yellow rust) in cereals, Pyrenophora teres (Net blotch) in Barley, Pyricularia oryzae (Rice Blast) in Rice, Ramularia areola (Ramularia leaf spot) in cotton, Ramularia collo-cygni (Ramularia leaf spot) in Cereals, Sclerotinia homeocarpa (Dollar spot) in Turf, Lawns, Golf courses, Uromyces betae (Rust) in sugar beet, Zymoseptoria tritici (Septoria) in Cereals.

In some most specific embodiments, the combination, mixture or composition comprises fluazinam and mandestrobin for controlling fungi selected from a group comprising Alternaria sp. (Early blight) in Potato and Tomato, Cercospora zeae-maydis (Gray Leaf Spot) in corn, Cochliobolus carbonum (Northern Corn Leaf Spot) in corn, Cochliobolus heterostrophus (Southern corn leaf blight) in corn, Colletotrichum kahawae (Coffee Berry Disease) in coffee, Colletotrichum truncatum (Anthracnose) in chilli, Corynespora cassiicola (Target spot) in Soybean and cotton, Phakopsora pachyrhizi (Asian soybean rust) in soybean, Puccinia recondite (Brown rust) in cereals, Puccinia striiformis (Yellow rust) in cereals, Pyrenophora teres (Net blotch) in Barley, Pyricularia oryzae (Rice Blast) in Rice, Ramularia areola (Ramularia leaf spot) in cotton, Ramularia collo-cygni (Ramularia leaf spot) in Cereals, Sclerotinia homeocarpa (Dollar spot) in Turf, Lawns, Golf courses, Uromyces betae (Rust) in sugar beet, Zymoseptoria tritici (Septoria) in Cereals.

In some most specific embodiments, the combination, mixture or composition comprises fluazinam and mandestrobin for controlling fungi selected from a group comprising Alternaria sp. (Early blight) in Potato and Tomato, Cercospora zeae-maydis (Gray Leaf Spot) in corn, Cochliobolus carbonum (Northern Corn Leaf Spot) in corn, Cochliobolus heterostrophus (Southern corn leaf blight) in corn, Colletotrichum kahawae (Coffee Berry Disease) in coffee, Colletotrichum truncatum (Anthracnose) in chilli, Corynespora cassiicola (Target spot) in Soybean and cotton, Phakopsora pachyrhizi (Asian soybean rust) in soybean, Puccinia recondite (Brown rust) in cereals, Puccinia striiformis (Yellow rust) in cereals, Pyrenophora teres (Net blotch) in Barley, Pyricularia oryzae (Rice Blast) in Rice, Ramularia areola (Ramularia leaf spot) in cotton, Ramularia collo-cygni (Ramularia leaf spot) in Cereals, Sclerotinia homeocarpa (Dollar spot) in Turf, Lawns, Golf courses, Uromyces betae (Rust) in sugar beet, Zymoseptoria tritici (Septoria) in Cereals.

In some most specific embodiments, the combination, mixture or composition comprises fluazinam and benzovindiflupyr for controlling fungi selected from a group comprising Fusarium sp. (Fusarium head blight) in cereals, Phakopsora pachyrhizi (Asian soybean rust) in soybean, Puccinia recondite (Brown rust) in cereals, Ramularia areola (Ramularia leaf spot) in cotton, Sclerotinia homeocarpa (Dollar spot) in Turf, Lawns, Golf courses, Sclerotinia sclerotiorum (Sclerotinia) in OSR, Soybean, Sunflower and Lettuces, Setosphaeria turcica (Northern Corn Leaf Blight) in corn, Uromyces betae (Rust) in sugar beet, Zymoseptoria tritici (Septoria) in Cereals.

In some most specific embodiments, the combination, mixture or composition comprises fluazinam and fluindapyr for controlling fungi selected from a group comprising Fusarium sp. (Fusarium head blight) in cereals, Phakopsora pachyrhizi (Asian soybean rust) in soybean, Puccinia recondite (Brown rust) in cereals, Ramularia areola (Ramularia leaf spot) in cotton, Sclerotinia homeocarpa (Dollar spot) in Turf, Lawns, Golf courses, Sclerotinia sclerotiorum (Sclerotinia) in OSR, Soybean, Sunflower and Lettuces, Setosphaeria turcica (Northern Corn Leaf Blight) in corn, Uromyces betae (Rust) in sugar beet, Zymoseptoria tritici (Septoria) in Cereals.

In some most specific embodiments, the combination, mixture or composition comprises fluazinam and fluopyram for controlling fungi selected from a group comprising Corynespora cassiicola (Target spot) in Soybean and cotton, Pseudoperonospora cubensis (Downy mildew) in Cucurbits, Pyricularia oryzae (Rice Blast) in Rice, Rhizoctonia solani/Thanatephorus cucumeris (Sheath Blight) in Rice; Sclerotinia homeocarpa (Dollar spot) in Turf, Lawns, Golf courses; Sclerotinia sclerotiorum (Sclerotinia) in OSR, Soybean, Sunflower and Lettuces; Venturia inaequalis (Scab) in Pome fruit; and Zymoseptoria tritici (Septoria) in Cereals.

In some most specific embodiments, the combination, mixture or composition comprises fluazinam and fluxapyroxad for controlling fungi selected from a group comprising Fusarium sp. (Fusarium head blight) in cereals, Phakopsora pachyrhizi (Asian soybean rust) in soybean, Puccinia recondite (Brown rust) in cereals, Ramularia areola (Ramularia leaf spot) in cotton, Sclerotinia homeocarpa (Dollar spot) in Turf, Lawns, Golf courses, Sclerotinia sclerotiorum (Sclerotinia) in OSR, Soybean, Sunflower and Lettuces, Setosphaeria turcica (Northern Corn Leaf Blight) in corn, Uromyces betae (Rust) in sugar beet, Zymoseptoria tritici (Septoria) in Cereals.

In some most specific embodiments, the combination, mixture or composition comprises fluazinam and Inpyrfluxam for controlling fungi selected from a group comprising Fusarium sp. (Fusarium head blight) in cereals, Phakopsora pachyrhizi (Asian soybean rust) in soybean, Puccinia recondite (Brown rust) in cereals, Ramularia areola (Ramularia leaf spot) in cotton, Sclerotinia homeocarpa (Dollar spot) in Turf, Lawns, Golf courses, Sclerotinia sclerotiorum (Sclerotinia) in OSR, Soybean, Sunflower and Lettuces, Setosphaeria turcica (Northern Corn Leaf Blight) in corn, Uromyces betae (Rust) in sugar beet, Zymoseptoria tritici (Septoria) in Cereals.

In some most specific embodiments, the combination, mixture or composition comprises fluazinam and Isoflucypram for controlling fungi selected from a group comprising Fusarium sp. (Fusarium head blight) in cereals, Phakopsora pachyrhizi (Asian soybean rust) in soybean, Puccinia recondite (Brown rust) in cereals, Ramularia areola (Ramularia leaf spot) in cotton, Sclerotinia homeocarpa (Dollar spot) in Turf, Lawns, Golf courses, Sclerotinia sclerotiorum (Sclerotinia) in OSR, Soybean, Sunflower and Lettuces, Setosphaeria turcica (Northern Corn Leaf Blight) in corn, Uromyces betae (Rust) in sugar beet, Zymoseptoria tritici (Septoria) in Cereals.

In some most specific embodiments, the combination, mixture or composition comprises fluazinam and pydiflumetofen for controlling fungi selected from a group comprising Fusarium sp. (Fusarium head blight) in cereals, Phakopsora pachyrhizi (Asian soybean rust) in soybean, Puccinia recondite (Brown rust) in cereals, Ramularia areola (Ramularia leaf spot) in cotton, Sclerotinia homeocarpa (Dollar spot) in Turf, Lawns, Golf courses, Sclerotinia sclerotiorum (Sclerotinia) in OSR, Soybean, Sunflower and Lettuces, Setosphaeria turcica (Northern Corn Leaf Blight) in corn, Uromyces betae (Rust) in sugar beet, Zymoseptoria tritici (Septoria) in Cereals.

In some most specific embodiments, the combination, mixture or composition comprises fluazinam and captan for controlling fungi selected from a group comprising Colletotrichum kahawae (Coffee Berry Disease) in coffee, Colletotrichum truncatum (Anthracnose) in chilli, Plasmopara viticola (Downy mildew) in Grapes, Venturia inaequalis (Scab) in Pome fruit; Zymoseptoria tritici (Septoria) in Cereals, Alternaria sp. (Early blight) in Potato and Tomato.

In some most specific embodiments, the combination, mixture or composition comprises fluazinam and folpet for controlling fungi selected from a group comprising Ascochyta fabae (Didymella pisi) in Pulses and Peanuts, Zymoseptoria tritici (Septoria) in Cereals, Corynespora cassiicola (Target spot) in Soybean and cotton; Fusarium sp. (Fusarium head blight) in cereals, Pseudoperonospora cubensis (Downy mildew) in Cucurbits.

In some most specific embodiments, the combination, mixture or composition comprises fluazinam and fenpropidin for controlling fungi selected from a group comprising Cercospora beticola (leaf spot of beet) in Sugar beet; Cercospora zeae-maydis (Gray Leaf Spot) in corn; Cochliobolus carbonum (Northern Corn Leaf Spot) in corn, Cochliobolus heterostrophus (Southern corn leaf blight) in corn, Colletotrichum kahawae (Coffee Berry Disease) in coffee; Colletotrichum sp. (Anthracnose) in Pulses and Peanuts, Colletotrichum truncatum (Anthracnose) in chilli, Hemileia vastatrix (Coffee Leaf Rust) in coffee, Phakopsora pachyrhizi (Asian soybean rust) in soybean, Puccinia recondite (Brown rust) in cereals, Puccinia striiformis (Yellow rust) in cereals, Venturia inaequalis (Scab) in Pome fruit; and Zymoseptoria tritici (Septoria) in Cereals.

In some most specific embodiments, the combination, mixture or composition comprises fluazinam and fluopicolide for controlling fungi selected from a group comprising Phytophthora infestans (Late blight) in Potato and Tomato; Plasmopara viticola (Downy mildew) in Grapes, Pseudoperonospora cubensis (Downy mildew) in Cucurbits.

In some most specific embodiments, the combination, mixture or composition comprises fluazinam and zoxamide for controlling fungi selected from a group comprising Phytophthora infestans (Late blight) in Potato and Tomato; Plasmopara viticola (Downy mildew) in Grapes, Pseudoperonospora cubensis (Downy mildew) in Cucurbits.

In some most specific embodiments, the combination, mixture or composition comprises fluazinam and mandipropamid for controlling fungi selected from a group comprising Phytophthora infestans (Late blight) in Potato and Tomato; Plasmopara viticola (Downy mildew) in Grapes, Pseudoperonospora cubensis (Downy mildew) in Cucurbits.

In some most specific embodiments, the combination, mixture or composition comprises fluazinam and cymoxanil for controlling fungi selected from a group comprising Phytophthora infestans (Late blight) in Potato and Tomato; Plasmopara viticola (Downy mildew) in Grapes, Pseudoperonospora cubensis (Downy mildew) in Cucurbits.

In some most specific embodiments, the combination, mixture or composition comprises fluazinam and tricyclazole for controlling fungi selected from a group comprising Alternaria sp. (Early blight) in Potato and Tomato, Pyricularia oryzae (Rice Blast) in Rice, Rhizoctonia solani/Thanatephorus cucumeris (Sheath Blight) in Rice, Venturia inaequalis (Scab) in Pome fruit; Zymoseptoria tritici (Septoria) in Cereals.

In some most specific embodiments, the combination, mixture or composition comprises fluazinam and oxathiapiprolin for controlling fungi selected from a group comprising phoma (Leptosphaeria maculans), Alternaria sp. (Early blight) in Potato and Tomato, Cercospora zeae-maydis (Gray Leaf Spot) in corn, Cochliobolus carbonum (Northern Corn Leaf Spot) in corn, Cochliobolus heterostrophus (Southern corn leaf blight) in corn, Colletotrichum kahawae (Coffee Berry Disease) in coffee, Colletotrichum truncatum (Anthracnose) in chilli, Corynespora cassiicola (Target spot) in Soybean and cotton, Phakopsora pachyrhizi (Asian soybean rust) in soybean, Puccinia recondite (Brown rust) in cereals, Puccinia striiformis (Yellow rust) in cereals, Pyrenophora teres (Net blotch) in Barley, Pyricularia oryzae (Rice Blast) in Rice, Ramularia areola (Ramularia leaf spot) in cotton, Ramularia collo-cygni (Ramularia leaf spot) in Cereals, Sclerotinia homeocarpa (Dollar spot) in Turf, Lawns, Golf courses, Uromyces betae (Rust) in sugar beet, Zymoseptoria tritici (Septoria) in Cereals.

In some most specific embodiments, the combination, mixture or composition comprises fluazinam and metalaxyl-m for controlling fungi selected from a group comprising Phytophthora infestans (Late blight) in Potato and Tomato; Plasmopara viticola (Downy mildew) in Grapes, Pseudoperonospora cubensis (Downy mildew) in Cucurbits.

In some most specific embodiments, the combination, mixture or composition comprises fluazinam and potassium phosphonate for controlling fungi selected from a group comprising Phytophthora infestans (Late blight) in Potato and Tomato; Plasmopara viticola (Downy mildew) in Grapes, Pseudoperonospora cubensis (Downy mildew) in Cucurbits.

In some most specific embodiments, the combination, mixture or composition comprises fluazinam and fludioxonil for controlling fungi selected from a group comprising Botrytis sp. (Botrytis) in Grapes, Strawberry, flowers and ornamentals, tomato, chilli, Avocado, Mango and Pistachio, Venturia inaequalis (Scab) in Pome fruit.

In some most specific embodiments, the combination, mixture or composition comprises fluazinam and cyazofamid for controlling fungi selected from a group comprising Phytophthora infestans (Late blight) in Potato and Tomato; Plasmopara viticola (Downy mildew) in Grapes.

In some most specific embodiments, the combination, mixture or composition comprises fluazinam and fenpicoxamid for controlling fungi selected from a group comprising Phytophthora infestans (Late blight) in Potato and Tomato; Plasmopara viticola (Downy mildew) in Grapes.

In some most specific embodiments, the combination, mixture or composition comprises fluazinam and ametoctradin for controlling fungi selected from a group comprising Phytophthora infestans (Late blight) in Potato and Tomato; Plasmopara viticola (Downy mildew) in Grapes, Pseudoperonospora cubensis (Downy mildew) in Cucurbits.

In some most specific embodiments, the combination, mixture or composition comprises fluazinam and Flutriafol for controlling fungi selected from a group comprising phoma (Leptosphaeria maculans), Zymoseptoria tritici, Septoria tritici, Venturia inaequalis, Phytophthora infestans, Rhizoctonia solani, net blotch (Pyrenophora teres f. teres) and Asian Soybean Rust (Phakopsora pachyrizzi).

In some most specific embodiments, the combination, mixture or composition comprises fluazinam and Aminopyrifen for controlling fungi selected from a group comprising Zymoseptoria tritici, Venturia inaequalis, Septoria tritici, net blotch (Pyrenophora teres f. teres), Phytophthora infestans, Rhizoctonia solani and phoma (Leptosphaeria maculans).

The present invention also provides a mixture for controlling fungus, the mixture comprising
1) an effective amount of a fluazinam; and
2) an effective amount of at least two fungicides selected from the group consisting of:
(a) an azole fungicide selected from a group comprising bromuconazole, cyproconazole, difenoconazole, diniconazole, epoxiconazole, fenbuconazole, fluoxytioconazole, fluquinconazole, flusilazole, flutriafol, hexaconazole, imazalil, ipconazole, ipfentrifluconazole, mefentrifluconazole, metconazole, myclobutanil, penconazole, prochloraz, propiconazole, prothioconazole, pyrisoxazole, tebuconazole, tetraconazole, triadimefon, triadimenol, triflumizole, and a combination thereof;
(b) a quinone outside inhibitor (QoI) fungicide selected from a group comprising azoxystrobin, dimoxystrobin, famoxadone, fenamidone, fluoxastrobin, kresoxim-methyl, metarylpicoxamid, metominostrobin, metyltetraprole, picoxystrobin, pyraclostrobin, pyribencarb, trifloxystrobin, and a combination thereof;
(c) a succinate dehydrogenase inhibitor (SDHI) fungicide selected from a group comprising benzovindiflupyr, bixafen, boscalid, flubeneteram, fluindapyr, fluopyram, flutolanil, fluxapyroxad, inpyrfluxam, isofetamid, isoflucypram, isopyrazam, penthiopyrad, pydiflumetofen, pyrapropoyne, thifluzamide, and a combination thereof,
(d) a protectant fungicide selected from a group comprising copper, captan, folpet, and a combination thereof,
(e) a morpholine fungicide selected from a group comprising acibenzolar-s-methyl, fenpropidin, fenpropimorph, spiroxamine, and a combination thereof,
(f) a benzamide fungicide selected from a group comprising fluopicolide, zoxamide, and a combination thereof,
(g) a carboxylic acid amide (CAA) fungicide selected from a group comprising benthiavalicarb-isopropyl, dimethomorph, iprovalicarb, mandipropamid, valifenalate and a combination thereof;
(h) a cyanoacetamideoxime fungicide selected from a group comprising cymoxanil;
(i) an Isothiazole fungicide selected from a group comprising Dichlobentiazox;
(j) a melanin biosynthesis inhibitor reductase (MBI-R) fungicide selected from a group comprising tolprocarb, tricyclazole, and a combination thereof,
(k) an oxysterol binding protein homologue inhibition (OSBPI) fungicide selected from a group comprising fluoxapiprolin, oxathiapiprolin, and a combination thereof,
(l) a phenylamide fungicide selected from a group comprising benalaxyl, metalaxyl, metalaxyl-methyl, oxadixyl, and a combination thereof,
(m) a phosphonate fungicide selected from a group comprising disodium-phosphonate, fosetyl-al, potassium-bicarbonate, potassium-carbonate, potassium phosphite monobasic, potassium phosphonate, and a combination thereof,
(n) a phenylpyrrole fungicide selected from a group comprising fludioxonil;
(o) a quinone inside inhibitor (QiI) fungicide selected from a group comprising amisulbrom, cyazofamid, Fenpicoxamid, florylpicoxamid and a combination thereof,
(p) a quinone outside inhibitor fungicide of stigmatellin binding type (QoSI) selected from a group comprising Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof,
wherein the fungi are selected from a group comprising phoma (Leptosphaeria maculans), Alternaria sp. (Early blight) in Potato and Tomato; Ascochytafabae (Didymella pisi) in Pulses and Peanuts; Botrytis sp. (Botrytis) in Grapes, Strawberry, flowers and ornamentals, tomato, chilli, Avocado, Mango and Pistachio; Cercospora beticola (leaf spot of beet) in Sugar beet; Cercospora zeae-maydis (Gray Leaf Spot) in corn; Cochliobolus carbonum (Northern Corn Leaf Spot) in corn, Cochliobolus heterostrophus (Southern corn leaf blight) in corn, Colletotrichum kahawae (Coffee Berry Disease) in coffee; Colletotrichum sp. (Anthracnose) in Pulses and Peanuts, Colletotrichum truncatum (Anthracnose) in chilli, Corynespora cassiicola (Target spot) in Soybean and cotton; Fusarium sp. (Fusarium head blight) in cereals; Hemileia vastatrix (Coffee Leaf Rust) in coffee; Mycosphaerella fijiensis (Black sigatoka) in Banana; Phakopsora pachyrhizi (Asian soybean rust) in soybean; Phytophthora infestans (Late blight) in Potato and Tomato; Plasmopara viticola (Downy mildew) in Grapes; Pseudocercospora musae (Yellow sigatoka) in Banana; Pseudoperonospora cubensis (Downy mildew) in Cucurbits; Puccinia recondite (Brown rust) in cereals; Puccinia striiformis (Yellow rust) in cereals; Pyrenophora teres (Net blotch) in Barley; Pyricularia oryzae (Rice Blast) in Rice; Ramularia areola (Ramularia leaf spot) in cotton; Ramularia beticola (Ramularia leaf spot) in Sugar beet; Ramularia collo-cygni (Ramularia leaf spot) in Cereals, Rhizoctonia solani/Thanatephorus cucumeris (Sheath Blight) in Rice; Sclerotinia homeocarpa (Dollar spot) in Turf, Lawns, Golf courses; Sclerotinia sclerotiorum (Sclerotinia) in OSR, Soybean, Sunflower and Lettuces; Setosphaeria turcica (Northern Corn Leaf Blight) in corn; Uromyces betae (Rust) in sugar beet; Venturia inaequalis (Scab) in Pome fruit; and Zymoseptoria tritici (Septoria) in Cereals.

In some embodiments, most preferred target fungal diseases include, but not limited to phoma (Leptosphaeria maculans), Phytophthora infestans (Late blight) in Potato and Tomato, Plasmopara viticola (Downy mildew) in Grapes, Pseudoperonospora cubensis (Downy mildew) in Cucurbits, Alternaria sp. (Early blight) in Potato and Tomato, Cercospora zeae-maydis (Gray Leaf Spot) in corn, Cochliobolus carbonum (Northern Corn Leaf Spot) in corn, Cochliobolus heterostrophus (Southern corn leaf blight) in corn, Colletotrichum kahawae (Coffee Berry Disease) in coffee, Colletotrichum truncatum (Anthracnose) in chilli, Corynespora cassiicola (Target spot) in Soybean and cotton, Phakopsora pachyrhizi (Asian soybean rust) in soybean, Puccinia recondite (Brown rust) in cereals, Puccinia striiformis (Yellow rust) in cereals, Pyrenophora teres (Net blotch) in Barley, Pyricularia oryzae (Rice Blast) in Rice, Ramularia areola (Ramularia leaf spot) in cotton, Ramularia collo-cygni (Ramularia leaf spot) in Cereals, Sclerotinia homeocarpa (Dollar spot) in Turf, Lawns, Golf courses, Sclerotinia sclerotiorum (Sclerotinia) in OSR, Soybean, Sunflower and Lettuces, Uromyces betae (Rust) in sugar beet.

In some most specific embodiments, the combination, mixture or composition comprises fluazinam, prothioconazole and picoxystrobin for controlling fungi selected from a group comprising Phakopsora pachyrhizi (Asian soybean rust) in soybean, Corynespora cassiicola (Target spot) in Soybean and cotton, Sclerotinia homeocarpa (Dollar spot) in Turf, Lawns, Golf courses, Sclerotinia sclerotiorum (Sclerotinia) in OSR, Soybean, Sunflower and Lettuces.

In some more specific embodiments, the combination, mixture or composition comprises fluazinam, prothioconazole and picoxystrobin for controlling Asian Soybean Rust (Phakopsora pachyrizzi).

In some most specific embodiments, the combination, mixture or composition comprises fluazinam, prothioconazole and fluxapyroxad for controlling fungi selected from a group comprising Phakopsora pachyrhizi (Asian soybean rust) in soybean, Corynespora cassiicola (Target spot) in Soybean and cotton, Sclerotinia homeocarpa (Dollar spot) in Turf, Lawns, Golf courses, Sclerotinia sclerotiorum (Sclerotinia) in OSR, Soybean, Sunflower and Lettuces.

In some more specific embodiments, the combination, mixture or composition comprises fluazinam, prothioconazole and fluxapyroxad for controlling Phakopsora pachyrhizi (Asian soybean rust) in soybean.

In some most specific embodiments, the combination, mixture or composition comprises fluazinam, prothioconazole and fenpropidin for controlling fungi selected from a group comprising Phakopsora pachyrhizi (Asian soybean rust) in soybean, Corynespora cassiicola (Target spot) in Soybean and cotton, Sclerotinia homeocarpa (Dollar spot) in Turf, Lawns, Golf courses, Sclerotinia sclerotiorum (Sclerotinia) in OSR, Soybean, Sunflower and Lettuces.

In some most specific embodiments, the combination, mixture or composition comprises fluazinam, tebuconazole and picoxystrobin for controlling fungi selected from a group comprising Phakopsora pachyrhizi (Asian soybean rust) in soybean, Corynespora cassiicola (Target spot) in Soybean and cotton, Sclerotinia homeocarpa (Dollar spot) in Turf, Lawns, Golf courses, Sclerotinia sclerotiorum (Sclerotinia) in OSR, Soybean, Sunflower and Lettuces.

In some most specific embodiments, the combination, mixture or composition comprises fluazinam, tebuconazole and fluxapyroxad for controlling fungi selected from a group comprising Phakopsora pachyrhizi (Asian soybean rust) in soybean, Corynespora cassiicola (Target spot) in Soybean and cotton, Sclerotinia homeocarpa (Dollar spot) in Turf, Lawns, Golf courses, Sclerotinia sclerotiorum (Sclerotinia) in OSR, Soybean, Sunflower and Lettuces.

In some most specific embodiments, the combination, mixture or composition comprises fluazinam, tebuconazole and fenpropidin for controlling fungi selected from a group comprising Phakopsora pachyrhizi (Asian soybean rust) in soybean, Corynespora cassiicola (Target spot) in Soybean and cotton, Sclerotinia homeocarpa (Dollar spot) in Turf, Lawns, Golf courses, Sclerotinia sclerotiorum (Sclerotinia) in OSR, Soybean, Sunflower and Lettuces.

In some most specific embodiments, the combination, mixture or composition comprises fluazinam, picoxystrobin and fluxapyroxad for controlling fungi selected from a group comprising Phakopsora pachyrhizi (Asian soybean rust) in soybean, Corynespora cassiicola (Target spot) in Soybean and cotton, Sclerotinia homeocarpa (Dollar spot) in Turf, Lawns, Golf courses, Sclerotinia sclerotiorum (Sclerotinia) in OSR, Soybean, Sunflower and Lettuces.

In some most specific embodiments, the combination, mixture or composition comprises fluazinam, picoxystrobin and fenpropidin for controlling fungi selected from a group comprising Phakopsora pachyrhizi (Asian soybean rust) in soybean, Corynespora cassiicola (Target spot) in Soybean and cotton, Sclerotinia homeocarpa (Dollar spot) in Turf, Lawns, Golf courses, Sclerotinia sclerotiorum (Sclerotinia) in OSR, Soybean, Sunflower and Lettuces.

In some most specific embodiments, the combination, mixture or composition comprises fluazinam, fluxapyroxad and fenpropidin for controlling fungi selected from a group comprising Phakopsora pachyrhizi (Asian soybean rust) in soybean, Corynespora cassiicola (Target spot) in Soybean and cotton, Sclerotinia homeocarpa (Dollar spot) in Turf, Lawns, Golf courses, Sclerotinia sclerotiorum (Sclerotinia) in OSR, Soybean, Sunflower and Lettuces.

In some most specific embodiments, the combination, mixture or composition comprises fluazinam, prothioconazole and difenoconazole for controlling fungi selected from a group comprising Phakopsora pachyrhizi (Asian soybean rust) in soybean, Corynespora cassiicola (Target spot) in Soybean and cotton, Sclerotinia homeocarpa (Dollar spot) in Turf, Lawns, Golf courses, Sclerotinia sclerotiorum (Sclerotinia) in OSR, Soybean, Sunflower and Lettuces.

In some more specific embodiments, the combination, mixture or composition comprises fluazinam, prothioconazole and difenoconazole for controlling Phakopsora pachyrhizi (Asian soybean rust) in soybean.

In some most specific embodiments, the combination, mixture or composition comprises fluazinam, prothioconazole and copper oxychloride for controlling fungi selected from a group comprising Phakopsora pachyrhizi (Asian soybean rust) in soybean, Corynespora cassiicola (Target spot) in Soybean and cotton, Sclerotinia homeocarpa (Dollar spot) in Turf, Lawns, Golf courses, Sclerotinia sclerotiorum (Sclerotinia) in OSR, Soybean, Sunflower and Lettuces.

In some more specific embodiments, the combination, mixture or composition comprises fluazinam, prothioconazole and copper oxychloride for controlling Phakopsora pachyrhizi (Asian soybean rust) in soybean.

In some embodiments, the mixture is a tank mix. The amount of combination of the invention to be applied, will depend on various factors such as the compound employed, the subject of the treatment (plant, soil, seed), the type of treatment (e.g. spraying, dusting, seed dressing), the purpose of the treatment (prophylactic or therapeutic), the type of fungi to be treated and the application time.

In a preferred embodiment, the fungicidal mixture combination comprising, as active compounds:
1) an effective amount of a fluazinam; and
2) an effective amount of at least one fungicide selected from the group consisting of:
(a) an azole fungicide selected from a group comprising bromuconazole, cyproconazole, difenoconazole, diniconazole, epoxiconazole, fenbuconazole, fluoxytioconazole, fluquinconazole, flusilazole, flutriafol, hexaconazole, imazalil, ipconazole, ipfentrifluconazole, mefentrifluconazole, metconazole, myclobutanil, penconazole, prochloraz, propiconazole, prothioconazole, pyrisoxazole, tebuconazole, tetraconazole, triadimefon, triadimenol, triflumizole, and a combination thereof;
(b) a quinone outside inhibitor (QoI) fungicide selected from a group comprising azoxystrobin, dimoxystrobin, famoxadone, fenamidone, fluoxastrobin, kresoxim-methyl, metarylpicoxamid, metominostrobin, metyltetraprole, picoxystrobin, pyraclostrobin, pyribencarb, trifloxystrobin, and a combination thereof,
(c) a succinate dehydrogenase inhibitor (SDHI) fungicide selected from a group comprising benzovindiflupyr, bixafen, boscalid, flubeneteram, fluindapyr, fluopyram, flutolanil, fluxapyroxad, inpyrfluxam, isofetamid, isoflucypram, isopyrazam, penthiopyrad, pydiflumetofen, pyrapropoyne, thifluzamide, and a combination thereof,
(d) a protectant fungicide selected from a group comprising copper, captan, folpet, and a combination thereof,
(e) a morpholine fungicide selected from a group comprising acibenzolar-s-methyl, fenpropidin, fenpropimorph, spiroxamine, and a combination thereof,
(f) a benzamide fungicide selected from a group comprising fluopicolide, zoxamide, and a combination thereof,
(g) a carboxylic acid amide (CAA) fungicide selected from a group comprising benthiavalicarb-isopropyl, dimethomorph, iprovalicarb, mandipropamid, valifenalate and a combination thereof;
(h) a cyanoacetamideoxime fungicide selected from a group comprising cymoxanil;
(i) an Isothiazole fungicide selected from a group comprising Dichlobentiazox;
(j) a melanin biosynthesis inhibitor reductase (MI-R) fungicide selected from a group comprising tolprocarb, tricyclazole, and a combination thereof,
(k) an oxysterol binding protein homologue inhibition (OSBPI) fungicide selected from a group comprising fluoxapiprolin, oxathiapiprolin, and a combination thereof,
(l) a phenylamide fungicide selected from a group comprising benalaxyl, metalaxyl, metalaxyl-methyl, oxadixyl, and a combination thereof,
(m) a phosphonate fungicide selected from a group comprising disodium-phosphonate, fosetyl-al, potassium-bicarbonate, potassium-carbonate, potassium phosphite monobasic, potassium phosphonate, and a combination thereof,
(n) a phenylpyrrole fungicide selected from a group comprising fludioxonil;
(o) a quinone inside inhibitor (QiI) fungicide selected from a group comprising amisulbrom, cyazofamid, Fenpicoxamid, florylpicoxamid and a combination thereof,
(p) a quinone outside inhibitor fungicide of stigmatellin binding type (QoSI) selected from a group comprising Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof,
wherein the weight ratio of fluazinam to at least one fungicide a) to q) lie in the range from 1:100 to 100:1.

In some embodiments, the combination comprises fluazinam and an azole fungicide in the range from 1:100 to 100:1.

In some specific embodiments, the combination comprises fluazinam and an azole fungicide in the range from 1:1 to 20:1.

In some embodiments, the combination comprises fluazinam and a QoI fungicide in the range from 1:100 to 100:1.

In some specific embodiments, the combination comprises fluazinam and the QoI fungicide in the range from 1:1 to 20:1.

In some embodiments, the combination comprises fluazinam and an SDHI fungicide in the range from 1:100 to 100:1.

In some specific embodiments, the combination comprises fluazinam and the SDHI fungicide in the range from 1:1 to 20:1.

In some embodiments, the combination comprises fluazinam and a protectant fungicide in the range from 1:100 to 100:1.

In some specific embodiments, the combination comprises fluazinam and the protectant fungicide in the range from 1:1 to 20:1.

In some embodiments, the combination comprises fluazinam and a morpholine fungicide in the range from 1:100 to 100:1.

In some specific embodiments, the combination comprises fluazinam and the morpholine fungicide in the range from 1:1 to 20:1.

In some embodiments, the combination comprises fluazinam and a benzamide fungicide in the range from 1:100 to 100:1.

In some specific embodiments, the combination comprises fluazinam and the benzamide fungicide in the range from 1:1 to 20:1.

In some embodiments, the combination comprises fluazinam and a CAA fungicide in the range from 1:100 to 100:1.

In some specific embodiments, the combination comprises fluazinam and the CAA fungicide in the range from 1:1 to 20:1.

In some embodiments, the combination comprises fluazinam and a cyanoacetamideoxime fungicide in the range from 1:100 to 100:1.

In some specific embodiments, the combination comprises fluazinam and the cyanoacetamideoxime fungicide in the range from 1:1 to 20:1.

In some embodiments, the combination comprises fluazinam and a Isothiazole fungicide in the range from 1:100 to 100:1.

In some specific embodiments, the combination comprises fluazinam and the Isothiazole fungicide in the range from 1:1 to 20:1.

In some embodiments, the combination comprises fluazinam and an MBI-R fungicide in the range from 1:100 to 100:1.

In some specific embodiments, the combination comprises fluazinam and the MBI-R fungicide in the range from 1:1 to 20:1.

In some embodiments, the combination comprises fluazinam and an OSBPI fungicide in the range from 1:100 to 100:1.

In some specific embodiments, the combination comprises fluazinam and the OSBPI fungicide in the range from 1:1 to 20:1.

In some embodiments, the combination comprises fluazinam and a phenylamide fungicide in the range from 1:100 to 100:1.

In some specific embodiments, the combination comprises fluazinam and the phenylamide fungicide in the range from 1:1 to 20:1.

In some embodiments, the combination comprises fluazinam and a phosphonate fungicide in the range from 1:100 to 100:1.

In some specific embodiments, the combination comprises fluazinam and the phosphonate fungicide in the range from 1:1 to 20:1.

In some embodiments, the combination comprises fluazinam and a phenylpyrrole fungicide in the range from 1:100 to 100:1.

In some specific embodiments, the combination comprises fluazinam and the phenylpyrrole fungicide in the range from 1:1 to 20:1.

In some embodiments, the combination comprises fluazinam and a QiI fungicide in the range from 1:100 to 100:1.

In some specific embodiments, the combination comprises fluazinam and the QiI fungicide in the range from 1:1 to 20:1.

In some embodiments, the combination comprises fluazinam and aminopyrifen in the range from 1:100 to 100:1.

In some specific embodiments, the combination comprises fluazinam and aminopyrifen in the range from 1:1 to 20:1.

In some embodiments, the combination comprises fluazinam and chlorinconazide in the range from 1:100 to 100:1.

In some specific embodiments, the combination comprises fluazinam and chlorinconazide in the range from 1:1 to 20:1.

In some embodiments, the combination comprises fluazinam and dipymetitrone in the range from 1:100 to 100:1.

In some specific embodiments, the combination comprises fluazinam and dipymetitrone in the range from 1:1 to 20:1.

In some embodiments, the combination comprises fluazinam and flufenoxadiazam in the range from 1:100 to 100:1.

In some specific embodiments, the combination comprises fluazinam and flufenoxadiazam in the range from 1:1 to 20:1.

In some embodiments, the combination comprises fluazinam and ipflufenoquin in the range from 1:100 to 100:1.

In some specific embodiments, the combination comprises fluazinam and ipflufenoquin in the range from 1:1 to 20:1.

In some embodiments, the combination comprises fluazinam and picarbutrazox in the range from 1:100 to 100:1.

In some specific embodiments, the combination comprises fluazinam and picarbutrazox in the range from 1:1 to 20:1.

In some embodiments, the combination comprises fluazinam and pyridachlometyl in the range from 1:100 to 100:1.

In some specific embodiments, the combination comprises fluazinam and pyridachlometyl in the range from 1:1 to 20:1.

In some embodiments, the combination comprises fluazinam and quinofumelin in the range from 1:100 to 100:1.

In some specific embodiments, the combination comprises fluazinam and quinofumelin in the range from 1:1 to 20:1.

In a preferred embodiment, the fungicidal mixture combination comprising, as active compounds:
1) an effective amount of a fluazinam; and
2) an effective amount of at least two fungicides selected from the group consisting of:
(a) an azole fungicide selected from a group comprising bromuconazole, cyproconazole, difenoconazole, diniconazole, epoxiconazole, fenbuconazole, fluoxytioconazole, fluquinconazole, flusilazole, flutriafol, hexaconazole, imazalil, ipconazole, ipfentrifluconazole, mefentrifluconazole, metconazole, myclobutanil, penconazole, prochloraz, propiconazole, prothioconazole, pyrisoxazole, tebuconazole, tetraconazole, triadimefon, triadimenol, triflumizole, and a combination thereof;
(b) a quinone outside inhibitor (QoI) fungicide selected from a group comprising azoxystrobin, dimoxystrobin, famoxadone, fenamidone, fluoxastrobin, kresoxim-methyl, metarylpicoxamid, metominostrobin, metyltetraprole, picoxystrobin, pyraclostrobin, pyribencarb, trifloxystrobin, and a combination thereof,
(c) a succinate dehydrogenase inhibitor (SDHI) fungicide selected from a group comprising benzovindiflupyr, bixafen, boscalid, flubeneteram, fluindapyr, fluopyram, flutolanil, fluxapyroxad, inpyrfluxam, isofetamid, isoflucypram, isopyrazam, penthiopyrad, pydiflumetofen, pyrapropoyne, thifluzamide, and a combination thereof,
(d) a protectant fungicide selected from a group comprising copper, captan, folpet, and a combination thereof,
(e) a morpholine fungicide selected from a group comprising acibenzolar-s-methyl, fenpropidin, fenpropimorph, spiroxamine, and a combination thereof,
(f) a benzamide fungicide selected from a group comprising fluopicolide, zoxamide, and a combination thereof,
(g) a carboxylic acid amide (CAA) fungicide selected from a group comprising benthiavalicarb-isopropyl, dimethomorph, iprovalicarb, mandipropamid, valifenalate and a combination thereof,
(h) a cyanoacetamideoxime fungicide selected from a group comprising cymoxanil;
(i) an Isothiazole fungicide selected from a group comprising Dichlobentiazox;
(j) a melanin biosynthesis inhibitor reductase (MI-R) fungicide selected from a group comprising tolprocarb, tricyclazole, and a combination thereof,
(k) an oxysterol binding protein homologue inhibition (OSBPI) fungicide selected from a group comprising fluoxapiprolin, oxathiapiprolin, and a combination thereof,
(l) a phenylamide fungicide selected from a group comprising benalaxyl, metalaxyl, metalaxyl-methyl, oxadixyl, and a combination thereof,
(m) a phosphonate fungicide selected from a group comprising disodium-phosphonate, fosetyl-al, potassium-bicarbonate, potassium-carbonate, potassium phosphite monobasic, potassium phosphonate, and a combination thereof,
(n) a phenylpyrrole fungicide selected from a group comprising fludioxonil;
(o) a quinone inside inhibitor (QiI) fungicide selected from a group comprising amisulbrom, cyazofamid, Fenpicoxamid, florylpicoxamid and a combination thereof,
(p) a quinone outside inhibitor fungicide of stigmatellin binding type (QoSI) selected from a group comprising Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof,
wherein the weight ratio of fluazinam to two fungicides selected from a) to q) lie in the range from 1:1:1 to 1:100:1; to 100:1:1; to 1:1:100; to 1:100:100; to 100:100:1; to 100:1:100.

In some specific embodiments, the combination comprises fluazinam, an azole fungicide and a QoI fungicide in the range from 1:1:1 to 1:100:1; to 100:1:1; to 1:1:100; to 1:100:100; to 100:100:1; to 100:1:100.

In some specific embodiments, the combination comprises fluazinam, an azole fungicide and a SDHI fungicide in the range from 1:1:1 to 1:100:1; to 100:1:1; to 1:1:100; to 1:100:100; to 100:100:1; to 100:1:100.

In some specific embodiments, the combination comprises fluazinam, an azole fungicide and a protectant fungicide in the range from 1:1:1 to 1:100:1; to 100:1:1; to 1:1:100; to 1:100:100; to 100:100:1; to 100:1:100.

In some specific embodiments, the combination comprises fluazinam, an azole fungicide and a morpholine fungicide in the range from 1:1:1 to 1:100:1; to 100:1:1; to 1:1:100; to 1:100:100; to 100:100:1; to 100:1:100.

In some specific embodiments, the combination comprises fluazinam, an azole fungicide and a benzamide fungicide in the range from 1:1:1 to 1:100:1; to 100:1:1; to 1:1:100; to 1:100:100; to 100:100:1; to 100:1:100.

In some specific embodiments, the combination comprises fluazinam, an azole fungicide and a CAA fungicide in the range from 1:1:1 to 1:100:1; to 100:1:1; to 1:1:100; to 1:100:100; to 100:100:1; to 100:1:100.

In some specific embodiments, the combination comprises fluazinam, an azole fungicide and a cyanoacetamideoxime fungicide in the range from 1:1:1 to 1:100:1; to 100:1:1; to 1:1:100; to 1:100:100; to 100:100:1; to 100:1:100.

In some specific embodiments, the combination comprises fluazinam, an azole fungicide and an Isothiazole fungicide in the range from 1:1:1 to 1:100:1; to 100:1:1; to 1:1:100; to 1:100:100; to 100:100:1; to 100:1:100.

In some specific embodiments, the combination comprises fluazinam, an azole fungicide and an MBI-R fungicide in the range from 1:1:1 to 1:100:1; to 100:1:1; to 1:1:100; to 1:100:100; to 100:100:1; to 100:1:100.

In some specific embodiments, the combination comprises fluazinam, an azole fungicide and an OSBPI fungicide in the range from 1:1:1 to 1:100:1; to 100:1:1; to 1:1:100; to 1:100:100; to 100:100:1; to 100:1:100.

In some specific embodiments, the combination comprises fluazinam, an azole fungicide and a phenylamide fungicide in the range from 1:1:1 to 1:100:1; to 100:1:1; to 1:1:100; to 1:100:100; to 100:100:1; to 100:1:100.

In some specific embodiments, the combination comprises fluazinam, an azole fungicide and a phosphonate fungicide in the range from 1:1:1 to 1:100:1; to 100:1:1; to 1:1:100; to 1:100:100; to 100:100:1; to 100:1:100.

In some specific embodiments, the combination comprises fluazinam, an azole fungicide and a phenylpyrrole fungicide in the range from 1:1:1 to 1:100:1; to 100:1:1; to 1:1:100; to 1:100:100; to 100:100:1; to 100:1:100.

In some specific embodiments, the combination comprises fluazinam, an azole fungicide and a QiI fungicide in the range from 1:1:1 to 1:100:1; to 100:1:1; to 1:1:100; to 1:100:100; to 100:100:1; to 100:1:100.

In some specific embodiments, the combination comprises fluazinam, an azole fungicide and a QoSI fungicide in the range from 1:1:1 to 1:100:1; to 100:1:1; to 1:1:100; to 1:100:100; to 100:100:1; to 100:1:100.

In some embodiments, the combination, mixture or composition reduces the amount of time needed to achieve a level of fungal control compared to when each fungicide at the same amount is applied alone. For example, if each fungicide applied alone achieves 50% control of fungal disease 7 days after application, the combination, mixture or composition disclosed herein achieves 50% control of fungal diseases 2 days after application where each fungicide is applied at the rate.

In some embodiments, the amount of time is reduced by at least 1 day, 2 days, 3 days, 4 day, 5 days, 7 days, 10 days, 14 days or 21 days, or 28 days.

In some embodiments, the combination, mixture or composition is more effective for protecting the plant or soil against fungal attack than when each fungicide at the same amount is applied alone.

In some embodiments, the combination, mixture or composition prolongs protection against the fungus compared to when each fungicide at the same amount is applied alone.

In some embodiments, protection is prolonged by at least 7 days, 14 day, 21 days, or 28 day.

In some embodiments, the combination, mixture or composition disclosed herein extends the protection period against fungal attack compared to when each fungicide at the same amount is applied alone.

In some embodiments, the protection period is extended by at least 7 days, 14 days, 21 days, or 28 days.

In some embodiments, the combination, mixture or composition is effective for increasing plant development compared to when each fungicide at the same amount is applied alone.

Increasing plant development includes, but is not limited to, enhancing the root systems, enhancing shoot of the crop plant, enhancing greening effect, enhancing plant vigor and/or enhancing plant potential yield.

In some other embodiments, the combination, mixture or composition is effective for increasing control of phytophagous mites compared to when each fungicide at the same amount is applied alone.

In some embodiments, plant vigor is assessed using the relative vigor index. In some embodiments, plant vigor is increased by at least 1%, 5%, 10, 20%, 30%, 40%, 50%, 60%, 70%, 80%, or 90%.

In some embodiments, enhancement in root system is measured by root weight. In some embodiments, root weight is increased by at least 1%, 5%, 10, 20%, 30%, 40%, 50%, 60%, 70%, 80%, or 90%.

In some embodiments, enhancement in shoot is measured by shoot weight. In some embodiments, shoot weight is increased by at least 1%, 5%, 10, 20%, 30%, 40%, 50%, 60%, 70%, 80%, or 90%.

In some embodiments, the fungicidal composition further comprises at least one agrochemically acceptable excipient.

In an embodiment, in the fungicidal composition according to the invention, the combination of fluazinam mixed with one or more fungicides selected from (a) to (q) represents 0.5 wt % to 95 wt % of the total weight of the fungicide composition.

In some embodiments, the amount of fluazinam and one or more fungicides selected from (a) to (q) represents 0.5 wt % to 95 wt % of the total weight of the combination, mixture, or composition. In some embodiments, the amount of fluazinam and one or more fungicides selected from (a) to (q) represents 0.5 wt % to 95 wt % of the total weight of the combination, mixture, or composition.

The present invention also discloses a method of combatting phytopathogenic diseases on crop plants which comprises applying to the crop plant or to the locus thereof the fungicide composition according to the invention. A preferred method of applying the invention composition comprises the application of said composition to the aerial parts of the plant, especially the foliage.

The present invention also discloses a method of combatting phytopathogenic diseases on crop plants which comprises applying to the crop plant or to the locus thereof the combination, mixture or composition according to the invention. A preferred method of applying the invention combination, mixture or composition comprises the application of said combination, mixture or composition to the aerial parts of the plant, especially the foliage.

The present invention also provides a method of treating a plant or soil against fungal infection comprising applying an effective amount of any one of the combinations, mixtures, or compositions disclosed herein to the plant, propagation material of the plant, or soil so as to thereby treat the plant or soil against fungal infection.

The present invention also provides a method of preventing fungal infection of a plant or soil comprising applying an effective amount of any one of the combinations, mixtures, or compositions disclosed herein to the plant, propagation material of the plant, or soil so as to thereby prevent fungal infection of the plant or soil.

The present invention also provides a method of controlling fungal disease infecting a plant or soil comprising applying an effective amount of any one of the combinations, mixtures, or compositions disclosed herein to the plant, propagation material of the plant, or soil so as to thereby control the fungal disease infecting the plant or soil.

The present invention also provides a method of reducing fungal infection of a plant or soil comprising applying an effective amount of any one of the combinations, mixtures, or compositions disclosed herein to the plant, propagation material of the plant, or soil so as to thereby reduce fungal infection of the plant or soil.

The present invention also provides a method for prolonging the period of protection against fungal infection comprising applying any one of the combinations, mixtures or compositions disclosed herein to a plant or soil.

In some embodiments, the method comprises applying fluazinam and the additional fungicide at any one of the rates described herein.

The rate at which the fungicidal composition according to the invention is applied will depend upon the particular type of fungus to be controlled, the degree of control required and the timing and method of application. In general, the composition of the disclosure can be applied at an application rate lying in the range of from about 30 g a.i./ha to about 5000 g a.i./ha based on the total amount of active ingredients in the composition.

In an embodiment, the fungicidal composition according to the invention is applied at a rate lying in the range of from about 60 g a.i./ha to about 3000 g a.i./ha. In a more particular embodiment, the fungicidal composition according to the invention is applied at a rate lying in the range of from about 75 g a.i./ha to about 2000 g a.i./ha, even more particularly in the range of from about 100 g a.i./ha to about 1000 g a.i./ha.

The components of the combination, mixture or composition of the present disclosure can be applied either separately or as part of a multipart fungicidal system. The components of the combination, mixture or composition of the present disclosure can be applied either separately or as part of a multipart fungicidal system. Consequently, the methods and uses disclosed herein include preparation of the combination, mixture and composition from the component parts prior to application or use.

In some embodiments, the components of the combination, mixture or composition are applied simultaneously.

In some embodiments, the components of the combination, mixture or composition are applied contemporaneously.

In some embodiments, fluazinam and/or mixture thereof is applied at least one time during a growth season.

In some embodiments, fluazinam and/or mixture thereof is applied two or more times during a growth season.

In some embodiments, fluazinam and/or mixture thereof described herein are applied as a soil application. In some embodiments, the mixtures and/or compositions described herein are applied as a foliar application.

In some embodiments, the combination, mixture or composition is applied at least one time during a growth season.

In some embodiments, the combination, mixture or composition is applied two or more times during a growth season.

In some embodiments, the combination, mixture or composition described herein are applied as a soil application. In some embodiments, the combination, mixture or composition described herein are applied as a foliar application.

The rate at which the combination, mixture or composition disclosed herein is applied will depend upon the particular type of fungus to be controlled, the degree of control required and the timing and method of application. In general, the combination, mixture or composition described herein can be applied at an application rate of between about 30 g/ha and about 4000 g/ha.

In some embodiments, fluazinam is applied at a rate between 50-600 g a.i./ha. In some embodiments, the fluazinam is applied at a rate between 150-500 g a.i./ha. In some embodiments, the fluazinam is applied at a rate between 200-400 g a.i./ha.

In some embodiments, the azole fungicide is applied at a rate of 30-250 g a.i./ha. In some embodiments, the azole fungicide is applied at a rate of 30-200 g a.i./ha. In some embodiments, the azole fungicide is applied at a rate of 30-150 g a.i./ha.

In some specific embodiments, Mefentrifluconazole is applied at a rate of 30-150 g a.i./ha. In some embodiments, prothioconazole is applied at a rate of 50-200 g a.i./ha. In some embodiments tebuconazole is applied at a rate of 50-150 g a.i./ha. In some embodiments difenoconazole is applied at a rate of 30-125 g a.i./ha. In some embodiments Fluoxytioconazole is applied at a rate of 30-150 g a.i./ha.

In some embodiments, the QoI fungicide is applied at a rate of 40-500 g a.i./ha. In some embodiments, the QoI fungicide is applied at a rate of 50-350 g a.i./ha. In some embodiments, the QoI fungicide is applied at a rate of 40-250 g a.i./ha.

In some specific embodiments, azoxystrobin is applied at a rate of 50-250 g a.i./ha. In some embodiments, Metyltetraprole is applied at a rate of 50-250 g a.i./ha. In some embodiments pyraclostrobin is applied at a rate of 50-250 g a.i./ha. In some embodiments picoxystrobin is applied at a rate of 50-250 g a.i./ha.

In some embodiments, the SDHI fungicide is applied at a rate of 40-500 g a.i./ha. In some embodiments, the SDHI fungicide is applied at a rate of 50-400 g a.i./ha. In some embodiments, the SDHI fungicide is applied at a rate of 35-400 g a.i./ha.

In some specific embodiments, Fluindapyr is applied at a rate of 50-150 g a.i./ha. In some embodiments, fluopyram is applied at a rate of 50-150 g a.i./ha. In some embodiments fluxapyroxad is applied at a rate of 35-125 g a.i./ha. In some embodiments Inpyrfluxam is applied at a rate of 35-400 g a.i./ha. In some embodiments Isoflucypram is applied at a rate of 50-200 g a.i./ha.

In some embodiments, the protectant fungicide is applied at a rate of 200-5000 g a.i./ha. In some embodiments, the protectant fungicide is applied at a rate of 200-4000 g a.i./ha. In some embodiments, the protectant fungicide is applied at a rate of 350-4000 g a.i./ha.

In some specific embodiments, Captan is applied at a rate of 500-900 g a.i./ha. In some embodiments, folpet is applied at a rate of 500-900 g a.i./ha.

In some embodiments, the morpholine fungicide is applied at a rate of 200-600 g a.i./ha. In some embodiments, the morpholine fungicide is applied at a rate of 200-400 g a.i./ha. In some embodiments, the morpholine fungicide is applied at a rate of 150-400 g a.i./ha.

In some specific embodiments, fenpropidin is applied at a rate of 150-300 g a.i./ha.

In some embodiments, the benzamide fungicide is applied at a rate of 20-500 g a.i./ha. In some embodiments, the benzamide fungicide is applied at a rate of 30-400 g a.i./ha. In some embodiments, the benzamide fungicide is applied at a rate of 35-150 g a.i./ha.

In some specific embodiments, fluopicolide is applied at a rate of 40-130 g a.i./ha.

In some embodiments, the CAA fungicide is applied at a rate of 20-300 g a.i./ha. In some embodiments, the CAA fungicide is applied at a rate of 30-200 g a.i./ha. In some embodiments, the CAA fungicide is applied at a rate of 80-150 g a.i./ha.

In some specific embodiments, mandipropamid is applied at a rate of 80-150 g a.i./ha.

In some embodiments, the cyanoacetamideoxime fungicide is applied at a rate of 20-300 g a.i./ha. In some embodiments, the cyanoacetamideoxime fungicide is applied at a rate of 30-200 g a.i./ha. In some embodiments, the cyanoacetamideoxime fungicide is applied at a rate of 100-150 g a.i./ha.

In some specific embodiments, cymoxanil is applied at a rate of 100-150 g a.i./ha.

In some embodiments, the MBI-R fungicide is applied at a rate of 100-500 g a.i./ha. In some embodiments, the MBI-R fungicide is applied at a rate of 150-400 g a.i./ha. In some embodiments, the MBI-R fungicide is applied at a rate of 200-400 g a.i./ha.

In some specific embodiments, tricyclazole is applied at a rate of 200-400 g a.i./ha.

In some embodiments, the OSBPI fungicide is applied at a rate of 5-100 g a.i./ha. In some embodiments, the OSBPI fungicide is applied at a rate of 10-75 g a.i./ha. In some embodiments, the OSBPI fungicide is applied at a rate of 10-50 g a.i./ha.

In some specific embodiments, oxathiapiprolin is applied at a rate of 10-50 g a.i./ha.

In some embodiments, the phenylamide fungicide is applied at a rate of 50-150 g a.i./ha. In some embodiments, the phenylamide fungicide is applied at a rate of 60-125 g a.i./ha. In some embodiments, the phenylamide fungicide is applied at a rate of 80-100 g a.i./ha.

In some specific embodiments, metalaxyl-m is applied at a rate of 80-100 g a.i./ha.

In some embodiments, the phosphonate fungicide is applied at a rate of 200-4000 g a.i./ha. In some embodiments, the phosphonate fungicide is applied at a rate of 300-3000 g a.i./ha. In some embodiments, the phosphonate fungicide is applied at a rate of 500-2000 g a.i./ha.

In some specific embodiments, potassium-phosphonate is applied at a rate of 500-2000 g a.i./ha.

In some specific embodiments, fosetyl-Al is applied at a rate of 500-2000 g a.i./ha.

In some embodiments, the phenylpyrrole fungicide is applied at a rate of 50-300 g a.i./ha. In some embodiments, the phenylpyrrole fungicide is applied at a rate of 100-250 g a.i./ha. In some embodiments, the phenylpyrrole fungicide is applied at a rate of 150-250 g a.i./ha.

In some specific embodiments, fludioxonil is applied at a rate of 150-250 g a.i./ha.

In some embodiments, the QiI fungicide is applied at a rate of 50-200 g a.i./ha. In some embodiments, the QiI fungicide is applied at a rate of 50-150 g a.i./ha. In some embodiments, the QiI fungicide is applied at a rate of 80-150 g a.i./ha.

In some specific embodiments, fenpicoxamid is applied at a rate of 80-150 g a.i./ha.

In some embodiments, the QoSI fungicide is applied at a rate of 100-500 g a.i./ha. In some embodiments, the QoSI fungicide is applied at a rate of 100-400 g a.i./ha. In some embodiments, the QoSI fungicide is applied at a rate of 120-400 g a.i./ha.

In some specific embodiments, Ametoctradin is applied at a rate of 120-400 g a.i./ha.

In some other embodiments, Picarbutrazox is applied at a rate of 50-150 g a.i./ha.

In some most specific embodiments, the combination of the present invention comprises fluazinam, prothioconazole and picoxystrobin at the application rates of 350 g a.i./ha, 60 g a.i./ha and 50 g a.i./ha, respectively.

In some most specific embodiments, the combination of the present invention comprises fluazinam, prothioconazole and fluxapyroxad at the application rates of 350 g a.i./ha, 60 g a.i./ha and 45 g a.i./ha, respectively.

In some most specific embodiments, the combination of the present invention comprises fluazinam, prothioconazole and fenpropidin at the application rates of 350 g a.i./ha, 60 g a.i./ha and 150-250 g a.i./ha, respectively.

In some most specific embodiments, the combination of the present invention comprises fluazinam, tebuconazole and picoxystrobin at the application rates of 350 g a.i./ha, 70 g a.i./ha and 50 g a.i./ha, respectively.

In some most specific embodiments, the combination of the present invention comprises fluazinam, tebuconazole and fluxapyroxad at the application rates of 350 g a.i./ha, 70 g a.i./ha and 45 g a.i./ha, respectively.

In some most specific embodiments, the combination of the present invention comprises fluazinam, tebuconazole and fenpropidin at the application rates of 350 g a.i./ha, 70 g a.i./ha and 150-250 g a.i./ha, respectively.

In some most specific embodiments, the combination of the present invention comprises fluazinam, picoxystrobin and fluxapyroxad at the application rates of 350 g a.i./ha, 50 g a.i./ha and 45 g a.i./ha, respectively.

In some most specific embodiments, the combination of the present invention comprises fluazinam, picoxystrobin and fenpropidin at the application rates of 350 g a.i./ha, 50 g a.i./ha and 150-250 g a.i./ha, respectively.

In some most specific embodiments, the combination of the present invention comprises fluazinam, fluxapyroxad and fenpropidin at the application rates of 350 g a.i./ha, 45 g a.i./ha and 150-250 g a.i./ha, respectively.

The composition according to the invention can be used as a fungicide, i.e. for combatting fungal diseases that have already contaminated crop plants but also for the prevention of fungal attacks.

The combination, mixture or composition according to the invention can be used as a fungicide, i.e. for combatting fungal diseases that have already contaminated crop plants but also for the prevention of fungal attacks.

The preferred target fungi and fungal diseases for treating a plant or soil against infection are phoma (Leptosphaeria maculans), Alternaria sp. (Early blight) in Potato and Tomato; Ascochyta fabae (Didymella pisi) in Pulses and Peanuts; Botrytis sp. (Botrytis) in Grapes, Strawberry, flowers and ornamentals, tomato, chilli, Avocado, Mango and Pistachio; Cercospora beticola (leaf spot of beet) in Sugar beet; Cercospora zeae-maydis (Gray Leaf Spot) in corn; Cochliobolus carbonum (Northern Corn Leaf Spot) in corn, Cochliobolus heterostrophus (Southern corn leaf blight) in corn, Colletotrichum kahawae (Coffee Berry Disease) in coffee; Colletotrichum sp. (Anthracnose) in Pulses and Peanuts, Colletotrichum truncatum (Anthracnose) in chilli, Corynespora cassiicola (Target spot) in Soybean and cotton; Fusarium sp. (Fusarium head blight) in cereals; Hemileia vastatrix (Coffee Leaf Rust) in coffee; Mycosphaerella fijiensis (Black sigatoka) in Banana; Phakopsora pachyrhizi (Asian soybean rust) in soybean; Phytophthora infestans (Late blight) in Potato and Tomato; Plasmopara viticola (Downy mildew) in Grapes; Pseudocercospora musae (Yellow sigatoka) in Banana; Pseudoperonospora cubensis (Downy mildew) in Cucurbits; Puccinia recondite (Brown rust) in cereals; Puccinia striiformis (Yellow rust) in cereals; Pyrenophora teres (Net blotch) in Barley; Pyricularia oryzae (Rice Blast) in Rice; Ramularia areola (Ramularia leaf spot) in cotton; Ramularia beticola (Ramularia leaf spot) in Sugar beet; Ramularia collo-cygni (Ramularia leaf spot) in Cereals, Rhizoctonia solani/Thanatephorus cucumeris (Sheath Blight) in Rice; Sclerotinia homeocarpa (Dollar spot) in Turf, Lawns, Golf courses; Sclerotinia sclerotiorum (Sclerotinia) in OSR, Soybean, Sunflower and Lettuces; Setosphaeria turcica (Northern Corn Leaf Blight) in corn; Uromyces betae (Rust) in sugar beet; Venturia inaequalis (Scab) in Pome fruit; and Zymoseptoria tritici (Septoria) in Cereals.

In some embodiments, the invention provides a method of combatting fungal diseases on crop plants, which comprises applying to the crop plant or to the locus thereof the fungicidal composition or combination of the present invention, wherein the fungi and fungal diseases for treating a plant or soil against infection are phoma (Leptosphaeria maculans), Alternaria sp. (Early blight) in Potato and Tomato; Ascochyta fabae (Didymella pisi) in Pulses and Peanuts; Botrytis sp. (Botrytis) in Grapes, Strawberry, flowers and ornamentals, tomato, chilli, Avocado, Mango and Pistachio; Cercospora beticola (leaf spot of beet) in Sugar beet; Cercospora zeae-maydis (Gray Leaf Spot) in corn; Cochliobolus carbonum (Northern Corn Leaf Spot) in corn, Cochliobolus heterostrophus (Southern corn leaf blight) in corn, Colletotrichum kahawae (Coffee Berry Disease) in coffee; Colletotrichum sp. (Anthracnose) in Pulses and Peanuts, Colletotrichum truncatum (Anthracnose) in chilli, Corynespora cassiicola (Target spot) in Soybean and cotton; Fusarium sp. (Fusarium head blight) in cereals; Hemileia vastatrix (Coffee Leaf Rust) in coffee; Mycosphaerella fijiensis (Black sigatoka) in Banana; Phakopsora pachyrhizi (Asian soybean rust) in soybean; Phytophthora infestans (Late blight) in Potato and Tomato; Plasmopara viticola (Downy mildew) in Grapes; Pseudocercospora musae (Yellow sigatoka) in Banana; Pseudoperonospora cubensis (Downy mildew) in Cucurbits; Puccinia recondite (Brown rust) in cereals; Puccinia striiformis (Yellow rust) in cereals; Pyrenophora teres (Net blotch) in Barley; Pyricularia oryzae (Rice Blast) in Rice; Ramularia areola (Ramularia leaf spot) in cotton; Ramularia beticola (Ramularia leaf spot) in Sugar beet; Ramularia collo-cygni (Ramularia leaf spot) in Cereals, Rhizoctonia solani/Thanatephorus cucumeris (Sheath Blight) in Rice; Sclerotinia homeocarpa (Dollar spot) in Turf, Lawns, Golf courses; Sclerotinia sclerotiorum (Sclerotinia) in OSR, Soybean, Sunflower and Lettuces; Setosphaeria turcica (Northern Corn Leaf Blight) in corn; Uromyces betae (Rust) in sugar beet; Venturia inaequalis (Scab) in Pome fruit; and Zymoseptoria tritici (Septoria) in Cereals.

In an embodiment, a method of combatting Zymoseptoria tritici on crop plants comprises applying to the crop plant or to the locus thereof the fungicidal composition or combination of the present invention.

In an embodiment, a method of combatting Venturia inaequalis on crop plants comprises applying to the crop plant or to the locus thereof the fungicidal composition or combination of the present invention.

In an embodiment, a method of combatting Septoria tritici on crop plants comprises applying to the crop plant or to the locus thereof the fungicidal composition or combination of the present invention.

In an embodiment, a method of combatting net blotch (Pyrenophora teres f. teres) on crop plants comprises applying to the crop plant or to the locus thereof the fungicidal composition or combination of the present invention.

In an embodiment, a method of combatting Phytophthora infestans on crop plants comprises applying to the crop plant or to the locus thereof the fungicidal composition or combination of the present invention.

In an embodiment, a method of combatting phoma (Leptosphaeria maculans) on crop plants comprises applying to the crop plant or to the locus thereof the fungicidal composition or combination of the present invention.

In an embodiment, a method of combatting Asian Soybean Rust (Phakopsora pachyrizzi) on crop plants comprises applying to the crop plant or to the locus thereof the fungicidal composition or combination of the present invention.

In a preferred embodiment, the method of combatting fungal diseases on crop plants, which comprises applying to the crop plant or to the locus thereof the fungicidal composition or combination of fluazinam and an azole fungicide, wherein the fungi and fungal diseases for treating a plant or soil against infection are selected from a group comprising Asian Soybean Rust (Phakopsora pachyrizzi), Zymoseptoria tritici, Pyricularia oryzae, Venturia inaequalis, Septoria tritici, net blotch (Pyrenophora teres f. teres), Phytophthora infestans, Rhizoctonia solani and phoma (Leptosphaeria maculans).

In a specific embodiment, the method of combatting fungal diseases on crop plants, which comprises applying to the crop plant or to the locus thereof the fungicidal composition or combination of fluazinam and epoxiconazole, wherein the fungi and fungal diseases for treating a plant or soil against infection are selected from a group comprising Asian Soybean Rust (Phakopsora pachyrizzi), Zymoseptoria tritici, Pyricularia oryzae, Venturia inaequalis, Septoria tritici, net blotch (Pyrenophora teres f. teres), Phytophthora infestans, Rhizoctonia solani and phoma (Leptosphaeria maculans).

In a specific embodiment, the method of combatting fungal diseases on crop plants, which comprises applying to the crop plant or to the locus thereof the fungicidal composition or combination of fluazinam and prothioconazole, wherein the fungi and fungal diseases for treating a plant or soil against infection are selected from a group comprising Asian Soybean Rust (Phakopsora pachyrizzi), Zymoseptoria tritici, Pyricularia oryzae, Venturia inaequalis, Septoria tritici, net blotch (Pyrenophora teres f. teres), Phytophthora infestans, Rhizoctonia solani and phoma (Leptosphaeria maculans).

In a specific embodiment, the method of combatting fungal diseases on crop plants, which comprises applying to the crop plant or to the locus thereof the fungicidal composition or combination of fluazinam and Tebuconazole, wherein the fungi and fungal diseases for treating a plant or soil against infection are selected from a group comprising Asian Soybean Rust (Phakopsora pachyrizzi), Zymoseptoria tritici, Pyricularia oryzae, Venturia inaequalis, Septoria tritici, net blotch (Pyrenophora teres f. teres), Phytophthora infestans, Rhizoctonia solani and phoma (Leptosphaeria maculans).

In a specific embodiment, the method of combatting fungal diseases on crop plants, which comprises applying to the crop plant or to the locus thereof the fungicidal composition or combination of fluazinam and flutriafol, wherein the fungi and fungal diseases for treating a plant or soil against infection are selected from a group comprising Asian Soybean Rust (Phakopsora pachyrizzi), Zymoseptoria tritici, Pyricularia oryzae, Venturia inaequalis, Septoria tritici, net blotch (Pyrenophora teres f. teres), Phytophthora infestans, Rhizoctonia solani and phoma (Leptosphaeria maculans).

In a preferred embodiment, the method of combatting fungal diseases on crop plants, which comprises applying to the crop plant or to the locus thereof the fungicidal composition or combination of fluazinam and a quinone outside inhibitor (QoI) fungicide, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In a specific embodiment, the method of combatting fungal diseases on crop plants, which comprises applying to the crop plant or to the locus thereof the fungicidal composition or combination of fluazinam and picoxystrobin, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In a preferred embodiment, the method of combatting fungal diseases on crop plants, which comprises applying to the crop plant or to the locus thereof the fungicidal composition or combination of fluazinam and a succinate dehydrogenase inhibitor (SDHI) fungicide, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In a specific embodiment, the method of combatting fungal diseases on crop plants, which comprises applying to the crop plant or to the locus thereof the fungicidal composition or combination of fluazinam and flubeneteram, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In a specific embodiment, the method of combatting fungal diseases on crop plants, which comprises applying to the crop plant or to the locus thereof the fungicidal composition or combination of fluazinam and fluxapyroxad, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In a preferred embodiment, the method of combatting fungal diseases on crop plants, which comprises applying to the crop plant or to the locus thereof the fungicidal composition or combination of fluazinam and a protectant fungicide, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In a specific embodiment, the method of combatting fungal diseases on crop plants, which comprises applying to the crop plant or to the locus thereof the fungicidal composition or combination of fluazinam and copper oxychloride, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In a preferred embodiment, the method of combatting fungal diseases on crop plants, which comprises applying to the crop plant or to the locus thereof the fungicidal composition or combination of fluazinam and a quinone inside inhibitor (QiI) fungicide, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In a specific embodiment, the method of combatting fungal diseases on crop plants, which comprises applying to the crop plant or to the locus thereof the fungicidal composition or combination of fluazinam and florylpicoxamid, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In another specific embodiment, the method of combatting fungal diseases on crop plants, which comprises applying to the crop plant or to the locus thereof the fungicidal composition or combination of fluazinam and aminopyrifen, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In another specific embodiment, the method of combatting fungal diseases on crop plants, which comprises applying to the crop plant or to the locus thereof the fungicidal composition or combination of fluazinam and picarbutrazox, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In another embodiment, the method of combatting fungal diseases on crop plants, which comprises applying to the crop plant or to the locus thereof the fungicidal composition or combination of fluazinam, prothioconazole and picoxystrobin, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In a specific embodiment, the method of combatting Asian Soybean Rust (Phakopsora pachyrizzi) comprises applying to the crop plant or to the locus thereof the fungicidal composition or combination of fluazinam, prothioconazole and picoxystrobin.

In another embodiment, the method of combatting fungal diseases on crop plants, which comprises applying to the crop plant or to the locus thereof the fungicidal composition or combination of fluazinam, prothioconazole and fluxapyroxad, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In a specific embodiment, the method of combatting Asian Soybean Rust (Phakopsora pachyrizzi) comprises applying to the crop plant or to the locus thereof the fungicidal composition or combination of fluazinam, prothioconazole and fluxapyroxad.

In another embodiment, the method of combatting fungal diseases on crop plants, which comprises applying to the crop plant or to the locus thereof the fungicidal composition or combination of fluazinam, prothioconazole and difenoconazole, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In a specific embodiment, the method of combatting Asian Soybean Rust (Phakopsora pachyrizzi) comprises applying to the crop plant or to the locus thereof the fungicidal composition or combination of fluazinam, prothioconazole and difenoconazole.

In another embodiment, the method of combatting fungal diseases on crop plants, which comprises applying to the crop plant or to the locus thereof the fungicidal composition or combination of fluazinam, prothioconazole and copper oxychloride, wherein the fungi and fungal diseases for treating a plant or soil against infection are selected from a group comprising Asian Soybean Rust (Phakopsora pachyrizzi), Zymoseptoria tritici, Venturia inaequalis, Septoria tritici, net blotch (Pyrenophora teres f. teres), Phytophthora infestans, Rhizoctonia solani and phoma (Leptosphaeria maculans).

In a specific embodiment, the method of combatting Asian Soybean Rust (Phakopsora pachyrizzi) comprises applying to the crop plant or to the locus thereof the fungicidal composition or combination of fluazinam, prothioconazole and copper oxychloride.

In some embodiments, the combination, mixture or composition is for treating crop against fungal infection. Crop includes, but is not limited to, arable crops, vegetables and fruits. In some embodiments, the combination, mixture or composition according to the invention is intended for use on crops of corn, soybean, dry bean, cotton, wheat or coffee. In some embodiments, the combination, mixture or composition according to the invention is intended for use on soybean, dry bean, corn, cotton, cereals, coffee, rice, pome fruit, grapevine, zucchini and/or tomato. In some embodiment, the crop is soybean. In some embodiment, the crop is dry bean. In some embodiment, the crop is corn. In some embodiment, the crop is cotton. In some embodiment, the crop is cereal.

In some embodiment, the crop is coffee. In some embodiment, the crop is rice. In some embodiments, the crop is grapevine. In some embodiments, the crop is a pome fruit, preferably apple. In some embodiments, the crop is zucchini. In some embodiment, the crop is tomato.

Number and rates of application depend on the biological and climatic environment of the pathogen. Alternatively, the active ingredients can reach the plant from the soil or water via the root system (systemic action) by drenching the locus of the plant with a liquid preparation (for example in rice growing) or incorporating the substances into the soil in solid form, for example in the form of granules (soil application). The inventive composition can also be applied to seed kernels for the purposes of seed treatment (coating), either by soaking the roots or kernels in succession with a liquid preparation of an active ingredient or by coating them with a moist or dry preparation which already comprises the combination. In addition, other types of application to plants are possible in specific cases, for example the targeted treatment of buds or fruit-bearing parts of the plant.

The inventive combination, mixture or composition can also be applied to seed kernels for the purposes of seed treatment (coating), either by soaking the roots or kernels in succession with a liquid preparation of an active ingredient or by coating them with a moist or dry preparation which already comprises the combination. In addition, other types of application to plants are possible in specific cases, for example the targeted treatment of buds or fruit-bearing parts of the plant.

The composition of the invention may be formulated into any conventional type of formulation. The composition of the invention may be employed in any conventional form, especially in the form of water dispersible granules, coated granules, emulsifiable concentrate, suspension concentrate, microemulsion, oil dispersion, suspo-emulsion, capsule suspension, a mixed formulation of capsule suspension and suspension concentrate.

Suitable carriers and adjuvants may be solid or liquid and correspond to the substances ordinarily employed in formulation technology, such as, e.g. natural or regenerated mineral substances, solvents, dispersants, wetting fungicides, tackifiers, thickeners, binding fungicides or fertilisers. Such carriers are for example described in WO 96/22690.

Such compositions may be produced in conventional manner, e.g. by mixing the active ingredients with appropriate adjuvants (diluents or solvents and optionally other formulating ingredients such as surfactants).

Particularly formulations to be applied in spraying forms such as water dispersible concentrates or wettable powders may contain surfactants such as wetting and dispersing fungicides, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

The composition according to the invention is generally formulated in various ways using formulation adjuvants, such as carriers, solvents and surface-active substances. The formulations can be in various physical forms, e.g. in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). Such formulations can either be used directly or diluted prior to use. The dilutions can be made, for example, with water, liquid fertilisers, micronutrients, biological organisms, oil or solvents. The formulations can be prepared e.g. by mixing the active ingredient with the formulation adjuvants in order to obtain compositions in the form of finely divided solids, granules, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The active ingredients can also be contained in microcapsules. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of from about 25 to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the formulations according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, di ethylene glycol butyl ether, di ethylene glycol ethyl ether, di ethylene glycol methyl ether, /V,/V-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, V-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting fungicides or suspending fungicides or for other purposes. Typical surface-active substances include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters.

Further adjuvants that can be used in pesticidal formulations include crystallisation inhibitors, viscosity modifiers, suspending fungicides, dyes, anti-oxidants, foaming fungicides, light absorbers, mixing auxiliaries, antifoams, complexing fungicides, neutralising or pH-modifying substances and buffers, corrosion inhibitors, fragrances, wetting fungicides, take-up enhancers, micronutrients, plasticisers, glidants, lubricants, dispersants, thickeners, antifreezes, microbicides, and liquid and solid fertilisers.

The formulations according to the invention can include an additive comprising an oil of vegetable or animal origin, a mineral oil, alkyl esters of such oils or mixtures of such oils and oil derivatives. The amount of oil additive in the formulation according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C8-C22 fatty acids, especially the methyl derivatives of 02-08 fatty acids, for example the methyl esters of lauric acid, palmitic acid and oleic acid (methyl laurate, methyl palmitate and methyl oleate, respectively).

A seed dressing formulation is applied in a manner known per se to the seeds employing the combination of the invention and a diluent in suitable seed dressing formulation form, e.g. as an aqueous suspension or in a dry powder form having good adherence to the seeds. Such seed dressing formulations are known in the art. Seed dressing formulations may contain the single active ingredients or the combination of active ingredients in encapsulated form, e.g. as slow release capsules or microcapsules.

The present invention also provides a package comprising any one of the combinations, mixtures or compositions disclosed herein.

In some embodiments, the package comprises instructions for using the combination, mixture or composition for protecting a plant from fungal attack. In some embodiments, the package comprises instructions for using the combination, mixture or composition for controlling fungal disease infecting a plant. In some embodiments, the instructions comprise application rates, application times, target fungal pathogen, and/or target plant as described herein.

Each embodiment disclosed herein is contemplated as being applicable to each of the other disclosed embodiments. Thus, all combinations of the various elements described herein are within the scope of the invention. In addition, the elements recited in the composition embodiments can be used in the combination, mixture (including synergistic mixture), package, method and use embodiments described herein and vice versa.

The present invention is illustrated and further described in more detail with reference to the following non-limiting examples. The following examples illustrate the practice of the present subject matter in some of its embodiments but should not be construed as limiting the scope of the present subject matter. Other embodiments will be apparent to one skilled in the art from consideration of the specification and examples. It is intended that the specification, including the examples, is considered exemplary only without limiting the scope and spirit of the present subject matter.

### EXAMPLES

Experiments may be carried out to determine the synergistic effect of the mixture combination which comprises a mixture of i) an effective amount of fluazinam and ii) an effective amount of at least one fungicide selected from the group as mentioned hereinbefore.

The following representative examples illustrate the practice of the present invention in some of its embodiments but should not be construed as limiting the scope of the invention. Other embodiments will be apparent to one skilled in the art from consideration of the specification and examples. It is intended that the specification, including the examples, is considered exemplary only without limiting the scope and coverage of the invention.

A synergistic effect exists whenever the action of an active ingredient combination is greater than the sum of the actions of the individual components.

In determining the effect of a fungicidal interactions and to determine synergism/antagonism/additive among the fungicides' mixtures, “Wadley formula” is well known in the literature. Wadley's formula is based on EC₅₀ values (effective concentration required to obtain a 50% effect) typically derived by linear or non-linear regression from dose-response experiments, and thus avoids errors arising from the nonlinear nature of the dose-response curve. In the Wadley formula, for a given combination of two active components, E (expected EC₅₀) can be expressed as:

$$E = \frac{( α + b )}{\frac{a}{EC 50 ( Ao )} + \frac{b}{E C 50 ( B o )}}$$

where a and b are the weight ratios of compound A and B in the mixture and EC₅₀(Ao) and EC₅₀(Bo) are the experimentally observed (o) EC₅₀ values obtained using the dose response curves for the individual compounds. The Interaction Factor (IF) is calculated as the ratio between the expected values and observed values, EC₅₀A+B (e)/EC₅₀A+B(o). If A+B (observed) is >A+B (expected) then synergy (IF >1) is exhibited. If IF=1 then the effect is additive and if IF<1 then antagonism is exhibited.

Furthermore, in the field of agriculture, it is often understood that the term “synergy” is as defined by Colby S. R. in an article entitled “Calculation of the synergistic and antagonistic responses of herbicide combinations” published in the journal Weeds, 1967, 15, p. 20.

The action expected for a given combination of two active components can be calculated as follows:

$$E = X + Y - XY / 100$$

The action expected for a given combination of three active components can be calculated as follows:

$$E = X + Y + Z - ( X Y + Y Z + XZ ) / 100 + ( X YZ ) / 10000$$

in which E represents the expected effect, e.g. percentage of pest control, for the combination of the active ingredients at defined doses (for example equal to x and y respectively), X is the effect, e.g. percentage of pest control, observed for compound (1), i.e. fluzinam at a defined dose (equal to x), Y or/and Z is the effect, e.g. percentage of pest control, observed for compound(s) (2) at a defined dose (equal to y or z). Here, efficacy or percent inhibition is determined in %. 0% means efficacy that corresponds to the Control, i.e., as if no treatment had been applied. Whereas, a percent inhibition of 100% means that complete control is observed. When the percent control observed for the combination is greater than E, there is a synergistic effect. When the percent control observed for the combination is equal to E, there is an additive effect and wherein the percent control observed for the combination is lower than E, there is an antagonistic effect.

In some embodiments, the combination is synergistic for controlling fungi. In some embodiments, the combination is synergistic for enhancing the crop plant. In some embodiments, the combination is synergistic for enhancing plant development. In some other embodiments, the combination is synergistic for enhancing the root system. In some embodiments, the combination is synergistic for improving plant quality. In some embodiments, the combination is synergistic for regulating plant growth. In some embodiments, the combination is synergistic for controlling different species of pathogen.

### EXPERIMENTAL EXAMPLES

The synergistic effect can be determined for the combination which comprises fluazinam when combined with one or more fungicides, as depicted in the following Examples:

### Example 1

Efficacy of the fungicidal compositions is evaluated with reference to the EC₅₀ values in comparison with untreated control plots.

The experiments were conducted by applying technical grade of each active ingredient in a standard formulation, alone or with their tank-mixed compositions. All the active ingredients straight or in mixture are diluted in a suitable solvent to a set of concentrations. The technical active ingredients were dissolved in pure DMSO, and then adjusted in distilled water.

Two fungicide ratios are tested for each combination.

One hundred microliters of sterile distilled water with or without fungicide are added to 100 μl of pathogen suspension into each well of the 96-wells microtiter plate.

Three repetitions (wells) are undertaken. The EC50 value of each product towards each pathogen is determined from the effect towards the fungal growth measured using the Optical density.

The active ingredients used in the experiments are having following formulation types and the concentrations:

| Active ingredient | Formulation type | Concentration |
|---|---|---|
| Fluazinam | Technical product | 99% |
| Aminopyrifen | Technical product | 98% |
| Flubeneteram | Technical product | 99% |
| Florylpicoxamid | Technical product | 99.30% |
| Picarbutrazox | Technical product | 100% |

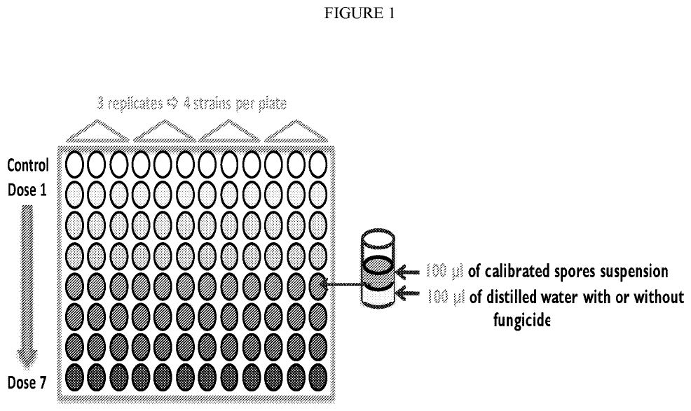

Each bioassay is carried out with the following 8 treatment groups corresponding to 8 concentrations of the fungicide mixture. In the MTP assay (Microtiter Plate assay, an example of which is presented in FIG. 1), 3 replicates (wells) are carried out for each concentration of fungicide mixture and tested pathogen strain.

The MTPs are incubated in the dark at 19° C. for 5 days under saturated humidity in order to avoid evaporation. Then, the fungal growth in each well is estimated by measuring the Optical Density (OD) at 590 nm with a BMG plate reader (FLUOstar Omega, BMG Labtech). The OD values at 5 days are automatically corrected by comparison with those measured at day zero (inoculation day). The generated data are transferred to the MARS Data Analysis software (BMG Labtech) which allows to calculate percentage of growth inhibition induced by each concentration of fungicide tested. Finally, the EC50 of each product and mixture towards each fungal strain is determined.

Interactions between fungicides in mixtures are analyzed according to Wadley formula (as explained hereinabove):

TABLE 1
Activity of Fluazinam combinations on Zymoseptoria tritici control

| | | | EC₅₀ | EC₅₀ | Interaction |
|---|---|---|---|---|---|
| Active | Doses | | observed | expected | factor |
| ingredient | (μg/mL) | | (μg/ml) | (μg/ml) | (IF) |
| Fluazinam | 0.0014 | | 0.2566 | | |
| | 0.0041 | | | | |
| | 0.012 | | | | |
| | 0.037 | | | | |
| | 0.111 | | | | |
| | 0.333 | | | | |
| | 1 | | | | |
| Aminopyrifen | 0.00625 | | 0.2220 | — | — |
| | 0.0125 | | | | |
| | 0.025 | | | | |
| | 0.05 | | | | |
| | 0.1 | | | | |
| | 0.2 | | | | |
| | 0.4 | | | | |
| Fluazinam/ | 0.00625 | 0.00625 | 0.1375 | 0.2381 | 1.731 |
| Aminopyrifen | 0.0125 | 0.0125 | | | |
| | 0.025 | 0.025 | | | |
| | 0.05 | 0.05 | | | |
| | 0.1 | 0.1 | | | |
| | 0.2 | 0.2 | | | |
| | 0.4 | 0.4 | | | |
| Fluazinam/ | 0.0125 | 0.00625 | 0.1776 | 0.2439 | 1.374 |
| Aminopyrifen | 0.025 | 0.0125 | | | |
| | 0.05 | 0.025 | | | |
| | 0.1 | 0.05 | | | |
| | 0.2 | 0.1 | | | |
| | 0.4 | 0.2 | | | |
| | 0.8 | 0.4 | | | |
| Flubeneteram | 0.00625 | | 0.1221 | — | — |
| | 0.0125 | | | | |
| | 0.025 | | | | |
| | 0.05 | | | | |
| | 0.1 | | | | |
| | 0.2 | | | | |
| | 0.4 | | | | |
| Fluazinam/ | 0.00625 | 0.00625 | 0.0876 | 0.1655 | 1.890 |
| Flubeneteram | 0.0125 | 0.0125 | | | |
| | 0.025 | 0.025 | | | |
| | 0.05 | 0.05 | | | |
| | 0.1 | 0.1 | | | |
| | 0.2 | 0.2 | | | |
| | 0.4 | 0.4 | | | |
| Fluazinam/ | 0.0125 | 0.00625 | 0.0724 | 0.1877 | 2.594 |
| Flubeneteram | 0.025 | 0.0125 | | | |
| | 0.05 | 0.025 | | | |
| | 0.1 | 0.05 | | | |
| | 0.2 | 0.1 | | | |
| | 0.4 | 0.2 | | | |
| | 0.8 | 0.4 | | | |
| Florylpicoxamid | 0.00156 | | 0.0022 | — | — |
| | 0.00313 | | | | |
| | 0.00625 | | | | |
| | 0.0125 | | | | |
| | 0.025 | | | | |
| | 0.05 | | | | |
| | 0.1 | | | | |
| Fluazinam/ | 0.0078 | 0.00156 | 0.0094 | 0.0127 | 1.354 |
| Florylpicoxamid | 0.0156 | 0.00313 | | | |
| | 0.0313 | 0.00625 | | | |
| | 0.0625 | 0.0125 | | | |
| | 0.125 | 0.025 | | | |
| | 0.25 | 0.05 | | | |
| | 0.5 | 0.1 | | | |
| Fluazinam/ | 0.00313 | 0.00156 | 0.0094 | 0.0065 | 0.697 |
| Florylpicoxamid | 0.00625 | 0.00313 | | | |
| | 0.0125 | 0.00625 | | | |
| | 0.025 | 0.0125 | | | |
| | 0.05 | 0.025 | | | |
| | 0.1 | 0.05 | | | |
| | 0.2 | 0.1 | | | |

TABLE 2
Activity of Fluazinam combinations on
Phytophthora infestans control

| | | | EC₅₀ | EC₅₀ | Interaction |
|---|---|---|---|---|---|
| Active | Doses | | observed | Expected | Factor |
| ingredient | (μg/mL) | | (μg/ml) | (μg/ml) | (IF) |
| Fluazinam | 0.0020 | | 0.5282 | | |
| | 0.0051 | | | | |
| | 0.013 | | | | |
| | 0.032 | | | | |
| | 0.08 | | | | |
| | 0.2 | | | | |
| | 0.5 | | | | |
| Picarbutrazox | 0.00039 | | 0.0026 | — | — |
| | 0.00078 | | | | |
| | 0.00156 | | | | |
| | 0.00313 | | | | |
| | 0.00625 | | | | |
| | 0.0125 | | | | |
| | 0.025 | | | | |
| Fluazinam/ | 0.0039 | 0.00039 | 0.0100 | 0.0277 | 2.786 |
| Picarbutrazox | 0.0078 | 0.00078 | | | |
| | 0.0156 | 0.00156 | | | |
| | 0.0312 | 0.00313 | | | |
| | 0.0625 | 0.00625 | | | |
| | 0.125 | 0.0125 | | | |
| | 0.25 | 0.025 | | | |
| Fluazinam/ | 0.00781 | 0.00039 | 0.0320 | 0.0506 | 1.579 |
| Picarbutrazox | 0.01562 | 0.00078 | | | |
| | 0.03125 | 0.00156 | | | |
| | 0.0625 | 0.00313 | | | |
| | 0.125 | 0.00625 | | | |
| | 0.25 | 0.0125 | | | |
| | 0.5 | 0.025 | | | |

### OTHER EXAMPLES

Efficacy of the fungicidal compositions is evaluated with reference to a scale of 0 to 100% in comparison with untreated control plots. 0 means no control and 100 means complete control of the target disease.

The experiments were conducted by applying commercially available formulations of Fluazinam and other mixture partners, alone or with their tank-mixed compositions. The compositions were diluted with water.

The active ingredients used in the experiments are having following formulations types and the concentrations:

| Active | Formulation | |
|---|---|---|
| ingredient | type | Concentration |
| Fluazinam | SC | 500 gr/Liter |
| Fluxapyroxad | SC | 300 gr/Liter |

| | Active | Conc |
|---|---|---|
| Product | Ingredient | (g ai/L or kg) |
| Intake Gold Sapphire | Flutriafol | 500 |
| Proviso | Prothioconazole | 250 |
| Soprano 500 | Epoxiconazole | 500 |
| Gem | Fluazinam | 500 |

Intake Gold Sapphire is available from Nufarm Pty Ltd, 103-105 Pipe Road, Laverton North Vic 3026

Proviso is available from Adama Australia Pty Ltd, Level 1, Building B, 207 Pacific Highway, St Leonards NSW 2065, Australia.

Soprano 500 is available from Adama Australia Pty Ltd, Level 1, Building B, 207 Pacific Highway, St Leonards NSW 2065, Australia.

Gem is available from Adama Australia Pty Ltd, Level 1, Building B, 207 Pacific Highway, St Leonards NSW 2065, Australia.

Each formulation with active ingredient is diluted with water and biological efficacy trials on target fungi are conducted.

Experimentations are summarized in the below tables.

### Example 2

TABLE 3
Activity of Fluazinam + Fluxapyroxad on apple leaves incidence
for Venturia inaequalis control at 27 days after application.

| | | Observed | Expected | Colby |
|---|---|---|---|---|
| Active | Rate | % control | % control | ratio |
| Ingredient | (g/ha) | (O) | (E) | (R) |
| Fluazinam | 350 | 30.50 | — | — |
| Fluxapyroxad | 75 | 27.50 | — | — |
| Fluxapyroxad | 90 | 43.80 | — | — |
| Fluazinam + | 350 + 75 | 88.40 | 49.6 | 1.78 |
| Fluxapyroxad | | | | |
| Fluazinam + | 350 + 90 | 95.90 | 60.90 | 1.57 |
| Fluxapyroxad | | | | |

The results established that:
The combination of fluazinam and Fluxapyroxad was synergistic for controlling Apple scab on apple leaves

### Example 3

In this example, a field trial was conducted in 2021 at Roseworthy, South Australia, Australia in a crop of wheat cv. Scepter. Soprano 500 and Gem were applied twice as a foliar application for the control of Septoria tritici blotch (Zymoseptoria tritici), with the first application at the start of stem elongation and the second at full flag leaf emergence. The fungicides, alone or in a mixture as set out in Table 1, were applied by spraying in a volume of 100 L/ha.

An assessment of control of Septoria tritici blotch was conducted 33 days after the second application.

TABLE 4
Percent control of Septoria tritici blotch
33 DAA2 on the flag-3 leaf in wheat

| | Application | | | Colby |
|---|---|---|---|---|
| | rate | % Control | % Control | ratio |
| Product | (g ai/ha) | observed | expected | o/e |
| Soprano 500 (S) | 32.5 | 15 | — | — |
| Gem (G) | 150 | 16 | — | — |
| S + G | 32.5 + 150 | 35 | 28 | 1.22 |

DAA = days after application

The results established that:
The combination of Soprano 500 and Gem was synergistic for controlling Septoria tritici blotch on the flag-3 leaf,
Applying the combination of Soprano and Gem increased the residual control of Septoria tritici blotch on older leaves.

### Example 4

In this example, a field trial was conducted in 2021 at Gnarwarre, Victoria, Australia in a crop of wheat. Soprano 500 and Gem were applied twice as a foliar application for the control of Septoria tritici blotch (Zymoseptoria tritici), with the first application at the start of stem elongation. The fungicides, alone or in a mixture as set out in Table 2, were applied by spraying in a volume of 100 L/ha.

Grain yield was assessed at harvest maturity (Table 2).

TABLE 5
Grain yield response in wheat

| | Application | % Increase |
|---|---|---|
| | rate | in grain |
| Product | (g ai/ha) | yield |
| Soprano 500 (S) | 32.5 | 14 |
| Gem (G) | 150 | 7 |
| S + G | 32.5 + 150 | 29 |

DAA = days after application

The results established that:
The combination of Soprano 500 and Gem provided a synergistic grain yield response.

### Example 5

In this example, a field trial was conducted in 2021 at Millicent, South Australia, Australia in a crop of barley cv. Planet. Proviso and Gem were applied twice as a foliar application for the control of net form of net blotch (Pyrenophora teres f. teres) and spot form net blotch (Pyrenophora teres f. maculata). The fungicides, alone or in a mixture as set out in Table 3, were applied by spraying in a volume of 100 L/ha.

An assessment of net blotch control was conducted 3 days after the second application (Tables 3 and 4). Green leaf retention was assessed on the flag-3 at 3 days after the second application (Table 5). Grain yield was measured when the crop reached maturity (Table 6).

TABLE 6
Percent control of net form net blotch 3 DAA2 in barley

| | Application | | | | | | | | | |
|---|---|---|---|---|---|---|---|---|---|---|
| | rate | % Control observed | | | % Control expected | | | Colby ratio o/e | | |
| Product | (g ai/ha) | Flag | Flag-1 | Flag-2 | Flag | Flag-1 | Flag-2 | Flag | Flag-1 | Flag-2 |
| Proviso (P) | 31.25 | 19 | 24 | 15 | — | — | — | — | — | — |
| Gem (G) | 150 | 1 | −5 | −3 | — | — | — | — | — | — |
| P + G | 31.25 + 150 | 34 | 36 | 23 | 20 | \hat{ } | \hat{ } | 1.70 | * | * |

DAA = days after application
\hat{ } Values could not be calculated due to negative control effects from solo Gem application
* Colby value could not be calculated due to the Gem response, but the response demonstrates synergy

TABLE 7
Percent control 3 DAA2 of spot form net blotch on flag-1 in barley

| | Application | | | Colby |
|---|---|---|---|---|
| | rate | % Control | % Control | ratio |
| Product | (g ai/ha) | observed | expected | o/e |
| Proviso (P) | 31.25 | 44 | — | — |
| Gem (G) | 150 | −17 | — | — |
| P + G | 31.25 + 150 | 50 | \hat{ } | * |

DAA = days after application
\hat{ } Values could not be calculated due to negative control effects from solo Gem application
* Colby value could not be calculated due to the Gem response, but the response demonstrates synergy

TABLE 8
Percent green leaf area on flag-3 in barley

| | Application | | Colby |
|---|---|---|---|
| | rate | % Green | ratio |
| Product | (g ai/ha) | leaf retained | o/e |
| Untreated | — | 7.0 | — |
| Soprano 500 (S) | 32.5 | 7.0 | — |
| Gem (G) | 150 | 5.3 | — |
| S + G | 32.5 + 150 | 13.5 | * |

DAA = days after application
* Colby value could not be calculated due to the Gem response, but the response demonstrates synergy

TABLE 9
Yield response in barley

| | Application | | | Colby |
|---|---|---|---|---|
| | rate | | | ratio |
| Product | (g ai/ha) | % observed | % expected | o/e |
| Proviso (P) | 31.25 | 7 | — | — |
| Gem (G) | 150 | −3 | — | — |
| P + G | 31.25 + 150 | 15 | \hat{ } | * |

DAA = days after application
\hat{ } Value could not be calculated due to negative control effects from solo Gem application
* Colby value could not be calculated due to Gem response, but the response demonstrates synergy

The results established that:
The combination of Proviso and Gem was synergistic for controlling net form net blotch on the flag leaf, flag-1 and flag-2,
The combination of Proviso and Gem was synergistic for controlling spot form net blotch on the flag-1,
The combination of Proviso and Gem was synergistic for retaining the green leaf area of the flag-3,
The combination of Proviso and Gem was synergistic for grain yield response in barley.

### Example 6

In this example, a field trial was conducted in 2021 at York, Western Australia, Australia in a crop of canola. Proviso and Gem were applied one as a foliar application for the control of phoma (Leptosphaeria maculans). The fungicides, alone or in a mixture as set out in Table 7, were applied by spraying in a volume of 100 L/ha.

An assessment of phoma control on leaves was conducted 20 days after application and stem severity was assessed 99 days after application.

TABLE 10
Percent control of phoma in canola

| | | % Control | | % Control | | | |
|---|---|---|---|---|---|---|---|
| | Application | observed | | expected | | Colby ratio o/e | |
| | rate | Leaves | Stems | Leaves | Stems | Leaves | Stems |
| Product | (g ai/ha) | 20 DAA | 99 DAA | 20 DAA | 99 DAA | 20 DAA | 99 DAA |
| Proviso (P) | 80 | 64 | 12 | — | | — | |
| Gem (G) | 250 | −27 | −65 | — | | — | |
| P + G | 80 + 250 | 91 | 35 | \hat{ } | \hat{ } | * | * |

DAA = days after application
\hat{ } Values could not be calculated due to negative control effects from solo Gem application
* Colby value could not be calculated due to Gem response, but the response demonstrates synergy

The results established that:
The combination of Proviso and Gem was synergistic for controlling phoma leaf and stem infection.

### Example 7

In this example, a field trial was conducted in 2021 at Marrabel, South Australia, Australia in a crop of canola cv. Bonito TT. Intake and Gem were applied for the control of phoma (Leptosphaeria maculans). The fungicides, alone or in a mixture as set out in Table 8, were as an in-furrow application at sowing.

An assessment of crop vigour response was conducted 61 and 76 days after sowing and grain yield was measured at harvest.

TABLE 11
Percent crop vigour and grain yield response in canola

| | | % Increase | | | % Increase | | | | | |
|---|---|---|---|---|---|---|---|---|---|---|
| | | observed | | | expected | | | Colby ratio o/e | | |
| | | Crop | | | Crop | | | Crop | | |
| | Application | vigour | | | vigour | | | vigour | | |
| | rate | 61 | 76 | Grain | 61 | 76 | Grain | 61 | 76 | Grain |
| Product | (g ai/ha) | DAS | DAS | yield | DAS | DAS | yield | DAS | DAS | yield |
| Intake (I) | 100 | 13 | 23 | 50 | — | — | — | — | — | — |
| Gem (G) | 250 | 0 | 5 | 8 | — | — | — | — | — | — |
| I + G | 100 + 250 | 18 | 30 | 65 | 13 | 27 | 54 | 1.38 | 1.12 | 1.22 |

DAS = days after sowing

The results established that:
The combination of Intake and Gem was synergistic for increasing early crop vigour when applied as an in-furrow application at sowing,
The combination of Intake and Gem was synergistic for grain yield response in canola.

### Example 8

In this example, a field trial was conducted in 2021 at Marrabel, South Australia, Australia in a crop of canola. Proviso and Gem were applied for the control of phoma (Leptosphaeria maculans). The fungicides, alone or in a mixture as set out in Table 9, were applied as an early post-emergent foliar spray.

An assessment of crop vigour response was conducted 29 days after application.

TABLE 12
Crop vigour response in canola 29 days after application

| | Application | % Crop vigour | % Crop vigour | Colby |
|---|---|---|---|---|
| | rate | increase | increase | ratio |
| Product | (g ai/ha) | observed | expected | o/e |
| Proviso (P) | 80 | 10 | — | — |
| Gem (G) | 250 | 4 | — | — |
| P + G | 80 + 250 | 16 | 13.9 | 1.15 |

DAS = days after sowing

The results established that:
The combination of Proviso and Gem was synergistic for increasing early season crop vigour when applied as an early post-emergent application.

### Example 9

A field trial was carried out during the 2022/2023 growing season in the Biosementes Eireli—ME, municipality of Uberlandia, state of Minas Gerais, Brazil.

The soybean variety used for the trial was Bonus variety. It was sown on Dec. 6, 2022. Each fungicide treatment and untreated control was composed of 4 replications. The size of each experimental plot was 15 m² (5×3 m) and 60 m² total per treatment/non treatment. The experiment was conducted under a randomized block design.

Fungicide treatments were applied three (4) times during the experiment, the first on Jan. 17, 2023, and the second, third and fourth application with 14-day intervals. Fungicides were applied with a CO2 propellant backpack sprayer equipped with nozzles type JCO 80015 and 150 L/ha of spray volume.

The evaluations were based on severity of Asian Soybean Rust (Phakopsora pachyrizzi), being the 1st at the 1st application, at the 2nd, at the 3rd application, and at the 4th application 10 days, 20 days and 30 days after the 4th. application.

Statistical analysis was performed using the Scott-Knott test (a hierarchical clustering algorithm used in the application of ANOVA).

| | | | | | | | Spray |
|---|---|---|---|---|---|---|---|
| | | | | Dose | Dose | Aplication | volum |
| No | Products | Formulation | i.a | i.a (g) | c.p/ha | time | (L/ha) |
| 1 | Untreated | — | — | — | — | — | — |
| 2 | BANJO | 500 SC | Fluazinam | 250 | 500 mL | ABCD | 150 |
| 3 | ADM.3500.F.2.A | 250 EC | Protioconazol | 80 | 320 mL | ABCD | 150 |
| 4 | ADA FF 0129/17 | 250 SC | Picoxystrobin | 65 | 260 mL | ABCD | 150 |
| 5 | BANJO + | 500 SC + | Fluazinam + | 250 + | 500 mL + | ABCD | 150 |
| | ADM.3500.F.2.A | 250 EC | Protioconazol | 80 | 320 mL | | |
| 6 | BANJO + | 500 SC + | Fluazinam + | 250 + | 500 mL + | ABCD | 150 |
| | ADA FF 0129/17 | 250 SC | Picoxystrobin | 65 | 260 mL | | |

Application timing:
A: Growth stage V8
B: V8 + 14 days
C: V8 + 28 days
D: V8 + 42 days

To better show and present the progression of the disease throughout the study evaluations, severity was used to calculate the AUDPC (Area Under the Disease Progress Curve) according to the Shaner and Finney Equation (1990).

Based on the results obtained, the % of control based on AUDPC was calculated, as shown in the graph below:

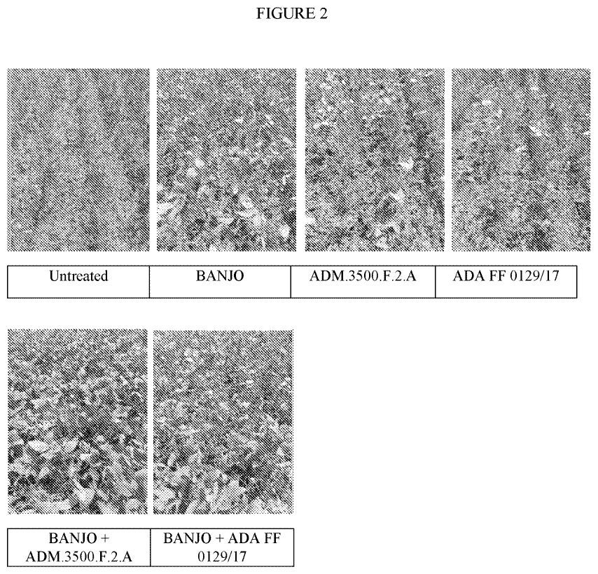

All the combinations performed statistical better compared to individual products. The combination fluazinam plus prothioconazole was numerically and statistically the best treatment.
Pictures from plots at 17 days after application 4 are presented in FIG. 2.

TABLE 14

| | | | % Green |
|---|---|---|---|
| No | Products | % defoliation | leaf retained |
| 1 | Untreated | 100 | 0 |
| 2 | BANJO | 90 | 5 |
| 3 | ADM.3500.F.2.A | 90 | 5 |
| 4 | ADA FF 0129/17 | 90 | 7 |
| 5 | BANJO + | 20 | 40 |
| | ADM.3500.F.2.A | | |
| 6 | BANJO + | 50 | 40 |
| | ADA FF 0129/17 | | |

All treatments were selective for soybean according to the ratios tested.

Calculation of Colby formula, demonstrated synergy for the double combinations:

$$E Colby [ 2 ] = P 1 + P 2 - ( ( P 1 * P 2 ) / 100 ) ,$$

$$E Colby [ 3 ] = P 1 + P 2 + P 3 - ( ( ( P 1 * P 2 ) + ( P 1 * P 3 ) + ( P 3 * P 3 ) ) / 100 ) + ( P 1 * P 2 * P 3 ) / 10 , 000 ,$$

P1: Control efficiency observed for the first product of the mixture.
P2: Control efficiency observed for the second product of the mixture.
P3: Control efficiency observed for the third product of the mixture.

TABLE 15

| | | | Mixture | | | | Colby | | | |
|---|---|---|---|---|---|---|---|---|---|---|
| | | % Ef | X | Y | Z | | E | E1 | E/E1 | |
| 1 | Untreated | — | | | | | | | | |
| 2 | BANJO (Fluazinam- 500 g.a.i/L - SC) | 23 | | | | | | | | |
| 3 | ADM.3500.F.2.A (Prothioconazol - 250 g.a.i/L - EC) | 48 | | | | | | | | |
| 4 | ADA FF 0129/17 (Picoxtystrobina - 250 g.a.i/L - SC) | 26 | | | | | | | | |
| 5 | BANJO + ADM.3500.F.2.A | 63 | 23 | 48 | — | Double | 63 | 60.0 | 1.05 | Sinergic |
| 6 | BANJO + ADA FF 0129/17 | 46 | 23 | 26 | — | Double | 46 | 43.0 | 1.07 | Sinergic |

The results established that:
The combination of fluazinam and prothioconazole was synergistic for controlling Asian Soybean Rust. This combination showed a lower percentage of defoliation and higher leaf greening retention than the solo products.
The combination of fluazinam and picoxistrobin was synergistic for controlling Asian Soybean Rust. This combination showed a lower percentage of defoliation and higher leaf greening retention than the solo products.

### Example 10

field trial was carried out during the 2022/2023 growing season in the Biosementes Eireli—ME, municipality of Uberlandia, state of Minas Gerais, Brazil. The soybean variety used for the trial was Bonus variety. It was sown on Dec. 6, 2022.

Each fungicide treatment and untreated control was composed of 4 replications. The size of each experimental plot was 15 m² (5×3 m) and 60 m² total per treatment/non treatment. The experiment was conducted under a randomized block design. Fungicide treatments were applied three (4) times during the experiment, the first on Jan. 17, 2023, and the second, third and fourth application with 14-day intervals.

Fungicides were applied with a CO2 propellant backpack sprayer equipped with nozzles type JCO 80015 and 150 L/ha of spray volume.

The evaluations were based on severity of Asian Soybean Rust (Phakopsora pachyrizzi), being the 1st at the 1st application, at the 2nd, at the 3rd application, and at the 4th application 10 days, 20 days and 30 days after the 4th. application.

Statistical analysis was performed using the Scott-Knott test (a hierarchical clustering algorithm used in the application of ANOVA).

TABLE 16

| | | | | Dose | | | Spray |
|---|---|---|---|---|---|---|---|
| | | | | i.a | Dose | Aplication | volum |
| No | Treatment | Formulation | i.a | (g) | c.p/ha | time | (L/ha) |
| 1 | Untreated | — | — | — | — | — | — |
| 2 | BANJO | 500 SC | Fluazinam | 250 | 500 mL | ABCD | 150 |
| 3 | BANJO + | 500 SC + | Fluazinam + | 250 + | 500 mL + | ABCD | 150 |
| | ADM.3500.F.2 | 250 EC | Protioconazol | 80 | 320 mL | | |
| 4 | BANJO + | 500 SC + | Fluazinam + | 250 + | 500 mL + | ABCD | 150 |
| | ADM.3500.F.2.A + | 250 EC + | Protioconazol + | 80 + | 320 mL + | | |
| | Score | 250 EC | Difenoconazol | 50 | 200 mL | | |
| 5 | BANJO + | 500 SC + | Fluazinam + | 250 + | 500 mL + | ABCD | 150 |
| | ADM.3500.F.2.A + | 250 EC + | Protioconazol + | 80 + | 320 mL + | | |
| | E02100F001 | 300 SC | Fluxapyroxade | 45 | 150 mL | | |
| 6 | BANJO + | 500 SC + | Fluazinam + | 250 + | 500 mL + | ABCD | 150 |
| | ADM.3500.F.2.A + | 250 EC + | Protioconazol + | 80 + | 320 mL + | | |
| | ADA FF | 250 SC | Picoxystrobin | 65 | 260 mL | | |
| | 0129/17 | | | | | | |
| 7 | BANJO + | 500 SC + | Fluazinam + | 250 + | 500 mL + | ABCD | 150 |
| | ADM.3500.F.2.A + | 250 EC + | Protioconazol + | 80 + | 320 mL + | | |
| | Difere | 588 SC | Copper | 294 | 500 mL | | |
| | | | Oxichloride | | | | |
| 8 | BANJO + | 500 SC + | Fluazinam + | 250 + | 500 mL + | ABCD | 150 |
| | ALTERNE + | 200 EC + | Tebuconazol + | 100 + | 500 mL + | | |
| | E02100F001 | 300 SC | Fluxapyroxade | 45 | 150 mL | | |
| 9 | BANJO + | 500 SC + | Fluazinam + | 250 + | 500 mL + | ABCD | 150 |
| | ALTERNE + | 200 EC + | Tebuconazol + | 100 + | 500 mL + | | |
| | ADA FF 0129/17 | 250 SC | Picoxystrobin | 65 | 260 mL | | |
| 10 | BANJO + | 500 SC + | Fluazinam + | 250 + | 500 mL + | ABCD | 150 |
| | ALTERNE + | 200 EC + | Tebuconazol + | 100 + | 500 mL + | | |
| | Difere | 588 SC | Copper | 294 | 500 mL | | |
| | | | Oxichloride | | | | |

Application timing:
A: Growth stage V8
B: V8 + 14 days
C: V8 + 28 days
D: V8 + 42 days

To better show and present the progression of the disease throughout the study evaluations, severity was used to calculate the AUDPC (Area Under the Disease Progress Curve) according to the Shaner and Finney Equation (1990).

Based on the results obtained, the % of control based on AUDPC was calculated, as shown in the graph below:

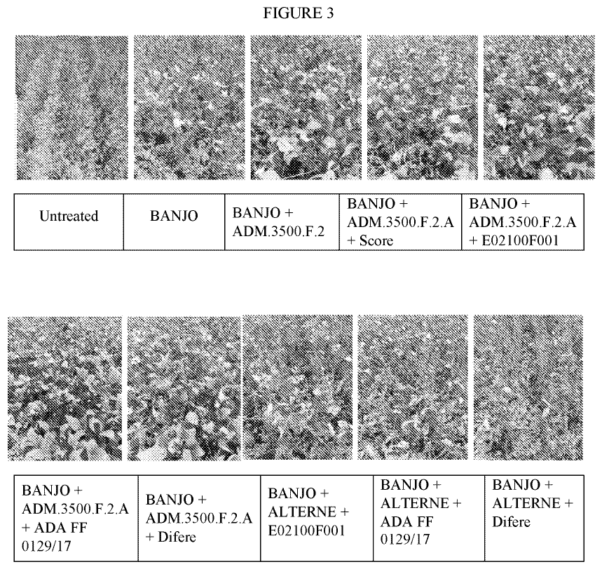

All the combinations performed statistical better compared to individual products. Among all combinations, all those containing fluazinam and prothioconazole showed the highest level of performance that was also statistically significant.
Pictures from plots at 17 days after application 4 are presented in FIG. 3.

TABLE 18

| | | | % Green |
|---|---|---|---|
| No | Treatment | % defoliation | leaf retained |
| 1 | Untreated | 100 | 0 |
| 2 | BANJO | 80 | 10 |
| 3 | BANJO + | 30 | 40 |
| | ADM.3500.F.2 | | |
| 4 | BANJO + | 40 | 30 |
| | ADM.3500.F.2.A + | | |
| | Score | | |
| 5 | BANJO + | 20 | 60 |
| | ADM.3500.F.2.A + | | |
| | E02100F001 | | |
| 6 | BANJO + | 10 | 80 |
| | ADM.3500.F.2.A + | | |
| | ADA FF 0129/17 | | |
| 7 | BANJO + | 20 | 50 |
| | ADM.3500.F.2.A + | | |
| | Difere | | |
| 8 | BANJO + | 80 | 10 |
| | ALTERNE + | | |
| | E02100F001 | | |
| 9 | BANJO + | 80 | 10 |
| | ALTERNE + | | |
| | ADA FF 0129/17 | | |
| 10 | BANJO + | 90 | 3 |
| | ALTERNE + | | |
| | Difere | | |

The results established that:
The combination of fluazinam and prothioconazole statistically better than the solo fluazinam for controlling Asian Soybean Rust. This combination showed a lower percentage of defoliation and higher leaf greening retention than the solo product.
   All the combination of fluazinam and 2 other active ingredients were statistically better than the solo fluazinam for controlling Asian Soybean Rust. Among them treatment n° 6 showed the lowest defoliation as well as the highest leaf greening retention followed by treatments 5 and 7. Treatment 10 was the worst among the 3 ways mixtures in terms of percentage of defoliation as well as leaf greening retention.

### Example 11

A field trial was carried out during the 2022/2023 growing season in Tien Giang, Vietnam. The rice variety used for the trial was IR50404. It was transplanted on Dec. 21, 2022.

Each fungicide treatment and untreated control was composed of 3 replications. The size of each experimental plot was 24 m². The experiment was conducted under a randomized block design. Fungicide treatments were applied two (2) times during the experiment, the first at booting stage, and the second at heading stage. Fungicides were diluted in water and applied with a backpack sprayer.

### Treatment List

| | | | | Dose i.a | Dose c.p | Aplication |
|---|---|---|---|---|---|---|
| No. | Products | Formulation | i.a | (g/ha) | (L/ha) | time |
| 1 | Untreated | | | | | |
| 2 | MCW-465 500 SC | 500 SC | Fluazinam | 210 | 0.42 | AB |
| 3 | Folicur 430 SC | 430 SC | Tebuconazole | 90 | 0.21 | AB |
| 4 | MCW-465 500 SC + | 500 SC | Fluazinam + | 210 + | 0.42 + | AB |
| | Folicur 430 SC | 430 SC | Tebuconazole | 90 | 0.21 | |

The evaluations were based on severity of Neck Blast (Pyricularia oryzae) and they were performed at 7, 14 and 21 days after the 2^{nd} application.

Statistical analysis was performed using the SNK test (a hierarchical clustering algorithm used in the application of ANOVA).

TABLE 19
Percent control of Neck Blast 21 DAA2
(days after application 2) in rice

| | Application | | | Colby |
|---|---|---|---|---|
| | rate | % Control | % Control | ratio |
| Product | (g ai/ha) | observed | expected | o/e |
| MCW-465 500 SC | 210 | 10.0 | 48.98 | — |
| Folicur 430 SC | 90 | 10.3 | 47.45 | — |
| MCW-465 500 SC + | 210 + 90 | 5.5 | 71.94 | 1.02 |
| Folicur 430 SC | | | | |

While the present disclosure of the invention may be susceptible to various modifications and alternative forms, specific embodiments have been described by way of example in detail herein. However, it is understood that the present disclosure is not intended to be limited to the particular forms disclosed. Rather, the present disclosure is to cover all modifications, equivalents, and alternatives falling within the scope of the present disclosure as defined by the following claims and their legal equivalents.

What is claimed is:

1. A fungicidal mixture combination comprising, as active compounds:
1) an effective amount of a fluazinam; and
2) an effective amount of at least one fungicide selected from the group consisting of:
(a) an azole fungicide selected from a group comprising bromuconazole, cyproconazole, difenoconazole, diniconazole, epoxiconazole, fenbuconazole, fluoxytioconazole, fluquinconazole, flusilazole, flutriafol, hexaconazole, imazalil, ipconazole, ipfentrifluconazole, mefentrifluconazole, metconazole, myclobutanil, penconazole, prochloraz, propiconazole, prothioconazole, pyrisoxazole, tebuconazole, tetraconazole, triadimefon, triadimenol, triflumizole, and a combination thereof;
(b) a quinone outside inhibitor (QoI) fungicide selected from a group comprising azoxystrobin, dimoxystrobin, famoxadone, fenamidone, fluoxastrobin, kresoxim-methyl, metarylpicoxamid, metominostrobin, metyltetraprole, picoxystrobin, pyraclostrobin, pyribencarb, trifloxystrobin, and a combination thereof,
(c) a succinate dehydrogenase inhibitor (SDHI) fungicide selected from a group comprising benzovindiflupyr, bixafen, boscalid, flubeneteram, fluindapyr, fluopyram, flutolanil, fluxapyroxad, inpyrfluxam, isofetamid, isoflucypram, isopyrazam, penthiopyrad, pydiflumetofen, pyrapropoyne, thifluzamide, and a combination thereof,
(d) a protectant fungicide selected from a group comprising copper, captan, folpet, and a combination thereof,
(e) a morpholine fungicide selected from a group comprising acibenzolar-s-methyl, fenpropidin, fenpropimorph, spiroxamine, and a combination thereof,
(f) a benzamide fungicide selected from a group comprising fluopicolide, zoxamide, and a combination thereof,
(g) a carboxylic acid amide (CAA) fungicide selected from a group comprising benthiavalicarb-isopropyl, dimethomorph, iprovalicarb, mandipropamid, valifenalate and a combination thereof,
(h) a cyanoacetamideoxime fungicide selected from a group comprising cymoxanil;
(i) an Isothiazole fungicide selected from a group comprising Dichlobentiazox;
(j) a melanin biosynthesis inhibitor reductase (MBI-R) fungicide selected from a group comprising tolprocarb, tricyclazole, and a combination thereof,
(k) an oxysterol binding protein homologue inhibition (OSBPI) fungicide selected from a group comprising fluoxapiprolin, oxathiapiprolin, and a combination thereof,
(l) a phenylamide fungicide selected from a group comprising benalaxyl, metalaxyl, metalaxyl-methyl, oxadixyl, and a combination thereof,
(m) a phosphonate fungicide selected from a group comprising disodium-phosphonate, fosetyl-al, potassium-bicarbonate, potassium-carbonate, potassium phosphite monobasic, potassium phosphonate, and a combination thereof,
(n) a phenylpyrrole fungicide selected from a group comprising fludioxonil;
(o) a quinone inside inhibitor (QiI) fungicide selected from a group comprising amisulbrom, cyazofamid, Fenpicoxamid, florylpicoxamid and a combination thereof,
(p) a quinone outside inhibitor fungicide of stigmatellin binding type (QoSI) selected from a group comprising Ametoctradin; and
(q) other one or more fungicides selected from a group comprising aminopyrifen, chlorinconazide, dipymetitrone, flufenoxadiazam, ipflufenoquin, picarbutrazox, pyridachlometyl, quinofumelin, and combinations thereof.

2. The mixture combination of claim 1 wherein the mixture is selected from the group comprising:
A) fluazinam and an azole fungicide;
B) fluazinam and a succinate dehydrogenase inhibitor (SDHI) fungicide;
C) fluazinam and a quinone outside inhibitor (QoI) fungicide
D) fluazinam and a quinone inside inhibitor (QiI) fungicide
E) fluazinam and one or more fungicides selected from a group comprising aminopyrifen and picarbutrazox.

3. The mixture combination of claim 2 wherein the mixture is selected from the group comprising:
1) fluazinam and prothioconazole;
2) fluazinam and epoxiconazole;
3) fluazinam and tebuconazole;
4) fluazinam and picoxystrobin;
5) fluazinam and flutriafol;
6) fluazinam and flubeneteram;
7) fluazinam and fluxapyroxad
8) fluazinam and florylpicoxamid;
9) fluazinam and aminopyrifen; and
10) fluazinam and picarbutrazox.

4. The fungicidal mixture combination of claim 1 comprising as active compounds:
i) an effective amount of a fluazinam; and
ii) an effective amount of at least two fungicides selected from the group consisting of fungicides (a) to (q) according to claim 1.

5. The mixture combination of claim 4 wherein the mixture is selected from the group comprising:
1) fluazinam, prothioconazole and picoxystrobin
2) fluazinam, prothioconazole and fluxapyroxad
3) fluazinam, prothioconazole and difenoconazole
4) fluazinam, prothioconazole and copper oxychloride

6. The mixture combination of any one of claims 1-5, wherein the mixture exhibits synergistic effects.

7. The mixture combination of any one of claims 1-6, wherein fluazinam and at least one 20 fungicide as recited in claim 1, are applied jointly or in a succession.

8. The mixture combination of any one of claims 1-7, wherein the weight ratio of fluazinam and one or more fungicide as recited in claim 1, is from 1:1 to 100:1.

9. A fungicidal composition comprising: (i) the mixture combination of any one of claims 1-8; and (ii) an agriculturally acceptable carrier.

10. The fungicidal composition of claim 9, further comprising at least one surfactant, solid diluent, liquid diluent, or a combination thereof.

11. A method for treating a plant or soil against fungal infection by controlling fungi with an effective amount of the any one of the mixture combinations of any one of claims 1-8 or the composition of claim 9 or 10 so as to control fungi, wherein the fungi and fungal diseases for treating a plant or soil against infection are selected from a group comprising phoma (Leptosphaeria maculans), Alternaria sp. (Early blight) in Potato and Tomato; Ascochyta fabae (Didymella pisi) in Pulses and Peanuts; Botrytis sp. (Botrytis) in Grapes, Strawberry, flowers and ornamentals, tomato, chilli, Avocado, Mango and Pistachio; Cercospora beticola (leaf spot of beet) in Sugar beet; Cercospora zeae-maydis (Gray Leaf Spot) in corn; Cochliobolus carbonum (Northern Corn Leaf Spot) in corn, Cochliobolus heterostrophus (Southern corn leaf blight) in corn, Colletotrichum kahawae (Coffee Berry Disease) in coffee; Colletotrichum sp. (Anthracnose) in Pulses and Peanuts, Colletotrichum truncatum (Anthracnose) in chilli, Corynespora cassiicola (Target spot) in Soybean and cotton; Fusarium sp. (Fusarium head blight) in cereals; Hemileia vastatrix (Coffee Leaf Rust) in coffee; Mycosphaerella fijiensis (Black sigatoka) in Banana; Phakopsora pachyrhizi (Asian soybean rust) in soybean; Phytophthora infestans (Late blight) in Potato and Tomato; Plasmopara viticola (Downy mildew) in Grapes; Pseudocercospora musae (Yellow sigatoka) in Banana; Pseudoperonospora cubensis (Downy mildew) in Cucurbits; Puccinia recondite (Brown rust) in cereals; Puccinia striiformis (Yellow rust) in cereals; Pyrenophora teres (Net blotch) in Barley; Pyricularia oryzae (Rice Blast) in Rice; Ramularia areola (Ramularia leaf spot) in cotton; Ramularia beticola (Ramularia leaf spot) in Sugar beet; Ramularia collo-cygni (Ramularia leaf spot) in Cereals, Rhizoctonia solani/Thanatephorus cucumeris (Sheath Blight) in Rice; Sclerotinia homeocarpa (Dollar spot) in Turf, Lawns, Golf courses; Sclerotinia sclerotiorum (Sclerotinia) in OSR, Soybean, Sunflower and Lettuces; Setosphaeria turcica (Northern Corn Leaf Blight) in corn; Uromyces betae (Rust) in sugar beet; Venturia inaequalis (Scab) in Pome fruit; and Zymoseptoria tritici (Septoria) in Cereals

12. The method for treating a plant or soil against fungal infection by controlling fungi according to claim 11, wherein the fungi are selected from a group comprising Asian Soybean Rust (Phakopsora pachyrizzi), Zymoseptoria tritici, Pyricularia oryzae, Venturia inaequalis, Septoria tritici, net blotch (Pyrenophora teres f. teres), Phytophthora infestans, Rhizoctonia solani and phoma (Leptosphaeria maculans).

13. The method of claim 12 for treating a plant or soil against fungal infection by controlling the fungi, Zymoseptoria tritici with an effective amount of the any one of the mixture combinations of any one of claims 1-8, in a weight ratio from 1:1 to 100:1, thereby controlling the said fungi.

14. The method of claim 12 for treating a plant or soil against fungal infection by controlling the fungi, Venturia inaequalis with an effective amount of the any one of the mixture combinations of any one of claims 1-8, in a weight ratio from 1:1 to 100:1, thereby controlling the said fungi.

15. The method of claim 12 for treating a plant or soil against fungal infection by controlling the fungi, Septoria tritici with an effective amount of the any one of the mixture combinations of any one of claims 1-8, in a weight ratio from 1:1 to 100:1, thereby controlling the said fungi.

16. The method of claim 12 for treating a plant or soil against fungal infection by controlling the fungi, net blotch (Pyrenophora teres f. teres) with an effective amount of the any one of the mixture combinations of any one of claims 1-8, in a weight ratio from 1:1 to 100:1, thereby controlling the said fungi.

17. The method of claim 12 for treating a plant or soil against fungal infection by controlling the fungi, Phytophthora infestans with an effective amount of the any one of the mixture combinations of any one of claims 1-8, in a weight ratio from 1:1 to 100:1, thereby controlling the said fungi.

18. The method of claim 12 for treating a plant or soil against fungal infection by controlling the fungi, Rhizoctonia solani with an effective amount of the any one of the mixture combinations of any one of claims 1-8, in a weight ratio from 1:1 to 100:1, thereby controlling the said fungi.

19. The method of claim 12 for treating a plant or soil against fungal infection by controlling the fungi, phoma (Leptosphaeria maculans) with an effective amount of the any one of the mixture combinations of any one of claims 1-8, in a weight ratio from 1:1 to 100:1, thereby controlling the said fungi.

20. The method of claim 12 for treating a plant or soil against fungal infection by controlling the fungi, Asian Soybean Rust (Phakopsora pachyrizzi) with an effective amount of any one of the mixture combinations of any one of claims 1-8, in a weight ratio from 1:1 to 100:1, thereby controlling the said fungi.

21. The method of claim 12 for treating a plant or soil against fungal infection by controlling the fungi, Pyricularia oryzae with an effective amount of any one of the mixture combinations of any one of claims 1-8, in a weight ratio from 1:1 to 100:1, thereby controlling the said fungi.
